(19) United States
(12) Patent Application Publication
(10) Pub. No.: US 2012/0088667 A1
(43) Pub. Date: Apr. 12, 2012

(54) SAFENING AGENT

(75) Inventors: Richard Williams, Colchester (GB); Peter Roose, Ghent (BE); Johan Josef De Saegher, Ghent (BE)

(73) Assignee: TAMINCO, NAAMLOZE VENNOOTSCHAP, Ghent (BE)

(21) Appl. No.: 13/263,674

(22) PCT Filed: Apr. 7, 2010
(86) PCT No.: PCT/IB10/01034

§ 371 Date: Dec. 27, 2011

(30) Foreign Application Priority Data
Apr. 7, 2009 (EP) 09447009.3

(51) Int. Cl. A01N 25/32; A01P 21/00; A01P 13/02; A01P 3/00; A01P 7/04

(52) U.S. Cl. 504/105; 504/112; 504/104; 504/108; 504/110

(57) ABSTRACT

A compound selected from a composition comprising an auxin, an auxin precursor, an auxin metabolite or a derivative of said auxin, auxin precursor or auxin metabolite and acetaminophen or a derivative thereof for use as a plant safener.

### FIELD OF THE INVENTION

This invention relates to a method and composition for improving crop safety by treating plants with, particularly but not exclusively, a composition comprising an auxin, an auxin precursor, an auxin metabolite or a derivative of said auxin, auxin precursor or auxin metabolite and acetaminophen or a derivative thereof.

### BACKGROUND OF THE INVENTION

Chemical fertilisers, fungicides, insecticides and herbicides are applied to plants in order to promote growth and reduce or destroy unwanted fungi, pests, weeds and other unwanted species. This is of particular importance in the field of commercial farming, where obtaining the maximum yield is of the utmost importance.

Chemical fertilisers, fungicides, pesticides, insecticides and herbicides available to-date often have negative effects on crops, as well as the positive effect of reducing unwanted species and promoting growth. For example, such chemicals may damage the crops to which they are applied, as well as the species to which they are targeted. This is a particular problem in the field of non-selective fertilisers. These fertilisers, fungicides, pesticides, insecticides and herbicides may also be hazardous. Other compositions applied to plants such as plant growth regulators, chemical thinners and abscission delay agents also often have negative effects on crops and may also be hazardous.

Thus, there is a continuing need for safeners and which may provide improved properties.

### SUMMARY OF THE INVENTION

The present invention relates to the novel use of compositions comprising an auxin, an auxin precursor, an auxin metabolite or a derivative of said auxin, auxin precursor or auxin metabolite and acetaminophen or a derivative thereof for use as a plant safener.

The present invention also relates to the novel use of compounds selected from a) glucose, hydrolysed starch, sucrose, fructose, glycerol, glyceraldehydes, erythrose, ribulose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid in combination with the afore-mentioned compositions. Such compounds have previously been associated with providing useful additive effects, but their use as part of a safening package is surprising.

Anthranilic acid is used as an intermediate for production of dyes, pigments and saccharin. It and its esters are also used in preparing perfumes to imitate jasmine and orange, pharmaceuticals (loop diuretics such as furosemide) and UV-absorbers, as well as corrosion inhibitors for metals and mold inhibitors in soya sauce. Its usefulness as part of a safening package is surprising.

Acetaminophen is widely used as an over-the-counter analgesic and antipyretic. It will be appreciated that its efficacy as part of a safening package is surprising.

### STATEMENTS OF THE INVENTION

The present invention is directed to the treatment of a plant with an effective amount of a composition comprising an auxin, an auxin precursor, an auxin metabolite or a derivative of said auxin, auxin precursor or auxin metabolite and acetaminophen or a derivative thereof to improve safety.

According to one aspect of the present invention there is provided a composition comprising an auxin, an auxin precursor, an auxin metabolite or a derivative of said auxin, auxin precursor or auxin metabolite and acetaminophen or a derivative thereof for use as a plant safener.

The combination envisaged in the present invention may give rise to a synergistic effect.

For ease of reference we will refer to an auxin, an auxin precursor, an auxin metabolite or a derivative of said auxin, auxin precursor or auxin metabolite or a mixture thereof as an “auxin-related compound”.

In one embodiment the auxin-related compound is based on an indolic ring. In another embodiment the auxin-related compound is based on a phenolic ring.

In one embodiment the derivative is an acid, a conjugate, a salt, an ester, or an amide of the auxin, auxin precursor, or auxin metabolite.

In one embodiment the derivative is in the form of a conjugate, e.g. conjugated to a sugar, an alcohol, an amino acid, a peptide or a protein.

In one embodiment the auxin precursor is chorismate, anthranilic acid, phosphoribosyl anthraniliate, 1-(O-carboxyphenulamino)-1-deoxyribulose-5-phosphate, indole-3-glycerol-phosphate, indole, indole-3-acetic acid, tryptophan, tryptamine, N-hydroxy tryptamine, indole-3-acetaldoxime, 1-aci-nitro-2-indolylethane, indolic glucosinate, indole-3-acetonitrile (IAN), indole-3-acetaldehyde, indole-3-lactic acid, indole-3-pyruvic acid, or indole-3-ethanol.

In a particularly preferred embodiment the auxin precursor is anthranilic acid or a derivative thereof.

In one embodiment the derivative of anthranilic acid is one of the compounds set out in FIG. 1.

The auxin-related compound may be a natural, such as is obtainable from seaweed or algae, or synthetic auxin.

In one embodiment the natural auxin is indole-3-acetic acid (IAA), 4-chloro-indole-3-acetic acid (4-Cl-IAA), phenylacetic acid (PAA), indole-3-butyric acid (IBA), indole-3-acetyl-1-O-β-D-glucose (IAAglc).

In one embodiment the conjugate of the natural auxin is IAA-Inositol, IAA-Inositol-arabinose, IAP1, an IAA-peptide, an IAA glycoprotein, an IAA-glucan, IAA-aspartate, IAA-glucose, IAA-1-O-glucose, IAA-myo-Inositol, IAA-4-O-glucose, IAA-6-O-glucose, IAA-Inositol-galactose, an IAA amide conjugate, or an IAA-amino acid conjugate.

In one embodiment the synthetic auxin is 1-naphthaleneacetic acid (NAA), 2,4-dichlorophenoxyacetic acid (2,4-D), 2-methoxy-3,6-dichlorobenzoic acid (dicamba), 4-amino-3,5,6-trichloropicolinic acid (tordon), 2,4,5-trichlorophenoxyacetic acid (2,4,5-T), 2,3,6-trichlorobenzoic acid, 4-chloro-2 methylphenoxyacetic acid (MCPA) or N,N-dimethylethylthiocarbamate.

In one embodiment the auxin metabolite is indole-3-lactic acid or indole-3-ethanol.

The composition of the present invention employs the use of acetaminophen or an analog or derivative thereof. In a preferred embodiment use is made of acetaminophen. In another embodiment the acetaminophen derivative is a compound as set out in FIG. 3.

In one embodiment the composition further comprises cobalt.

In another aspect of the present invention there is provided a method for improving plant safety comprising the application of a composition of the invention as described above to a plant or its environs or plant propagation material.

Thus, the present invention includes a method of protecting desired plants from the effect of an agrochemical comprising applying an effective amount of a composition of the present invention to the desired plant such that a protective effective against the agrochemical occurs.

The composition of the present invention seeks to protect plants from damage that may occur through the application of an agrochemical, preferably wihtout interfering or reducing the intended effect of the agrochemical. For example, a safener in the context of the application of a herbicide protects crop plants from herbicide damage without reducing activity in target weed species.

The composition of the present invention can be applied as a mixture with the agrochemical or before or after it.

Thus, we provide a kit for use in crops comprising the agrochemical, and the components of the present invention, preferably in separate containers.

The agrochemical may be, for example, at least one of a fungicide, an insecticide, a herbicide, a fertiliser, a plant growth regulator, a chemical thinning agent and an abscission delay agent.

Thus, in one embodiment the composition further comprises at least one of a fungicide, an insecticide, a herbicide, a fertiliser, a plant growth regulator, a chemical thinning agent and an abscission delay agent.

It will be appreciated that the components of the safening composition and the compound it is safening against should be different.

There is also described a compound selected from a) glucose, hydrolysed starch, sucrose, fructose, glycerol, glyceraldehydes, erythrose, ribulose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid for use as a safener.

Moreover, according to the present invention, according to another aspect there is provided a safenening composition according to the present invention further comprising at least one of compounds (a) to (f), as described above.

The combination may give rise to a synergistic effect.

In one embodiment therefore safener may comprises, e.g., at least one compound selected from c) a vitamin or coenzyme, or a precursor thereof; d) a purine or pyrimidine nucleoside, nucleotide or metabolic precursor thereof; or f) an amino acid.

There is further described a composition comprising an effective amount of an auxin, an auxin precursor, an auxin metabolite or a derivative of said auxin, auxin precursor or auxin metabolite for use as a safener.

The treatment of a plant with an effective amount of the compound anthranilic acid (also referred to as “AN”) or an effective salt, ester, or amide thereof including analogs of the AN and effective salts, ester and amides thereof is further described.

### ADVANTAGES

We have found that a composition comprising an auxin, an auxin precursor, an auxin metabolite or a derivative of said auxin, auxin precursor or auxin metabolite and acetaminophen or a derivative thereof is (amongst other benefits in plants) an effective safening agent, wherever this is deemed useful.

We have found that a compound selected from a) glucose, hydrolysed starch, sucrose, fructose, glycerol, glyceraldehydes, erythrose, ribulose, xylulose or arabinose or an ester or glycoside, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid is (amongst other benefits in plants) an effective safening agent, wherever this is deemed useful.

We have also found that a composition comprising an auxin, an auxin precursor, an auxin metabolite or a derivative of said auxin, auxin precursor or auxin metabolite or a mixture thereof is (amongst other benefits in plants) an effective safening agent, wherever this is deemed useful.

We have found that the present invention can provide a reduction in phytotoxicity in crops treated with fungicides, fertilizers, herbicides and pesticides, as well as plant growth regulators, chemical thinning agents and abscission delay agents.

We have also found that the safening systems of the present invention can be used alone (without e.g. fungicides, fertilizers, herbicides, pesticides) to provide a boost in growth and/or vigour, especially when applied under conditions of potential or actual plant stress, such as high/low pH, high/low temperatures, high/low salinity, drought or other unfavourable plant conditions.

The composition of the present invention may include trace elements such as iron, manganese, boron, copper, cobalt, molybdenum and zinc. In a particularly preferred embodiment, the composition of the present invention includes cobalt. We have found that cobalt increases nodulation in nitrogen fixing crops.

The combinations envisaged in the compositions of the present invention may give rise to a synergistic effect.

### BRIEF DESCRIPTION OF THE FIGURES

FIG. 1 shows structures of examples of analogs of anthranilic acid.

FIG. 2 shows structures of examples of naturally occurring auxins and conjugates.

FIG. 3 shows structures of examples of derivatives of acetaminophen.

FIG. 4 shows an overview of the reactions leading from chorismate to IAA and tryptophan.

FIG. 5 shows the structure of some synthetic auxins.

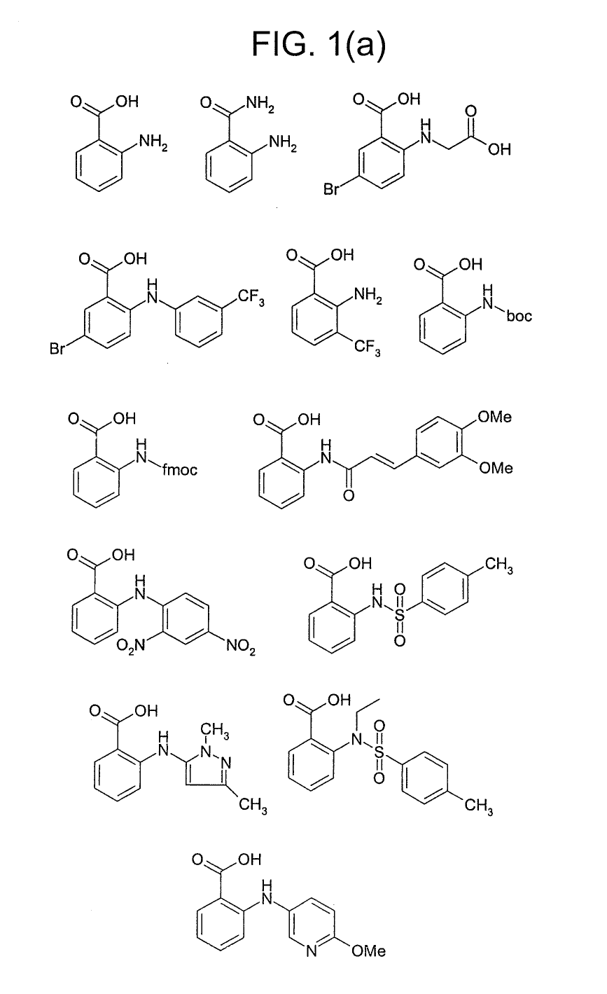

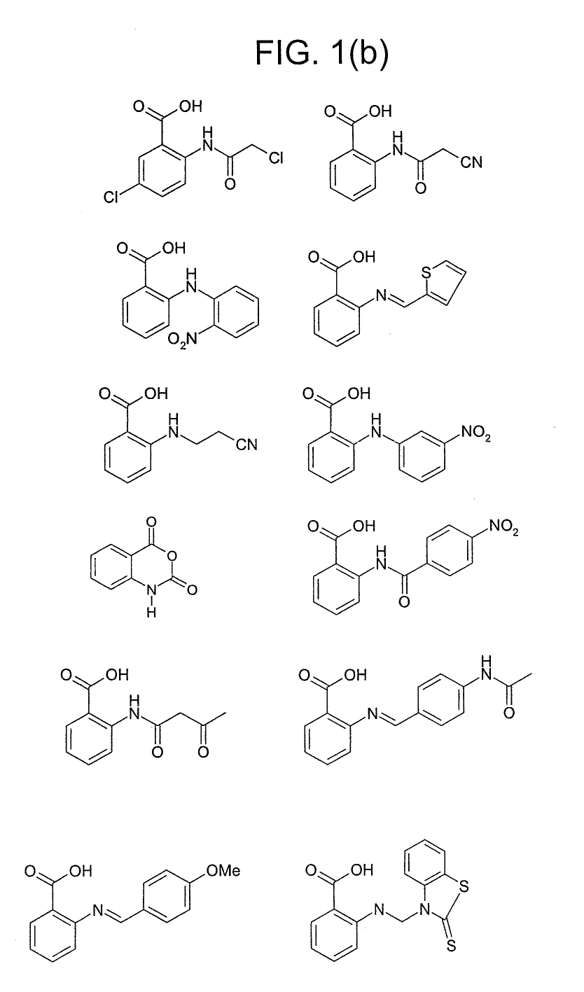

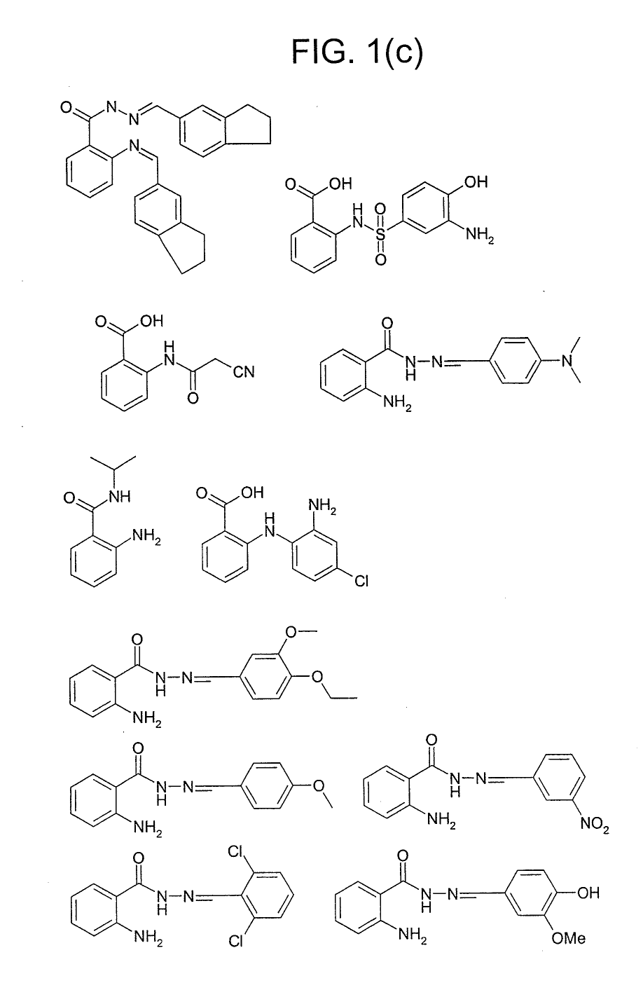

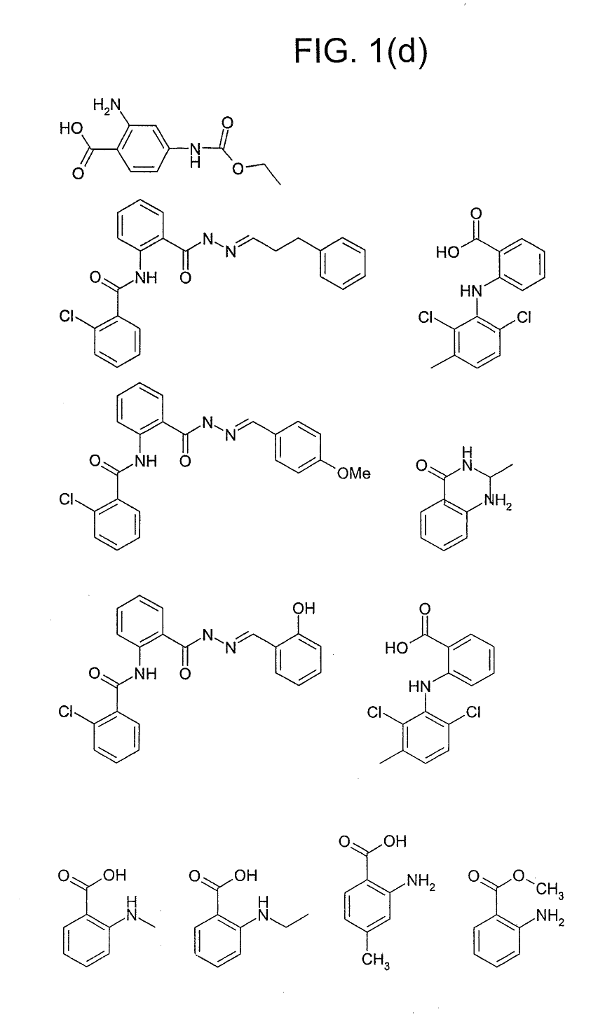

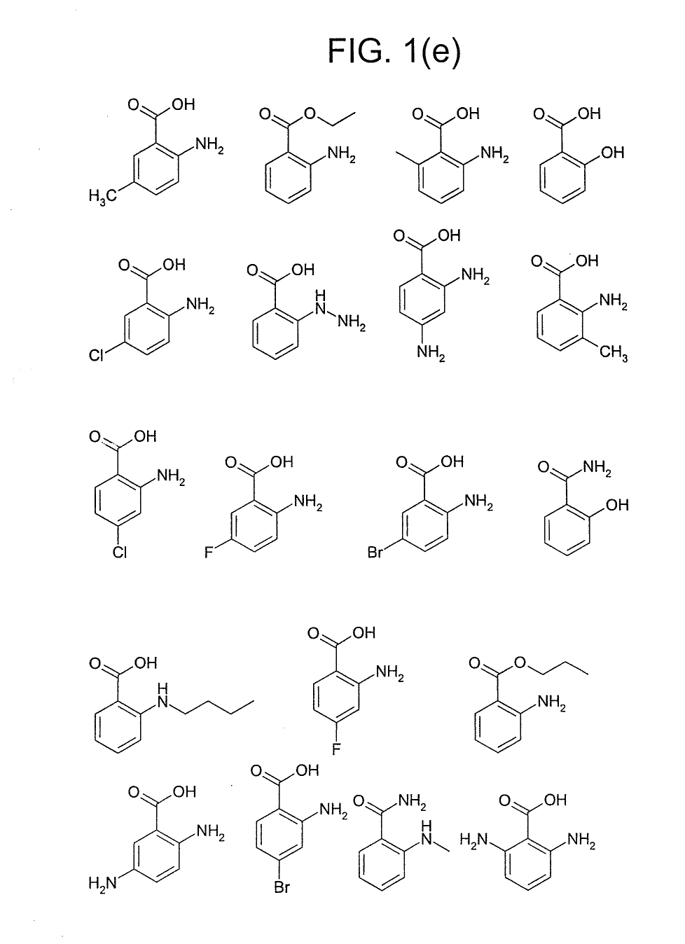

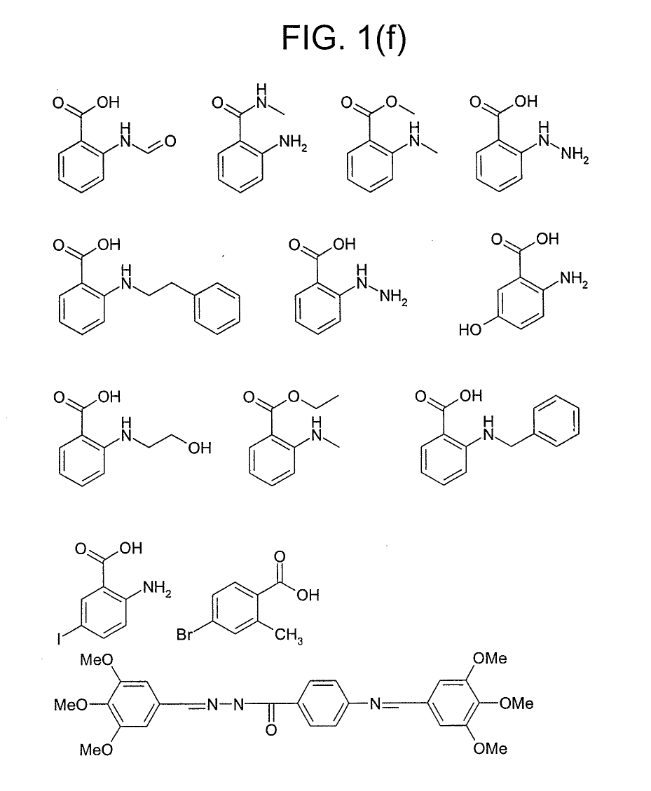

### DETAILED DESCRIPTION OF THE INVENTION

Various preferred features and embodiments of the present invention will now be described by way of non-limiting example.

The present invention relates to the use of anthranilic acid (AN):

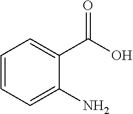

AN, also known as anthraniliate, has the CAS number 118-92-3.

We have described useful derivatives of AN above. Preferably such derivatives are water soluble. Representative salts include inorganic salts such as ammonium, lithium, sodium, potassium, magnesium and calcium salts and organic amine salts such as the triethanolamine, dimethylethanolamine and ethanolamine salts.

The present invention involves the use of auxins.

Auxins are a class of plant growth hormones. An auxin is an organic substance that promotes cell elongation growth when applied in low concentrations to plant tissue segments in a bioassay. The most studied member of the auxin family is indole-3-acetic acid (IAA). In addition to IAA, there are several other naturally occurring auxins that have been described to date: IAA, IBA, PAA and 4-Cl-IAA. Naturally occurring auxins are found in plants as the free acid and in conjugated forms.

An auxin has been defined as a compound that gives rise to curvature in the grass coleoptile curvature (or growth) test. Such an assay is described by Fritz Went in 1926 and 1928. In this bioassay coleoptile tips of grass seedlings are placed on an agar plate containing the substance to be assayed. If an auxin response is present then the coleoptile bends in darkness and the angle of curvature can be measured. Went's results indicated that the curvatures of stems were proportional to the amount of growth substance in the agar. This test is also called the avena curvature test. Other functional tests which can be employed to determine auxin activity include the ability to cause rooting in stem cuttings and the ability to promote cell division in tissue or cell culture.

A review of auxins, their synthesis and metabolism can be found in e.g. Normanly, Slovin and Cohen in “Plant Hormones, Biosynthesis, Signal Transduction and Action!”, Ed Peter J. Davies, [2004] Chapter “B1. Auxin Biosynthesis and Metabolism” pages 36-62.

In addition to indolic auxins, various phenolic auxins have auxin activity.

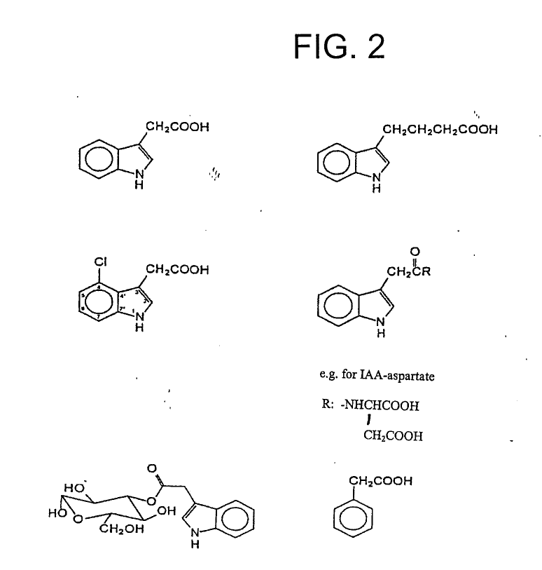

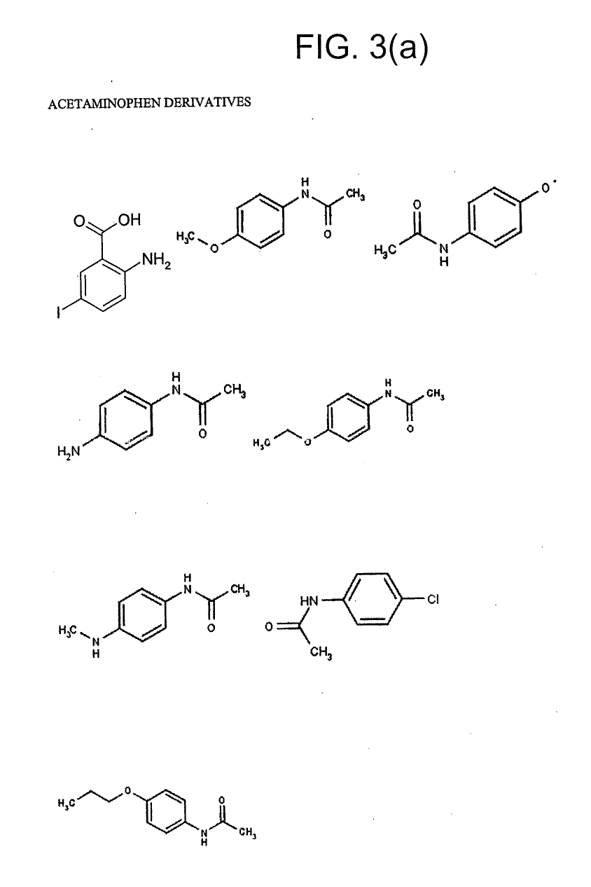

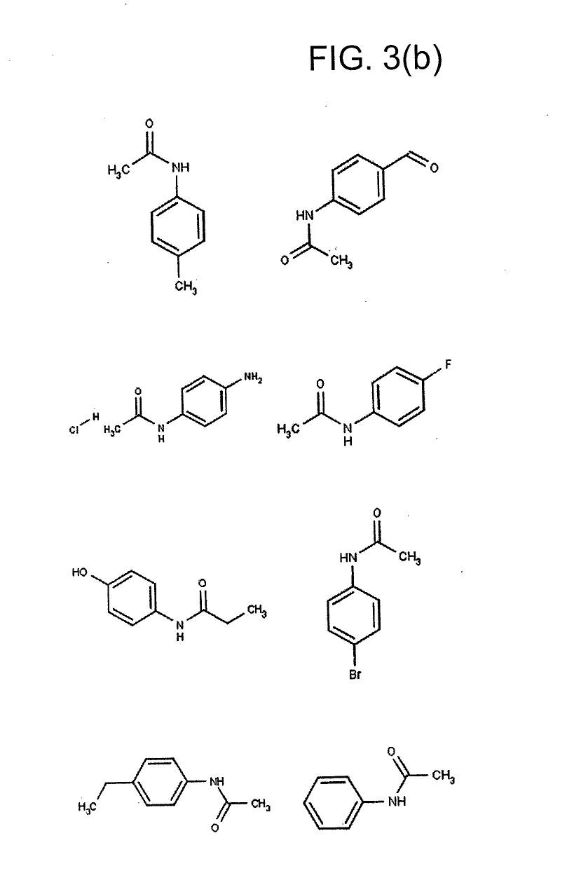

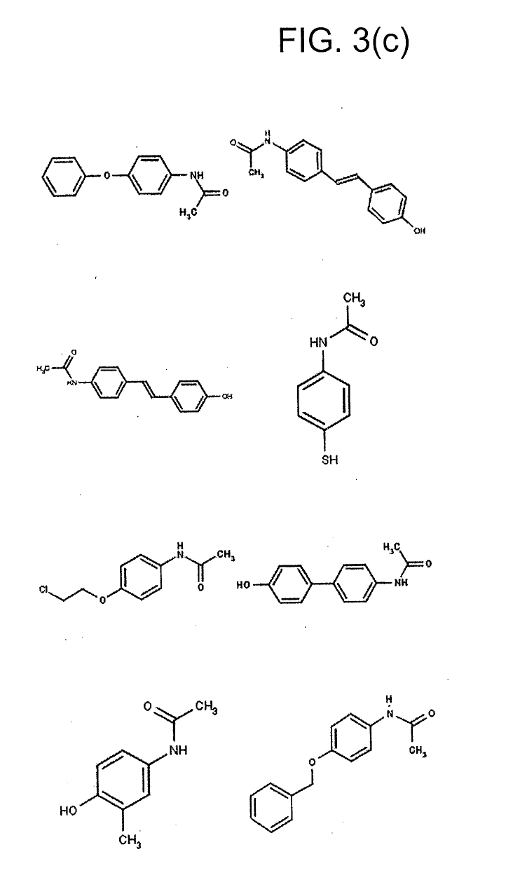

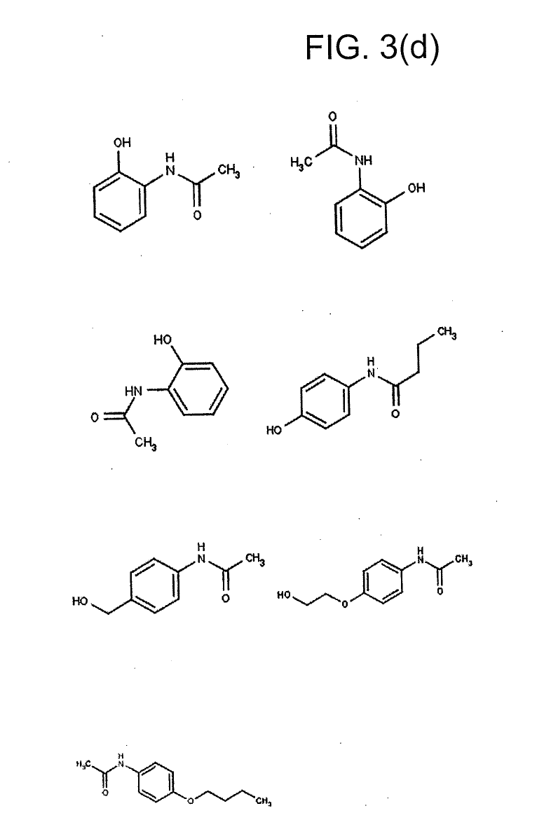

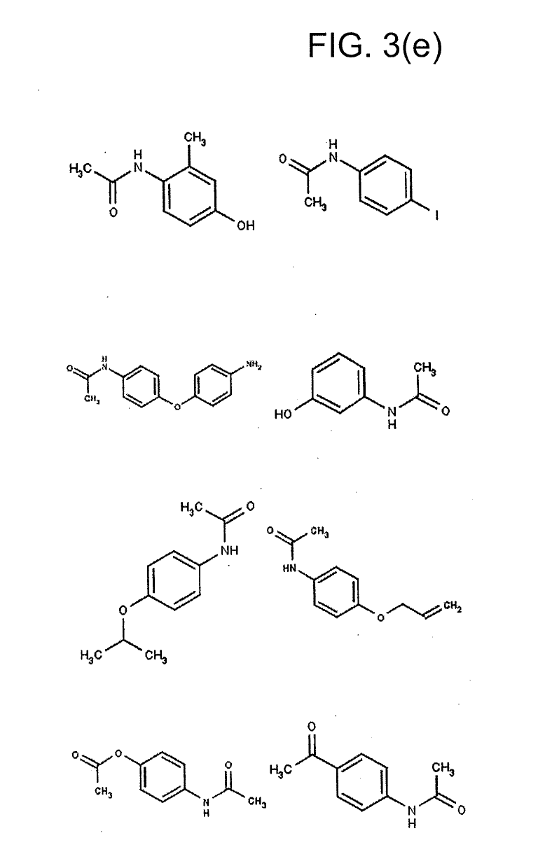

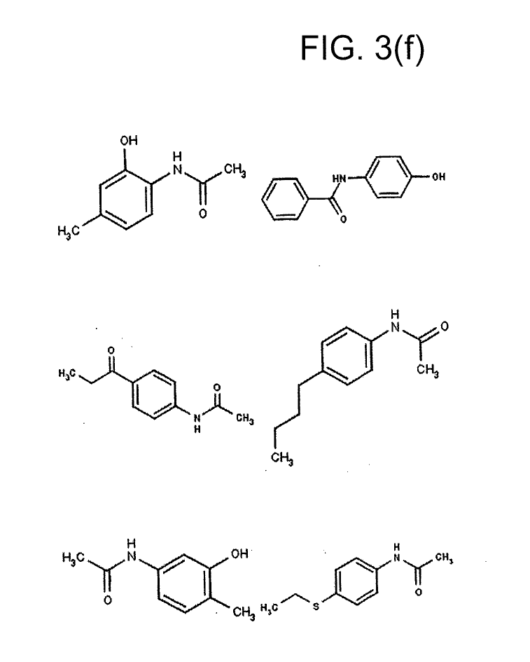

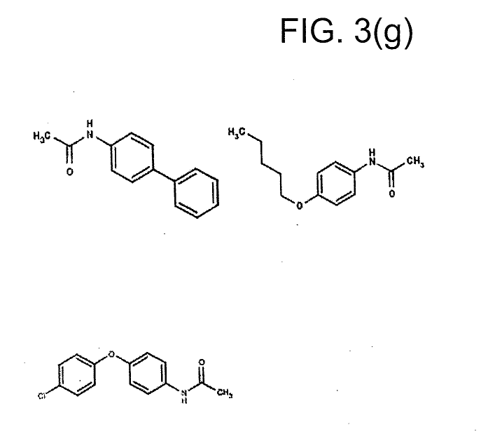

Some examples of naturally occurring auxins and some examples of the lower molecular weight conjugates which may be used in the present invention are shown in FIG. 2.

The present invention may also make use of conjugates. It is believed that plants use conjugates for storage purposes and/or to regulate the amount of free auxin available in the plant. IAA is primarily conjugated to the amino acid aspartate.

Related low molecular weight conjugates, such as IAA-Inos, IAA-Inos-arabinose and conjugates with other amino acids, and higher molecular weight conjugates, such as the IAA protein IAP1, IAA-peptides, IAA glycoprotein and IAA-glucans, have also been isolated from plants.

IAA and its precursors undergo metabolic conversions to indole-3-lactic acid, indole-3-ethanol and IBA. IBA has been found to occur naturally in plants; although some references refer to it as a synthetic auxin. Some commentators refer to it as an auxin per se and other as a precursor to IAA.

One general class of conjugated forms consists of those linked through carbon-oxygen-carbon bridges. These compounds have been referred to generically as “ester-linked”, although some 1-0 sugar conjugates such as 1-O-IAA-Gluc are actually linked by acyl alkyl acetal bonds. Typical ester-linked moieties include 6-O-IAGluc, IAA-Inos, IAA-glycoproteins, IAA-glucans and simple methyl and ethyl esters. The other type of conjugates present in plants are linked through carbon-nitrogen-carbon amide bonds (referred to as “amide-linked”), as in the IAA-amino acid and protein and peptide conjugates (see FIG. 2).

Biochemical pathways that result in IAA production within a plant tissue include: (A) de novo synthesis, whether from tryptophan [referred to as Trp-dependent (Trp-D) IAA synthesis], or from indolic precursors of Trp [referred to as Trp-independent (Trp-I) IAA synthesis, since these pathways bypass Trp]; (B) hydrolysis of both amide- and ester-linked IAA conjugates; (C) transport from one site in the plant to another site; and (D) conversion of IBA to IAA. IAA turnover mechanisms include: (E) oxidative catabolism; (F) conjugate synthesis; (G) transport away from a given site; and (H) conversion of IAA to IBA. The present invention makes use of such precursors and metabolites along this pathway. The present invention does not make use of inactive metabolites, such as arise from catabolism of the auxin.

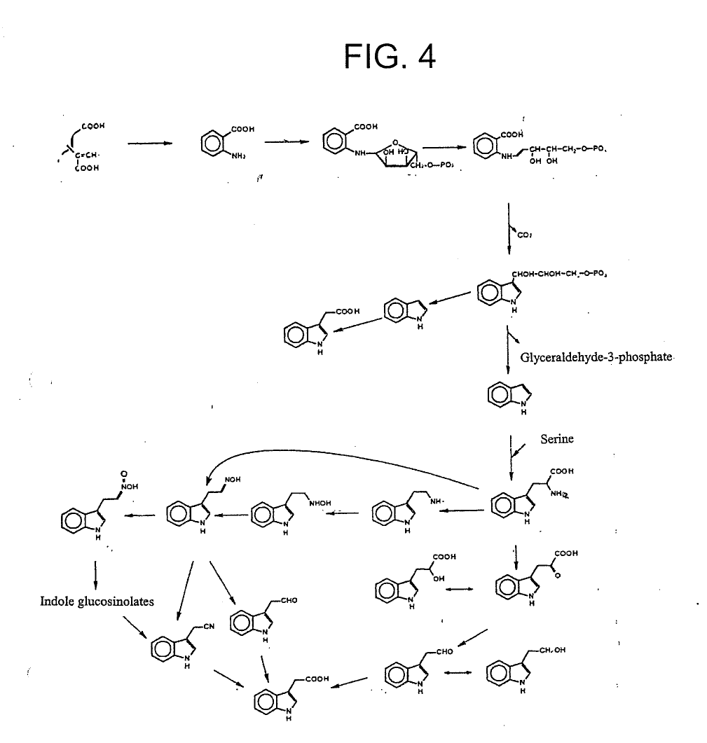

Normally the present invention makes use of the tryptophan-dependent pathway. A summary of the reactions leading from chorismate—the first committed step of indolic metabolism—to IAA and tryptophan is shown in FIG. 4.

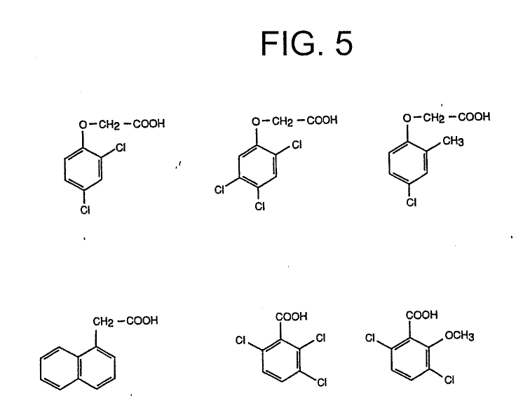

The present invention also encompasses the use of synthetic auxins. Some examples of synthetic auxins are shown in FIG. 5.

A comparison of the compounds that possess auxin activity reveals that at neutral pH they all have a strong negative charge on the carboxyl group of the side chain that is separated from a weaker positive charge on the ring structure by a distance of about 0.5 nm. It has been proposed that an indole is not essential for activity, but that it can be an aromatic or fused aromatic ring of a similar size. A model has been proposed as being a planar aromatic ring-binding platform, a carboxylic acid-binding site and a hydrophobic transition region that separates the two binding sites.

The present invention involves the use of acetaminophen.

Acetaminophen has the IUPAC name, N-(4-hydroxypheyl)acetamide and is commonly referred to as paracetamol. It has the CAS number 103-90-2.

Its formula is:

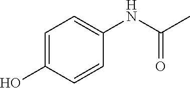

As described above, derivatives of acetaminophen are also useful in the present invention.

The compounds or compositions of the present invention can be used in combination with other components, as appropriate.

The present invention provides the use in a safening composition of a compound selected from a) glucose, hydrolysed starch, sucrose, fructose, glycerol, glyceraldehydes, erythrose, ribulose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid in some embodiments.

By “effective amount” we include an amount of the compound or composition of the present invention which is sufficient to achieve the desired “safening response”. In general by “safening response” we mean protecting the crop plants whilst not reducing the activity of the active ingredient being applied to the crop.

The compound may be defined as belonging to one or more of the following classes (a) to (f); although two or more such additives in the same or different classes may be used:
(a) glucose, hydrolysed starch, sucrose, fructose, glycerol, glyceraldehyde, erythrose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate, which will normally be applied at 10 to 10,000 g/ha (grams per hectare). Without wishing to be bound by any theory the component may function as
(1) A source for the production of high energy bonds as in adenosine trisephosphate (ATP) production,
(2) For the formation of reduced nicotinamide adenine dinucleotide (NADH) and reduced nicotamide adenine dinucleotide phosphate (NADPH) and
(3) As precursors of amino acids and nucleotides;
(b) an organic acid of the Krebs Tricarboxylic Acid Cycle or a metabolic precursor thereof, (including citric, succinic, malic, pyruvic, acetic and fumaric acids), which will normally be applied at similar rates to and used for similar functions as the carbohydrate source;
(c) a vitamin or coenzyme, e.g. thiamine, riboflavin, pyridozine, pyridoxamine, pyridoxal, nicotinamide, folic acid, or a precursor thereof including nicotinic acid, which will normally be applied at 0.01 to 500 g/ha to stimulate metabolic processes dependent on enzymatic action;
(d) a purine or pyrimidine nucleoside, nucleotide or a metabolic precursor thereof, e.g. adenine, adenosine, thymine, thymidine, cytosine, guanine, guanosine, hypoxanthine, uracil, uridine or inosine, which will normally be applied at 1 to 500 g/ha to act as structural precursors for nucleic acid synthesis;
(e) a naturally occurring fat or oil including olive, soya, coconut and corn oils, which can be degraded by living organisms to fatty acids and which will normally be applied at 10 to 10,000 g/ha;
(f) an amino acid of a type that occurs naturally in plant proteins, e.g. glycine, alanine, valine, leucine, isoleucine, serine, threonine, cysteine, methionine, aspartic acid, glutamic, acid, glutamine, asparagine, lysine, hyroxylysine, arginine, histidine, phenylalanine, tyrosine, tryptophan, proline or hydroxyproline, which will normally be applied at 1 to 500 g/ha to act as structural units for newly formed proteins or by their degradation to function in a similar manner to fatty acids and carbohydrates.

Other ingredients such as adjuvants may be added to the safening solution. The adjuvants can facilitate spreading and efficacy, and improve the adhesion properties of the composition, and generally include oils, antifoaming agents and surfactants. Such components which are useful in the present invention include, but are not limited to: terpene, Brij family (polyoxyethylene fatty alcohol ether) from Uniqema (Castle, Del.); surfactant in Tween family (Polyoxyethylene sorbitan esters) from Uniqema (Castle, Del.); Silwet family (Organosilicone) from Union Carbide (Lisle, Ill.); Triton family (Octylphenol ethoxylate) from The Dow Chemical Company (Midland, Mich.); Tomadol family (ethoxylated linear alcohol) from Tomah3 Products, Inc. (Milton, Wis.); Myrj family (Polyoxyethylene (POE) fatty acid esters) from Uniqema (Castle, Del.); Span family (Sorbitan ester) from Uniqema (Castle, Del.); and Trylox family (Ethoxylated Sorbitol and Ethoxylated Sorbitol Esters) from Cognis Corporation (Cincinnati, Ohio) as well as commercial surfactant Latron B-1956 (77.0% modified phthalic/glycerol alkyl resin and 23.0% Butyl alcohol) from Rohm & Haas (Philadelphia, Pa.); Caspil (Blend of Polyether-polymethylsiloxanecopolymer and nonionic surfactant) from Aquatrols (Paulsboro, N.J.); Agral 90 (Nonyl phenol ethoxylate) from Norac Concept, Inc. (Orleans, Ontario, Canada); Kinetic (99.00% Proprietary blend of polyalkyleneoxide modified polydimethylsiloxane and nonionic surfactants) from Setre Chemical Company (Memphis, Tenn.); and Regulaid (90.6% 2-butoxyethanol, poloxalene, monopropylene glycol) from KALO, Inc. (Overland Park, Kans.).

When the final solution is to be applied to plants which, because of their hairy or waxy surface, may be difficult to wet, it may be particularly advantageous to include such other additives, commonly known in the agrochemical industry, such as surfactants, wetting agents, spreaders and stickers. (Examples of wetting agents include silicone surfactants, nonionic surfactants such as alkyl ethoxylates, anionic surfactants such as phosphate ester salts and amphoteric or cationic surfactants such as fatty acid amido alkyl betaines).

The compounds of the invention may be the sole active ingredient of the composition or they may be admixed with further active ingredients such as nematicides, insecticides, synergists, herbicides, fungicides, fertilisers, chemically thinning agents, abscission delay agents or plant growth regulators where appropriate.

In a particularly preferred embodiment, the one or more compounds of the invention are administered in combination optionally with one or more active agents. In such cases, the compounds of the invention may be administered consecutively, simultaneously or sequentially with each other or the one or more active agents. The major advantages of combining the compounds are that it may promote additive or possible synergistic effects through e.g. biochemical interactions. Beneficial combinations may be suggested by studying the activity of the test compounds. This procedure can also be used to determine the order of administration of the agents, i.e. before, simultaneously or after delivery.

In order to apply the composition to the plant or environs of the plant, the composition may be used as a concentrate or more usually is formulated into a composition which includes an effective amount of the composition of the present invention together with a suitable inert diluent, carrier material and/or surface active agent. Preferably the composition is in the form of an aqueous solution which may be prepared from the concentrate. By effective amount we mean that the composition (and/or its individual components) provides an improved effect.

The applied concentration of chemical can vary widely depending on the water volume applied to plants as well as other factors such as plant age and size, and plant sensitivity to the product. Typical rates of AN-related compounds would be 1-10 g/ha (preferably and as used in these trials, 1 g per hectare was applied), typical rates of acetaminophen or its derivatives would be 1-10 g/ha (preferably and as used in these trials, 3 g per hectare was applied). Typical rates of the agrochemically acceptable additive of the present invention would be 1-10 g/ha (preferably and as used in these trials, less than 3 g per hectare was applied). The rate of other components such as spreaders and stickers can be 50-200 ml per ha.

Non-limiting examples of insecticides in relation to which the composition of the present invention may be useful include chlorinated hydrocarbons such as Aldrin, Chlordane, Chlordecone, DDT, Dieldrin, Endosulfan, Endrin, Heptachlor, Hexachlorobenzene, Lindane (gamma-Hexachlorocyclohexane), Methoxychlor, Mirex, Pentachlorophenol, TDE; organophosphates such as Acephate, Azinphos-methyl, Bensulide, Chlorethoxyfos, Chlorpyrifos, Chlorpyriphos-methyl, Diazinon, Dichlorvos (DDVP), Dicrotophos, Dimethoate, Disulfoton, Ethoprop, Fenamiphos, Fenitrothion, Fenthion, Fosthiazate, Malathion, Methamidophos, Methidathion, Mevinphos, Naled, Omethoate, Oxydemeton-methyl, Parathion, Parathion-methyl, Phorate, Phosalone, Phosmet, Phostebupirim, Phoxim, Pirimiphos-methyl, Profenofos, Terbufos, Tetrachlorvinphos, Tribufos, Trichlorfon; carbamates such as Aldicarb, Carbofuran, Carbaryl, Fenoxycarb, Methomyl, 2-(1-Methylpropyl)phenyl methylcarbamate; Phenothiazine; pyrethroids such as Allethrin, Bifenthrin, Cypermethrin, Deltamethrin, Lambda-cyhalothrin, Permethrin, Resmethrin, Tetramethrin, Tralomethrin, Transfluthrin; neonicotinoids such as Acetamiprid, Clothianidin, Imidacloprid, Nitenpyram, Nithiazine, Thiacloprid, Thiamethoxam; plant derived such as Caffeine, Derris (rotenone), Anabasine, Anethole, Annonin, Asimina, Azadirachtin, Carapa, Cinnamon leaf oil, Cinnamaldehyde, Cinnamyl acetate, Deguelin, Derris, Desmodium caudatum, Eugenol, Linalool, Myristicin, Neem (Azadirachtin), Nicotiana rustica (Nicotine), Peganum harmala, Oregano oil, Polyketide, Pyrethrum, Quassia, Tetranortriterpenoid, Thymol.

Non-limiting examples of fungicides in relation to which the composition of the present invention may be useful include (3-ethoxypropyl)mercury bromide, 2-methoxyethylmercury chloride, 2-phenylphenol, 8-hydroxyquinoline sulfate, 8-phenylmercurioxyquinoline, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boscalid, bridged diphenyl fungicides, bromuconazole, bupirimate, Burgundy mixture, buthiobate, butylamine, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides dichlofluanid, dichlone, dichlorophen, dichlorophenyl, dicarboximide fungicides, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfuram, ditalimfos, dithianon, dithiocarbamate fungicides, DNOC, dodemorph, dodicin, dodine, DONATODINE, drazoxolon, edifenphos, epoxiconazole, etaconazole, etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fludioxonil, flumetover, flumorph, fluopicolide, fluoroimide, fluotrimazole, fluoxastrobin, fluquinconazole, flusilazole, flusulfamide, flutolanil, flutriafol, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isoprothiolane, isovaledione, kasugamycin, kresoxim-methyl, Lime sulfur (lime sulphur), mancopper, mancozeb, maneb, mebenil, mecarbinzid, mepanipyrim, mepronil, mercuric chloride, mercuric oxide, mercurous chloride, mercury fungicides, metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulfonanilide, nabam, natamycin, nystatin, nitrostyrene, nitrothal-isopropyl, nuarimol, OCH, octhilinone, ofurace, oprodione, organomercury fungicides, organophosphorus fungicides, organotin fungicides, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinomethionate, quinone fungicides, quinoxaline fungicides, quinoxyfen, quintozene, rabenzazole, salicylanilide, silthiofam, simeconazole, sodium azide, sodium orthophenylphenoxide, sodium pentachlorophenoxide, sodium polysulfide, spiroxamine, streptomycin, strobilurin fungicides, sulfonanilide fungicides, sulfur, sultropen, TCMTB, tebuconazole, tecloftalam, tecnazene, tecoram, tetraconazole, thiabendazole, thiadifluor, thiazole fungicides, thicyofen, thifluzamide, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, Undecylenic acid, uniconazole, uniconazole-P, urea fungicides, validamycin, valinamide fungicides, vinclozolin, zarilamid, zinc naphthenate, zineb, ziram, zoxamide.

Non-limiting examples of fertilizers in relation to which the composition of the present invention may be useful include nitrogen fertilizers such as ammonium, ammonium sulphate, ammonium chloride, ammonium sulphate nitrate, ammonium nitrate, calcium ammonium nitrate, sodium nitrate, calcium nitrate, potassium nitrate, urea; phosphate fertilizers such as single superphosphate, triple superphosphate, diammonium phosphate, monoammonium phosphate, ground phosphate rock, rock phosphate, rock phosphate; potash fertilizers such as muriate of potash (potassium chloride), sulphate of potash, sulphate of potash magnesia; magnesium fertilizers such as kieserite, epsom salts, magnesium sulfate (Epsom salts); complex fertilizers such as urea-ammonium nitrate NPK fertilizers, NP fertilizers, NK fertilizers and PK fertilizers; aluminium sulfate, Ferrous sulfate, phosphite fertilizers; thiosulphate fertilizers.

Non-limiting examples of plant growth regulators in relation to which the composition of the present invention may be useful include abscisic acid or a derivative thereof, a cytokinin, ethylene or a gibberlin.

Non-limiting examples of the plant growth regulator in relation to which the composition of the present invention may be useful include p-Chlorophenoxyacetic acid (4-CPA), 2-CPA, 2,4-Dichlorophenoxyacetic acid, 2,4-Dichlorophenoxyacetic acid Sodium salt, Indole-3-acetic acid Free acid (IAA), Indole-3-acetic acid Sodium salt, Indole-3-acetic acid methyl ester, Indole-3-acety-L-aspartic acid, Indole-3-butyric acid (IBA), Indole-3-butyric acid Potassium salt (K-IBA), alpha-Naphthaleneacetic acid Free acid (NAA), beta-Naphthoxyacetic acid Free acid (NOA), Phenylacetic acid (PAA), Picloram, 2,4,5-Trichlorophenoxyacetic acid (2,4,5-T), 2,3,5-Triiodobenzoic acid Free acid (TIBA), Adenine Free base, Adenine hemisulfate salt, 6-Benzylaminopurine (BA), 6-Benzylaminopurine Hydrochloride, N-Benzyl-9-(2-tetrahydropyranyl) adenine (BPA), N-(2-Chloro-4-pyridyl)N′-phenylurea (4-CPPU), 6-(gamma, gamma-Dimethylallylamino)purine (2iP), 1,3-Diphenylurea (DPU), Kinetin, Kinetin Hydrochloride, 1-Phenyl-3-(1,2,3-thiadiazol-5-yl)urea, trans-Zeatin Free base, Zeatin, trans-Zeatin Hydrochloride, trans-Zeatin riboside, (±)-cis,trans-Abscisic acid (ABA), Ancymidol, Chlorocholine chloride (CCC), chlormequat chloride+choline chloride (5C chlormequat), 3,6-Dichloro-o-anisic acid (Dicamba), Gibberellic acid (GA₃), Gibberellic acid Potassium salt (K-GA₃), Gibberellin A₄ Free acid (GA₄), (±)-jasmonic acid, Phloroglucinol, N-(Phosphonomethyl)glycine (Glyphosate), Succinic acid 2,2-dimethylhydrazide, trinexapacethyl or metconazole.

The plant growth regulator may be other than a naturally occurring plant hormone.

Further non-limiting examples of the plant growth regulator include antiauxins, such as: clofibric acid and 2,3,5-tri-iodobenzoic acid; auxins such as 4-CPA, 2,4-D, 2,4-DB, 2,4-DEP, dichlorprop, fenoprop, IAA, IBA, naphthaleneacetamide, α-naphthaleneacetic acid, 1-naphthol, naphthoxyacetic acid, potassium naphthenate, sodium naphthenate, 2,4,5-T; cytokinins such as 2iP, benzyladenine, kinetin, zeatin; defoliants such as calcium cyanamide, dimethipin, endothal, ethephon, merphos, metoxuron, pentachlorophenol, thidiazuron, tribufos; ethylene inhibitors such as aviglycine, 1-methylcyclopropene; ethylene releasers such as ACC, etacelasil, ethephon, glyoxime; gibberellins such as gibberellins, gibberellic acid; growth inhibitors such as abscisic acid, ancymidol, butralin, carbaryl, chlorphonium, chlorpropham, dikegulac, flumetralin, fluoridamid, fosamine, glyphosine, isopyrimol, j asmonic acid, maleic hydrazide, mepiquat, mepiquat chloride, piproctanyl, prohydrojasmon, propham, 2,3,5-tri-iodobenzoic acid; morphactins such as chlorfluren, chlorflurenol, dichlorflurenol, flurenol; growth retardants such as chlormequat, daminozide, flurprimidol, mefluidide, paclobutrazol tetcyclacis, uniconazole; growth stimulators such as brassinolide, forchlorfenuron, hymexazol; and unclassified plant growth regulators such as benzofluor, buminafos, carvone, ciobutide, clofencet, cloxyfonac, cyanamide, cyclanilide, cycloheximide, cyprosulfamide, epocholeone, ethychlozate, ethylene, fenridazon, heptopargil, holosulf, inabenfide, karetazan, lead arsenate, methasulfocarb, prohexadione, pydanon, sintofen, triapenthenol, trinexapac.

Non-limiting examples of herbicides in relation to which the composition of the present invention may be useful include aminopyralid, glufosinate ammonium, fluoroxypyr, imazapic, pendimethlin, sodium chlorate, chloroacetamindes such as metalchlor, acetochlor, butachlor, propachlor, thenylchlor; amides such as dimethenamid, propanil, naptalam, pronamide, bensulide, pethoxamid; organoarsenicals such as cacodylic acid and its sodium salt, disodium methanearsonate, monosodium methanearsonate; benzoic acids and derivatives thereof such as dicamba, chlorfenac, chloramben; nitriles such as dichlobenil and bromoxynil, 2,6-dichlorobenzonitrile, Ioxynil; benzothiadiazoles such as bentazone; bipyridyliums such as diquat, paraquat, difenzoquat; carbamates such as propham, chloropropham, asulam; phenyl-carbamates such as phenmedipham, desmedipham; chlorinated aliphatic acids such as TCA, dalapon; cyclohexanediones such as sethoxydim, clethodim, cycloxydim, tralkoxydim, tepraloxydim; dinitroanilines such as benefin, oryzalin, pendimethalin, isopropalin; dinitrophenols such as DNOC, DINOSEB; diphenyl ethers such as nitrophen, bifenox, fomesafen, acifluorfen, lactofen, oxyfluorfen; imidazolinones such as imazamox, imazapyr, imazaquin, imazamethabenz-methyl, imazethapyr; triazolopyrimidines such as flumetsulam, metosulam, chloransulam, disclosulam; aryloxphenoxy propionates such as fluazifop-butyl, propaquizafop, quizalofop-P, metamifop, pyriftalid; phenoxys such as 2,4-D, 2,4,5-T, 2,4-DB, MCPA, silvex, 2,4-DP, MCPB, MCPP; ureas such as fluometuron, linuron, diuron and monuron, fenuron-TCA, siduron, tebuthiuron, isoproturon, cumyluron; phosphono amino acids such as glyphosate, glufosinate, fosamine and glyphosate trimesium; phthalic acid such as chlorthal, endothall; pyridazinones such as pyrazon, norflurazon, fluridone, fluorochloridone, clomazone, oxadiazon, beflubutamid, picolinafen, oxadiargyl; carboxylic acids such as picloram, triclopyr, fluoroxypyr, clopyralid, quinclorac; pyridines such as dithiopyr, thiazopyr; sulfonylureas such as chlorsulfuron, chlorimuron-ethyl, metsulfuron-methyl, sulfometuron-methyl, halosulfuron-methyl, sulfometuron-methyl, bensulfuron, nicosulfuron, triasulfuron, primisulfuron-methyl, amidosulfuron, azimsulfuron, cyclosulfamuron, ethametsulfuron-methyl, ethoxysulfuron, flupyrsulfuron-methyl, foramsulfuron, iodosulfuron-methyl, mesosulfuron-methyl, oxasulfuron, prosulfuron, rimsulfuron, sulfosulfuron, tribenuron-methyl, trifloxysufuron, triflusulfuron-methyl, tritosulfuron, foramsulfuron, iodosulfuron-methyl, thiocarbamates such as EPTC, pebulate, thiobencarb, butylate, cycloate, molinate, vernolate, diallate, triallate; triazines such as atrazine, prometryn, ametryn, and terbutryne; triazinones such as metribuzin and hexazinone; triazoles such as amitrol; uracils such as bromacil, terbacil, lenacil; benzoylcyclohexanediones such as mesotrione, sulcotrione, benzofenap; N-phenyl-phthalimides-cinidon-ethyl; oxazolidinediones such as pentoxazone; phenyl-pyrazoles such as pyraflufen-ethyl; pyrimidindiones such as butafenacil; sulfonyamino-carbonyl-triazolinones such as flucarbazone, propoxycarbazone; tetrazolinones such as fentrazamide; triazolinones such as amicarbazone; flufenpyr-ethyl; oxoziclomefone; benzobicyclon; soaps; petroleum oils.

Non-limiting examples of abscission delay agents in relation to which the composition of the present invention may be useful include 1-naphthaleneacetic acid (NAA), NAAm, 2,4-D, 2,4,5-T, 2,4,5-TP, amino-oxyacetic acid, aminoethoxyvinylglycine (AVG) and daminozide.

It will be appreciated that the active ingredient and safener should be different to each other.

The composition of the present invention may also include trace elements such as iron, manganese, boron, copper, cobalt, molybdenum and zinc. Preferably, the trace element is cobalt. In one embodiment cobalt is in the form of cobalt sulphate.

In a particularly preferred embodiment, the one or more compounds of the invention are administered in combination optionally with one or more active agents. In such cases, the compounds of the invention may be administered consecutively, simultaneously or sequentially with each other or the one or more active agents. The major advantages of combining the compounds are that it may promote additive or possible synergistic effects through e.g. biochemical interactions. Beneficial combinations may be suggested by studying the activity of the test compounds. This procedure can also be used to determine the order of administration of the agents, i.e. before, simultaneously or after delivery.

The rate and timing of application will depend on a number of factors known to those skilled in the art, such as the type of species etc. A second or further application(s) can be made as appropriate. The timings between each application may be in the region of 5 days or more.

The present invention relates to a method of safening plants which comprises applying to the plants or to the locus thereof an effective controlling amount of the compounds/compositions of the present invention.

The compositions of the present invention can be applied to the soil, plant, seed, or other area to be protected. Preferably the present invention is applied to the foliage of plants. The composition may be applied in the form of dusting powders, wettable powders, granules (slow or fast release), water dispersible granules, emulsion or suspension concentrates, liquid solutions, emulsions, seed dressings, or controlled release formulations such as microencapsulated granules or suspensions, soil drench, irrigation component, or preferably a foliar spray.

Dusting powders are formulated by mixing the active ingredient with one or more finely divided solid carriers and/or diluents, for example natural clays, kaolin, pyrophyllite, bentonite, alumina, montmorillonite, kieselguhr, chalk, diatomaceous earths, calcium phosphates, calcium and magnesium carbonates, sulfur, lime, flours, talc and other organic and inorganic solid carriers.

Granules are formed either by absorbing the active ingredient in a porous granular material for example pumice, attapulgite clays, fuller's earth, kieselguhr, diatomaceous earths, ground corn cobs, and the like, or on to hard core materials such as sands, silicates, mineral carbonates, sulfates, phosphates, or the like. Agents which are commonly used to aid in impregnation, binding or coating the solid carriers include aliphatic and aromatic petroleum solvents, alcohols, polyvinyl acetates, polyvinyl alcohols, ethers, ketones, esters, dextrins, sugars and vegetable oils, with the active ingredient. Other additives may also be included, such as emulsifying agents, wetting agents or dispersing agents.

Microencapsulated formulations (microcapsule suspensions CS) or other controlled release formulations may also be used, particularly for slow release over a period of time, and for seed treatment.

Alternatively and preferred the compositions may be in the form of liquid preparations to be used as dips, irrigation additives or sprays, which are generally aqueous dispersions or emulsions of the active ingredient in the presence of one or more known wetting agents, dispersing agents or emulsifying agents (surface active agents). The compositions which are to be used in the form of aqueous dispersions or emulsions are generally supplied in the form of an emulsifiable concentrate (EC) or a suspension concentrate (SC) containing a high proportion of the active ingredient or ingredients. An EC is an homogeneous liquid composition, usually containing the active ingredient dissolved in a substantially non-volatile organic solvent. An SC is a fine particle size dispersion of solid active ingredient in water. To apply the concentrates they are diluted in water and are usually applied by means of a spray to the area to be treated.

Suitable liquid solvents for ECs include methyl ketone, methyl isobutyl ketone, cyclohexanone, xylenes, toluene, chlorobenzene, paraffins, kerosene, white oil, alcohols (for example, butanol), methylnaphthalene, trimethylbenzene, trichloroethylene, N-methyl-2-pyrrolidone and tetrahydrofurfuryl alcohol (THFA).

These concentrates are often required to withstand storage for prolonged periods and after such storage, to be capable of dilution with water to form aqueous preparations which remain homogeneous for a sufficient time to enable them to be applied by conventional spray equipment. The concentrates may contain 1-85% by weight of the active ingredient or ingredients. When diluted to form aqueous preparations such preparations may contain varying amounts of the active ingredient depending upon the purpose for which they are to be used.

The composition may also be formulated as powders (dry seed treatment DS or water dispersible powder WS) or liquids (flowable concentrate FS, liquid seed treatment LS), or microcapsule suspensions CS for use in seed treatments. The formulations can be applied to the seed by standard techniques and through conventional seed treaters. In use the compositions are applied to the plants, to the locus of the plants, by any of the known means of applying fertiliser compositions, for example, by dusting, spraying, or incorporation of granules.

As indicated above, the composition of the present invention can be applied at the same time as or at an appropriate interval to the agrochemical. This can be readily determined by a skilled worker, e.g. it may be in the range of 1-3 days prior to application of the agrochemical.

As indicated above, the compositions according to this present invention may be applied to the foliage of plants but may also be applied to the soil or added to the irrigation water.

The present invention is useful in relation to crops. It will be appreciated that the present invention may be applicable to all horticultural and agricultural species.

The present invention is useful in relation to fruit crops. The crops can include trees, bushes, shrubs and vines.

The present invention is useful in relation to vegetable crops.

The present invention is useful in relation to agricultural and horticultural crops including ornamentals.

The present invention is useful in relation to cereals and grasses and to pod-bearing, bean and oilseed crops.

Particularly, but not exclusively, when the present invention is used in combination with a chemical thinner the present invention is useful in relation to fruit crops. The crops can include trees, bushes, and vines.

Particularly, but not exclusively, when the present invention is used in combination with cobalt the present invention is useful in relation to nitrogen-fixing crops. The nitrogen-fixing crops can include soybean, navy bean and pea.

The present invention can be used on the following plants as non-limiting examples: Almond (Prunus dulcis), Apple (Malus domestica), Apricot (Prunus armeniaca), Avocado (Persea americana), Banana, Plantain (Musa spp.), Blackberries (Rubus spp), Blueberries (Vaccinium spp), Cacao or cocoa (Theobroma cacao), Cashew (Anacardium occidentale), Chemies (Prunus cerasus, P. avium), Chestnuts (Castanea spp.), Coconut (Cocos nucifera), Coffee (Coffea arabica, C. canephora), Cranberry (Vaccinium macrocarpon), Currants (Ribes spp), Date (Phoenix dactylifera), Fig (Ficus carica), Gooseberry (Ribes grossularia; R. hirtellum), Grapefruit (Citrus paradisi), Grapes (Vitis vinifera, other Vitis spp), Guava (Psidium guajava & related spp), Hazelnut or filbert (Corylus avellana), Juneberry (Amelanchier alnifolia), Kiwifruit (Actinidia deliciosa), Kumquat (Fortunella spp), Lemon (Citrus limon), Lime (Citrus aurantifolia), Loquat (Eriobotrya japonica), Macadamia (Macadamia integrifolia), Mango (Mangifera indica), Mayhaw (Crataegus spp.), Oil Palm (Elaeis guineensis), Olive (Olea europaea), Orange (Citrus sinensis), Papaya (Carica papaya), Peach (Prunus persica), Pears (Pyrus communis, P. pyrifolia), Pecan (Carya illinoensis), Pineapple (Ananas comosus), Pistachio (Pistacia vera), Plums (Prunus domestica, P. salicina), Pomegranate (Punica granatum), Quince (Cyclonia oblonga), Raspberries (Rubus idaeus, R. occidentalis), Strawberry (Fragaria X ananassa), Tangerine (Citrus reticulata), Walnut (Juglans regia Chrysanthemum, and Rhododendron including Azalea species (e.g. Azaleastrum), Kalanchoe, Bulb crops, Crocus, Tulip, Narcissus, Hyacinth, Poinsettia and Roses, tomatoes, squash, pumpkin, beans, broccoli, green beans, asparagus, peas, corn, carrots, spinach, cauliflower, lima beans, broad beans, french beans, runner beans, navy beans, kidney beans, lentils, cabbage, onions, courgettes, aubergines, sweet basil, leeks, artichokes, lettuce, cassaya leaves, tomatoes, cucumbers and gherkins, marrows, gourds, squashes, chillies and peppers, green onions, dry onions, red onions, shallots, garlic, chives, other alliaceous vegetables, okra, mushrooms, watermelons, cantaloupe melons, other melons, bamboo shoots, beets, chards, capers, cardoons, celery, chervil, cress, fennel, horseradish, marjoram, oyster plant, parsley, parsnips, potato, radish, rhubarb, rutabaga, savory, scorzonera, sorrel, sprouts, swede, turnip, watercress and other vegetables, Maize, wheat, rye, oat, triticale, rice, barley, sorghum, millet, buckwheat, fonio, quinoa, spelt, other cereal crops, soybean, peanut, cotton, oilseed rape, sugar cane, bamboo, sesame, jute, canola, coconut, manihot, sunflower, tobacco, ground nuts, peanuts, oil palm, hemp, flax, lucerne, alfalfa tea, perennial grass.

Particularly, but not exclusively, when the present invention is used in combination with a herbicide crops of useful plants in which the composition according to the invention can be used include cereals, for example barley and wheat, cotton, oilseed rape, maize, rice, soy beans, sugar beet and sugar cane, especially cereals and maize. Crops can also include trees, such as palm trees, coconut trees or other nuts, and vines such as grapes.

The grasses and weeds to be controlled may be both monocotyledonous species, for example Agrostis, Alopecurus, Avena, Bromus, Cyperus, Digitaria, Echinochloa, Lolium, Monochoria, Rottboellia, Sagittaria, Scirpus, Setaria, Sida and Sorghum, and dicotyledonous species, for example Abutilon, Amaranthus, Chenopodium, Chrysanthemum, Galium, Ipomoea, Nasturtium, Sinapis, Solanum, Stellaria, Veronica, Viola and Xanthium.

Crops are to be understood as also including those crops which have been rendered tolerant to herbicides or classes of herbicides (e.g. ALS-, GS-, EPSPS-, PPO- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK® (Syngenta Seeds). The Bt toxin is a protein that is formed naturally by Bacillus thuringiensis soil bacteria. Examples of toxins, or transgenic plants able to synthesise such toxins, are described in EP-A-451 878, EP-A-374 753, WO 93/07278, WO 95/34656, WO 03/052073 and EP-A-427 529. Examples of transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

The addition of the following mixtures of the compounds of the present invention are particularly mentioned:

1. The addition of Anthranilic acid (AN).
2. The addition of NAA/other auxins, or auxin mixes (eg NAA/BA).
3. The addition of a safener (SAF).
4. The addition of Anthranilic acid (AN) to a safener (SAF).
5. The addition of SAF to NAA/other auxins, or auxin mixes (eg NAA/BA).
6. The addition of SAF to AN+AC.
7. The addition of SAF to AC+NAA/other auxins, or auxin mixes (eg NAA/BA).
8. The addition to AN to AC.
9. The addition of AC to NAA/other auxins, or auxin mixes (eg NAA/BA).

These combinations and others in accordance with the present invention may give rise to an additive or synergistic effect.

The safener (SAF) may be one set out as in classes (a) to (f) above. Two or more such additives in the same or different classes may be used.

When the additive is selected from class (a) it is preferably one or more of glucose, sucrose, fructose or glycerol.

When the additive is selected from class (b) it is preferably one or more of citric or succinic acid.

When the additive is selected from class (c) it is preferably one or more of thiamine, riboflavin, pyridoxine, nicotinamide, folic acid, ascorbic acid, biotin or vitamin B12.

When the additive is selected from class (d) it is preferably adenine, thymidine, cytosine or uracil.

When the additive is selected from class (e) it is preferably a corn oil.

When the additive is selected from an amino acid (f) is it preferably one of more of glycine, alanine, valine, leucine, threonine, cysteine, methionine, glutamine, asparagine or lysine.

The following Examples further illustrate, but do not limit, the invention.

### EXPERIMENTAL RESULTS

### Example 1

### Safening of Fertilisers

Safening systems were applied to crops of winter barley, winter wheat and lettuce treated with various fertilizers (Potassium Phosphite, potassium phosphite+ammonium thiosulphate, general NPK fertiliser). The safening system and the fertilizer were applied either simultaneously or sequentially.

Winter Barley: cv Saffron, sown 27 May 2008, at four/five seeds per 9 cm pot, sown in standard multi-purpose compost of pH 6.5. Date of spraying: 23 July; Dates of measurement/scoring: 30 July, 14 August, 22 August. Sprayed: mid-tillering phase (GS23).
Winter Wheat: cv Limerick, sown 4 Jun. 2008, at four/five seeds per 9 cm pot, sown in standard multi-purpose compost of pH 6.5. Date of spraying: 23 July; Dates of measurement/scoring: 30 July, 14 August, 23 August. Sprayed: mid-tillering phase (GS23).
Lettuce: cv Set, sown 10 Jul. 2008, at one seed per pot, in John Innes No 1 compost. Date of spraying: 30 July; Dates of measurement: 7 August, 14 August, 28 August. Sprayed: 2 true leaf stage.
SAF: at least one from class (f) each at <3 g/l, plus at least one from class (c).

The results are shown in Tables 1.1 to 1.9 below.

Tables 1.1, 1.2 and 1.3 (Winter Barley):

| | | | Vigour + | |
|---|---|---|---|---|
| | Phyto + 14 | Phyto + 28 | 14 | Vigour + 28 |
| | Days | Days | Days | Days |
| LSD (5%) | 1.15 | 1.28 | 1.39 | 1.41 |
| Treatment Means | | | | |

Tables 1.4, 1.5 and 1.6 (Winter Wheat):

| | | | Vigour + | |
|---|---|---|---|---|
| | Phyto + 14 | Phyto + 28 | 14 | Vigour + 28 |
| | Days | Days | Days | Days |
| LSD (5%) | 1.27 | 1.33 | 1.38 | 1.40 |
| Treatment Means | | | | |

Tables 1.7, 1.8 and 1.9 (Lettuce):

| | | | Vigour + | |
|---|---|---|---|---|
| | Phyto + 14 | Phyto + 28 | 14 | Vigour + 28 |
| | Days | Days | Days | Days |
| LSD (5%) | 1.40 | 1.38 | 1.51 | 1.48 |
| Treatment Means | | | | |

TABLE 1.1
WINTER BARLEY - CROP SAFENING BENEFITS FROM
ADDITION OF SAFENER AND/OR ANTHRANILIC ACID AND/OR
ACETAMINOPHEN TO A PHOSPHITE FERTILISER

| | Phyto- | Phyto- | | |
|---|---|---|---|---|
| | toxicity | toxicity | Vigour | |
| | (0-9) | (0-9) | (0-9) (9 = | |
| | (0 = | (0 = | Most | Vigour |
| | Dead) + | Dead) + | Vigour) + | (0-9) + |
| Treatment | 14 Days | 28 Days | 14 days | 28 Days |
| 1. Untreated | 8.0 | 7.5 | 8.0 | 8.0 |
| 2. Untreated | 7.5 | 8.0 | 8.0 | 8.0 |
| 3. AN (Anthranilic Acid) | 7.5 | 8.0 | 7.0 | 8.0 |
| 4. AC (Acetaminophen) | 8.0 | 8.0 | 7.0 | 8.0 |
| 5. AN + AC | 7.5 | 7.5 | 7.5 | 8.0 |
| 6. AN + AC + Terpene | 7.5 | 7.5 | 7.5 | 8.0 |
| 7. SAF | 7.5 | 7.5 | 8.0 | 8.0 |
| 8. AN + SAF | 8.0 | 8.0 | 8.0 | 8.0 |
| 9. AC + SAF | 7.5 | 7.5 | 8.0 | 7.5 |
| 10 AN + AC + SAF | 8.0 | 8.0 | 8.0 | 8.0 |
| 11 AN + AC + SAF + | 8.0 | 8.0 | 8.0 | 8.0 |
| Terpene | | | | |
| 12 Potassium Phosphite | 6.5 | 6.5 | 7.5 | 7.5 |
| (KP) - 3.0 l/ha = KP x1 | | | | |
| 13 KP x2 (4.0 l/ha) | 6.5 | 6.0 | 7.0 | 7.5 |
| 14 KP x3 (5.0 l/ha) | 6.5 | 6.0 | 7.0 | 7.5 |
| 15 KP x4 (6.0 l/ha) | 5.5 | 6.0 | 6.5 | 7.0 |
| 16 KP x1 + AN | 7.0 | 6.5 | 7.5 | 7.5 |
| 17 KP x2 + AN | 7.0 | 6.5 | 7.0 | 7.0 |
| 18 KP x3 + AN | 6.5 | 6.5 | 6.5 | 7.0 |
| 19 KP x4 + AN | 6.5 | 6.0 | 6.5 | 7.5 |
| 20 KP x1 + AC | 5.5 | 6.0 | 6.0 | 7.0 |
| 21 KP x2 + AC | 5.5 | 6.0 | 5.5 | 7.0 |
| 22 KP x3 + AC | 5.0 | 5.0 | 5.5 | 7.5 |
| 23 KP x4 + AC | 5.0 | 5.5 | 5.5 | 7.0 |
| 24 KP x1 + AN + AC | 6.5 | 6.5 | 6.5 | 7.0 |
| 25 KP x2 + AN + AC | 6.5 | 6.5 | 7.0 | 7.5 |
| 26 KP x3 + AN + AC | 6.5 | 6.5 | 5.0 | 7.0 |
| 27 KP x4 + AN + AC | 6.5 | 6.5 | 6.5 | 7.5 |
| 28 KP x1 + SAF | 6.5 | 6.5 | 6.0 | 8.0 |
| 29 KP x2 + SAF | 6.0 | 7.0 | 6.0 | 7.5 |
| 30 KP x3 + SAF | 6.5 | 7.0 | 6.0 | 8.0 |
| 31 KP x4 + SAF | 6.0 | 7.0 | 6.0 | 7.0 |
| 32 KP x1 + AN + SAF | 7.0 | 7.5 | 7.0 | 7.5 |
| 33 KP x2 + AN + SAF | 7.5 | 8.0 | 7.0 | 7.5 |
| 34 KP x3 + AN + SAF | 7.0 | 7.5 | 6.5 | 7.5 |
| 35 KP x4 + AN + SAF | 7.0 | 7.5 | 6.5 | 7.5 |
| 36 KP x1 + AC + SAF | 7.5 | 7.5 | 7.0 | 8.0 |
| 37 KP x2 + AC + SAF | 7.0 | 7.5 | 7.0 | 7.5 |
| 38 KP x3 + AC + SAF | 7.5 | 7.0 | 6.5 | 7.0 |
| 39 KP x4 + AC + SAF | 6.0 | 6.5 | 6.5 | 7.5 |
| 40 KP x1 + AN + AC + SAF | 7.5 | 7.5 | 7.0 | 8.0 |
| 41 KP x2 + AN + AC + SAF | 7.5 | 7.5 | 7.0 | 8.0 |
| 42 KP x3 + AN + AC + SAF | 7.5 | 7.5 | 7.0 | 8.0 |
| 43 KP x4 + AN + AC + SAF | 7.5 | 7.5 | 7.0 | 8.0 |
| 44 KP x1 fb (followed by) | 6.5 | 6.5 | 6.5 | 7.5 |
| AN + AC after 7 days | | | | |
| 45 KP x2 fb AN + AC after 7 | 6.0 | 6.0 | 6.5 | 7.5 |
| days | | | | |
| 46 KP x3 fb AN + AC after 7 | 6.0 | 6.0 | 6.0 | 7.0 |
| days | | | | |
| 47 KP x4 fb AN + AC after 7 | 5.5 | 6.0 | 6.5 | 7.5 |
| days | | | | |
| 48 KP x1 fb AN + AC + SAF | 6.5 | 6.5 | 6.0 | 7.0 |
| After 7 days | | | | |
| 49 KP x2 fb AN + AC + SAF | 7.0 | 6.0 | 6.0 | 7.0 |
| After 7 days | | | | |
| 50 KP x3 fb AN + AC + SAF | 6.5 | 6.5 | 6.5 | 7.5 |
| After 7 days | | | | |
| 51 KP x4 fb AN + AC + SAF | 6.0 | 6.0 | 7.0 | 7.0 |
| After 7 days | | | | |
| 52 KP x1 fb AN + AC + SAF + | 6.0 | 7.0 | 6.0 | 7.0 |
| Terpene after 7 days | | | | |
| 53 KP x2 fb AN + AC + SAF + | 6.0 | 6.5 | 6.5 | 7.0 |
| Terpene after 7 days | | | | |
| 54 KP x3 fb AN + AC + SAF + | 5.5 | 6.5 | 7.0 | 7.5 |
| Terpene after 7 days | | | | |
| 55 KP x4 fb AN + AC + SAF + | 5.5 | 7.0 | 7.0 | 7.5 |
| Terpene after 7 days | | | | |
| 56 KP x1 fb SAF after | 7.0 | 7.0 | 7.0 | 7.5 |
| 7 days | | | | |
| 57 KP x2 fb SAF after | 7.0 | 7.0 | 7.0 | 7.5 |
| 7 days | | | | |
| 58 KP x3 fb SAF after | 6.5 | 7.0 | 7.0 | 7.0 |
| 7 days | | | | |
| 59 KP x4 fb SAF after | 5.5 | 6.5 | 6.5 | 7.0 |
| 7 days | | | | |

TABLE 1.2
WINTER BARLEY - CROP SAFENING BENEFITS FROM
ADDITION OF SAFENER AND/OR ANTHRANILIC ACID AND/OR
ACETAMINOPHEN TO A PHOSPHITE FERTILISER

| | Phyto- | Phyto- | | |
|---|---|---|---|---|
| | toxicity | toxicity | Vigour | |
| | (0-9) | (0-9) | (0-9) (9 = | |
| | (0 = | (0 = | Most | Vigour |
| | Dead) + | Dead) + | Vigour) + | (0-9) + |
| Treatment | 14 Days | 28 Days | 14 days | 28 Days |
| 1. Untreated | 8.0 | 7.5 | 8.0 | 8.0 |
| 2. Untreated | 7.5 | 8.0 | 8.0 | 8.0 |
| 3. AN (Anthranilic Acid) | 7.5 | 8.0 | 7.0 | 8.0 |
| 4. AC (Acetaminophen) | 8.0 | 8.0 | 7.0 | 8.0 |
| 5. AN + AC | 7.5 | 7.5 | 7.5 | 8.0 |
| 6. AN + AC + Terpene | 7.5 | 7.5 | 7.5 | 8.0 |
| 7. SAF | 7.5 | 7.5 | 8.0 | 8.0 |
| 8. AN + SAF | 8.0 | 8.0 | 8.0 | 8.0 |
| 9. AC + SAF | 7.5 | 7.5 | 8.0 | 7.5 |
| 10 AN + AC + SAF | 8.0 | 8.0 | 8.0 | 8.0 |
| 11 AN + AC + SAF + | 8.0 | 8.0 | 8.0 | 8.0 |
| Terpene | | | | |
| 12 Potassium Phosphite | 7.0 | 7.5 | 7.0 | 7.0 |
| (KP) + Ammonium | | | | |
| Thiosulphate (ATS) - 4.0 l/ha = | | | | |
| KP/ATS x1 | | | | |
| 13 KP/ATS x2 (6.0 l/ha) | 7.0 | 7.5 | 7.5 | 7.0 |
| 14 KP/ATS x3 (8.0 l/ha) | 6.5 | 7.0 | 7.0 | 7.5 |
| 15 KP/ATS x4 (10.0 l/ha) | 6.0 | 7.0 | 6.5 | 7.0 |
| 24 KP/ATS x1 + AN + AC | 6.0 | 6.5 | 7.0 | 8.0 |
| 25 KP/ATS x2 + AN + AC | 6.0 | 6.5 | 6.5 | 8.0 |
| 26 KP/ATS x3 + AN + AC | 6.0 | 7.0 | 6.5 | 7.5 |
| 27 KP/ATS x4 + AN + AC | 6.5 | 7.0 | 6.5 | 8.0 |
| 28 KP/ATS x1 + SAF | 7.5 | 8.0 | 7.5 | 8.0 |
| 29 KP/ATS x2 + SAF | 7.5 | 8.0 | 8.0 | 8.0 |
| 30 KP/ATS x3 + SAF | 7.5 | 8.0 | 7.5 | 8.0 |
| 31 KP/ATS x4 + SAF | 6.5 | 7.5 | 7.0 | 7.5 |
| 32 KP/ATS x1 + AN + AC + | 7.5 | 8.0 | 8.0 | 8.0 |
| SAF | | | | |
| 33 KP/ATS x2 + AN + AC + | 7.5 | 7.5 | 8.0 | 8.0 |
| SAF | | | | |
| 34 KP/ATS x3 + AN + AC + | 7.5 | 8.0 | 8.0 | 8.0 |
| SAF | | | | |
| 35 KP/ATS x4 + AN + AC + | 7.0 | 7.5 | 7.0 | 8.0 |
| SAF | | | | |

TABLE 1.3
WINTER BARLEY - CROP SAFENING BENEFITS FROM
ADDITION OF SAFENER AND/OR ANTHRANILIC ACID AND/OR
ACETAMINOPHEN TO GENERAL FERTILISERS.

| | | | Vigour | |
|---|---|---|---|---|
| | Phytotoxicity | Phytotoxicity | (0-9) (9 = | |
| | (0-9) (0 = | (0-9) (0 = | Most | Vigour |
| | Dead) + | Dead) + | Vigour) + | (0-9) + |
| Treatment | 14 Days | 28 Days | 14 days | 28 Days |
| 1. Untreated | 8.0 | 7.5 | 8.0 | 8.0 |
| 2. Untreated | 7.5 | 8.0 | 8.0 | 8.0 |
| 3. AN | 7.5 | 8.0 | 7.0 | 8.0 |
| 4. AC | 8.0 | 8.0 | 7.0 | 8.0 |
| 5. AN + AC | 7.5 | 7.5 | 7.5 | 8.0 |
| 6. AN + AC + | 7.5 | 7.5 | 7.5 | 8.0 |
| Terpene | | | | |
| 7. SAF | 7.5 | 7.5 | 8.0 | 8.0 |
| 8. AN + SAF | 8.0 | 8.0 | 8.0 | 8.0 |
| 9. AC + SAF | 7.5 | 7.5 | 8.0 | 7.5 |
| 10 AN + AC + | 8.0 | 8.0 | 8.0 | 8.0 |
| SAF | | | | |
| 11 AN + AC + | 8.0 | 8.0 | 8.0 | 8.0 |
| SAF + Terpene | | | | |
| 12 General NPK | 6.0 | 7.0 | 7.5 | 8.0 |
| Fertiliser + | | | | |
| micronutrients, | | | | |
| with added KP @ | | | | |
| x2 rate (4.0 l/ha) = | | | | |
| GEN + KP x2 | | | | |
| 13 GEN + KP x3 | 6.0 | 6.5 | 7.5 | 8.0 |
| (6.0 l/ha) | | | | |
| 14 GEN + KP x6 | 5.5 | 6.0 | 7.5 | 8.0 |
| (12.0 l/ha) | | | | |
| 15 GEN + KP x2 + | 6.5 | 7.0 | 8.0 | 8.0 |
| AN + AC | | | | |
| 16 GEN + KP x3 + | 6.5 | 7.0 | 7.5 | 8.0 |
| AN + AC | | | | |
| 17 GEN + KP x6 + | 6.0 | 6.5 | 8.0 | 8.0 |
| AN + AC | | | | |
| 18 GEN + KP x2 + | 7.0 | 7.0 | 8.0 | 8.0 |
| SAF | | | | |
| 19 GEN + KP x3 + | 7.0 | 7.0 | 8.0 | 8.0 |
| SAF | | | | |
| 20 GEN + KP x6 + | 7.0 | 7.0 | 7.0 | 7.5 |
| SAF | | | | |
| 21 GEN + KP x2 + | 8.0 | 8.0 | 8.0 | 8.0 |
| AN + AC + | | | | |
| SAF | | | | |
| 22 GEN + KP x3 + | 8.0 | 8.0 | 8.0 | 8.0 |
| AN + AC + | | | | |
| SAF | | | | |
| 23 GEN + KP x6 + | 7.5 | 7.5 | 7.5 | 7.5 |
| AN + AC + | | | | |
| SAF | | | | |
| 24 General NPK | 6.0 | 7.5 | 8.0 | 8.0 |
| Fertiliser + | | | | |
| micronutrients, | | | | |
| but with NO | | | | |
| added KP = | | | | |
| GENEX x2 rate | | | | |
| 25 GENEX x3 | 6.0 | 7.5 | 8.0 | 8.0 |
| rate | | | | |
| 26 GENEX x6 | 6.0 | 7.5 | 6.5 | 7.5 |
| rate | | | | |
| 27 GENEX x2 + | 6.5 | 7.5 | 8.0 | 8.0 |
| AN + AC | | | | |
| 28 GENEX x3 + | 6.5 | 7.5 | 7.5 | 8.0 |
| AN + AC | | | | |
| 29 GENEX x6 + | 6.5 | 7.5 | 7.0 | 8.0 |
| AN + AC | | | | |
| 30 GENEX x2 + | 7.0 | 7.5 | 8.0 | 8.0 |
| SAF | | | | |
| 31 GENEX x3 + | 7.0 | 8.0 | 8.0 | 8.0 |
| SAF | | | | |
| 32 GENEX x6 + | 7.0 | 7.5 | 7.5 | 8.0 |
| SAF | | | | |
| 33 GENEX x2 + | 8.0 | 8.0 | 8.0 | 8.0 |
| AN + AC + SAF | | | | |
| 34 GENEX x3 + | 8.0 | 80 | 7.5 | 8.0 |
| AN + AC + | | | | |
| SAF | | | | |
| 35 GENEX x3 + | 8.0 | 8.0 | 8.0 | 8.0 |
| AN AC + SAF | | | | |

TABLE 1.4
WINTER WHEAT - CROP SAFENING BENEFITS FROM
ADDITION OF SAFENER AND/OR ANTHRANILIC ACID AND/OR
ACETAMINOPHEN TO PHOSPHITE FERTILISER

| | Phyto- | Phyto- | | |
|---|---|---|---|---|
| | toxicity | toxicity | Vigour | |
| | (0-9) | (0-9) | (0-9) (9 = | |
| | (0 = | (0 = | Most | Vigour |
| | Dead) + | Dead) + | Vigour) + | (0-9) + |
| Treatment | 14 Days | 28 Days | 14 days | 28 Days |
| 1. Untreated | 7.5 | 8.0 | 8.0 | 8.0 |
| 2. Untreated | 7.0 | 8.0 | 8.0 | 8.0 |
| 3. AN (Anthranilic Acid) | 7.5 | 8.0 | 8.0 | 8.5 |
| 4. AC (Acetaminophen) | 7.0 | 8.0 | 8.0 | 8.0 |
| 5. AN + AC | 7.5 | 8.0 | 8.0 | 8.0 |
| 6. AN + AC + Terpene | 7.5 | 8.0 | 8.0 | 8.0 |
| 7. SAF | 7.5 | 8.0 | 8.0 | 8.0 |
| 8. AN + SAF | 7.0 | 8.0 | 8.5 | 8.0 |
| 9. AC + SAF | 7.0 | 8.0 | 8.0 | 8.0 |
| 10 AN + AC + SAF | 7.0 | 8.0 | 8.0 | 8.0 |
| 11 AN + AC + SAF + | 7.5 | 8.0 | 8.0 | 8.0 |
| Terpene | | | | |
| 12 Potassium Phosphite | 7.0 | 8.0 | 8.0 | 7.5 |
| (KP) - 3.0 l/ha = KP x1 | | | | |
| 13 KP x2 (4.0 l/ha) | 6.5 | 8.0 | | |
| 14 KP x3 (5.0 l/ha) | 6.0 | 8.0 | 7.0 | 7.5 |
| 15 KP x4 (6.0 l/ha) | 5.5 | 8.0 | 7.0 | 8.0 |
| 16 KP x1 + AN | 7.0 | 7.5 | 8.0 | 8.0 |
| 17 KP x2 + AN | 7.0 | 8.0 | 8.0 | 8.0 |
| 18 KP x3 + AN | 6.0 | 8.0 | 7.5 | 8.0 |
| 19 KP x4 + AN | 6.0 | 8.0 | 7.5 | 8.0 |
| 20 KP x1 + AC | 7.0 | 8.0 | 8.0 | 8.0 |
| 21 KP x2 + AC | 7.0 | 8.0 | 7.0 | 7.5 |
| 22 KP x3 + AC | 6.5 | 8.0 | 7.0 | 7.5 |
| 23 KP x4 + AC | 6.5 | 8.0 | 6.5 | 7.0 |
| 24 KP x1 + AN + AC | 6.0 | 8.0 | 7.5 | 8.0 |
| 25 KP x2 + AN + AC | 7.0 | 7.5 | 7.5 | 7.5 |
| 26 KP x3 + AN + AC | 7.0 | 8.0 | 7.5 | 7.5 |
| 27 KP x4 + AN + AC | 6.5 | 7.5 | 7.5 | 7.5 |
| 28 KP x1 + SAF | 7.0 | 8.0 | 8.0 | 8.0 |
| 29 KP x2 + SAF | 7.0 | 8.0 | 8.0 | 8.0 |
| 30 KP x3 + SAF | 6.5 | 8.0 | 8.0 | 8.0 |
| 31 KP x4 + SAF | 6.5 | 7.0 | 8.0 | 8.0 |
| 32 KP x1 + AN + SAF | 7.0 | 7.0 | 8.0 | 8.0 |
| 33 KP x2 + AN + SAF | 7.0 | 7.0 | 8.0 | 8.0 |
| 34 KP x3 + AN + SAF | 7.0 | 7.5 | 7.5 | 8.0 |
| 35 KP x4 + AN + SAF | 6.5 | 7.0 | 7.5 | 8.0 |
| 36 KP x1 + AC + SAF | 7.0 | 7.0 | 7.5 | 8.0 |
| 37 KP x2 + AC + SAF | 7.0 | 8.0 | 7.5 | 8.0 |
| 38 KP x3 + AC + SAF | 7.0 | 7.5 | 7.5 | 7.5 |
| 39 KP x4 + AC + SAF | 6.5 | 7.0 | 7.5 | 7.5 |
| 40 KP x1 + AN + AC + SAF | 8.0 | 8.0 | 7.5 | 7.5 |
| 41 KP x2 + AN + AC + SAF | 8.0 | 8.0 | 7.5 | 7.5 |
| 42 KP x3 + AN + AC + SAF | 8.0 | 8.0 | 7.5 | 7.5 |
| 44 KP x4 + AN + AC + SAF | 8.0 | 8.0 | 7.5 | 7.5 |
| 45 KP x1 fb AN + AC after 7 | 7.0 | 7.0 | 7.0 | 7.5 |
| days | | | | |
| 46 KP x2 fb AN + AC after 7 | 6.0 | 7.5 | 7.0 | 7.5 |
| days | | | | |
| 47 KP x3 fb AN + AC after 7 | 6.0 | 7.0 | 7.0 | 8.0 |
| days | | | | |
| 48 KP x4 fb AN + AC after 7 | 6.5 | 7.5 | 7.0 | 8.0 |
| days | | | | |
| 49 KP x1 fb AN + AC + SAF | 6.0 | 7.5 | 7.5 | 8.0 |
| after 7 days | | | | |
| 50 KP x2 fb AN + AC + SAF | 6.5 | 7.0 | 7.5 | 7.5 |
| after 7 days | | | | |
| 51 KP x3 fb AN + AC + SAF | 6.5 | 7.0 | 7.0 | 7.5 |
| after 7 days | | | | |
| 52 KP x4 fb AN + AC + SAF | 7.0 | 7.0 | 7.0 | 7.0 |
| after 7 days | | | | |
| 53 KP x1 fb AN + AC + SAF + | 6.0 | 7.0 | 8.0 | 8.0 |
| Terpene after 7 days | | | | |
| 54 KP x2 fb AN + AC + SAF + | 6.0 | 7.0 | 7.5 | 7.0 |
| Terpene after 7 days | | | | |
| 55 KP x3 fb AN + AC + SAF + | 6.0 | 7.0 | 7.5 | 7.0 |
| Terpene after 7 days | | | | |
| 56 KP x4 fb AN + AC + SAF + | 6.5 | 7.5 | 6.5 | 6.5 |
| Terpene after 7 days | | | | |
| 57 KP x1 fb SAF after | 6.5 | 7.0 | 7.0 | 7.5 |
| 7 days | | | | |
| 58 KP x2 fb SAF after | 6.0 | 7.0 | 7.0 | 7.0 |
| 7 days | | | | |
| 59 KP x3 fb SAF after | 7.0 | 7.0 | 7.0 | 6.5 |
| 7 days | | | | |
| 60 KP x4 fb SAF after | 6.0 | 7.0 | 6.5 | 6.5 |
| 7 days | | | | |

TABLE 1.5
WINTER WHEAT - CROP SAFENING BENEFITS FROM
ADDITION OF SAFENER AND/OR ANTHRANILIC ACID AND/OR
ACETAMINOPHEN TO THIOSULPHATE AND PHOSPHITE
FERTILISERS

| | Phyto- | Phyto- | | |
|---|---|---|---|---|
| | toxicity | toxicity | Vigour | |
| | (0-9) | (0-9) | (0-9) (9 = | |
| | (0 = | (0 = | Most | Vigour |
| | Dead) + | Dead) + | Vigour) + | (0-9) + |
| Treatment | 14 Days | 28 Days | 14 days | 28 Days |
| 1. Untreated | 7.5 | 8.0 | 8.0 | 8.0 |
| 2. Untreated | 7.0 | 8.0 | 8.0 | 8.0 |
| 3. AN (Anthranilic Acid) | 7.5 | 8.0 | 8.0 | 8.5 |
| 4. AC (Acetaminophen) | 7.0 | 8.0 | 8.0 | 8.0 |
| 5. AN + AC | 7.0 | 8.0 | 8.0 | 8.0 |
| 6. AN + AC + Terpene | 7.0 | 8.0 | 8.0 | 8.0 |
| 7. SAF | 7.0 | 8.0 | 8.0 | 8.0 |
| 8. AN + SAF | 7.0 | 8.0 | 8.5 | 8.0 |
| 9. AC + SAF | 7.0 | 8.0 | 8.0 | 8.0 |
| 10 AN + AC + SAF | 7.0 | 8.0 | 8.0 | 8.0 |
| 11 AN + AC + SAF + | 7.0 | 8.0 | 8.0 | 8.0 |
| Terpene | | | | |
| 12 Potassium Phosphite | 7.0 | 7.0 | 7.0 | 7.5 |
| (KP) + Ammonium | | | | |
| Thiosulphate (ATS) - | | | | |
| 4.0 l/ha = KP/ATS x1 | | | | |
| 13 KP/ATS x2 (6.0 l/ha) | 7.0 | 7.0 | 7.0 | 7.0 |
| 14 KP/ATS x3 (8.0 l/ha) | 7.0 | 7.0 | 7.0 | 6.5 |
| 15 KP/ATS x4 (10.0 l/ha) | 6.0 | 7.0 | 6.5 | 6.5 |
| 24 KP/ATS x1 + AN + AC | 7.0 | 7.0 | 7.5 | 7.0 |
| 25 KP/ATS x2 + AN + AC | 7.0 | 7.0 | 7.0 | 7.0 |
| 26 KP/ATS x3 + AN + AC | 6.5 | 7.0 | 7.0 | 7.0 |
| 27 KP/ATS x4 + AN + AC | 6.0 | 7.0 | 6.5 | 7.0 |
| 28 KP/ATS x1 + SAF | 7.0 | 7.0 | 8.0 | 8.0 |
| 29 KP/ATS x2 + SAF | 7.0 | 7.0 | 8.0 | 8.0 |
| 30 KP/ATS x3 + SAF | 7.0 | 7.0 | 8.0 | 8.0 |
| 31 KP/ATS x4 + SAF | 7.0 | 7.0 | 7.0 | 7.0 |
| 32 KP/ATS x1 + AN + AC + | 7.0 | 7.5 | 8.0 | 8.0 |
| SAF | | | | |
| 33 KP/ATS x2 + AN + AC + | 7.0 | 7.0 | 8.0 | 8.0 |
| SAF | | | | |
| 34 KP/ATS x3 + AN + AC + | 7.0 | 7.0 | 7.0 | 8.0 |
| SAF | | | | |
| 35 KP/ATS x4 + AN + AC + | 7.0 | 7.0 | 7.0 | 7.0 |
| SAF | | | | |

TABLE 1.6
WINTER WHEAT - CROP SAFENING BENEFITS FROM
ADDITION OF SAFENER AND/OR ANTHRANILIC ACID AND/OR
ACETAMINOPHEN TO GENERAL FERTILISERS.

| | | | Vigour | |
|---|---|---|---|---|
| | Phytotoxicity | Phytotoxicity | (0-9) (9 = | |
| | (0-9) (0 = | (0-9) (0 = | Most | Vigour |
| | Dead) + | Dead) + | Vigour) + | (0-9) + |
| Treatment | 14 Days | 28 Days | 14 days | 28 Days |
| 1. Untreated | 7.5 | 8.0 | 8.0 | 8.0 |
| 2. Untreated | 7.0 | 8.0 | 8.0 | 8.0 |
| 3. AN | 7.5 | 8.0 | 8.0 | 8.5 |
| 4. AC | 7.0 | 8.0 | 8.0 | 8.0 |
| 5. AN + AC | 7.0 | 8.0 | 8.0 | 8.0 |
| 6. AN + AC + | 7.0 | 8.0 | 8.0 | 8.0 |
| Terpene | | | | |
| 7. SAF | 7.0 | 8.0 | 8.0 | 8.0 |
| 8. AN + SAF | 7.0 | 8.0 | 8.5 | 8.0 |
| 9. AC + SAF | 7.0 | 8.0 | 8.0 | 8.0 |
| 10 AN + AC + | 7.0 | 8.0 | 8.0 | 8.0 |
| SAF | | | | |
| 11 AN + AC + | 7.0 | 8.0 | 8.0 | 8.0 |
| SAF + Terpene | | | | |
| 12 General NPK | 7.0 | 6.5 | 8.0 | 8.0 |
| Fertiliser + | | | | |
| micronutrients, | | | | |
| with added KP @ | | | | |
| x2 rate (4.0 l/ha) = | | | | |
| GEN + KP x2 | | | | |
| 13 GEN + KP x3 | 6.5 | 7.0 | 8.0 | 8.0 |
| (6.0 l/ha) | | | | |
| 14 GEN + KP x6 | 7.0 | 7.5 | 8.0 | 8.0 |
| (12.0 l/ha) | | | | |
| 15 GEN + KP x2 + | 6.5 | 7.0 | 7.5 | 8.0 |
| AN + AC | | | | |
| 16 GEN + KP x3 + | 6.0 | 7.0 | 8.0 | 8.0 |
| AN + AC | | | | |
| 17 GEN + KP x6 + | 6.0 | 7.0 | 7.5 | 8.0 |
| AN + AC | | | | |
| 18 GEN + KP x2 + | 7.0 | 7.5 | 8.0 | 8.0 |
| SAF | | | | |
| 19 GEN + KP x3 + | 7.0 | 7.0 | 8.0 | 8.0 |
| SAF | | | | |
| 20 GEN + KP x6 + | 7.0 | 7.0 | 8.0 | 8.5 |
| SAF | | | | |
| 21 GEN + KP x2 + | 7.0 | 7.5 | 8.0 | 8.5 |
| AN + AC + | | | | |
| SAF | | | | |
| 22 GEN + KP x3 + | 7.0 | 7.5 | 7.5 | 8.0 |
| AN + AC + | | | | |
| SAF | | | | |
| 23 GEN + KP x6 + | 7.0 | 8.0 | 7.5 | 8.5 |
| AN + AC + | | | | |
| SAF | | | | |
| 24 General NPK | 7.0 | 8.0 | 8.0 | 8.0 |
| Fertiliser + | | | | |
| micronutrients, | | | | |
| but with NO | | | | |
| added KP = | | | | |
| GENEX x2 rate | | | | |
| 25 GENEX x3 | 7.0 | 8.0 | 8.0 | 8.0 |
| rate | | | | |
| 26 GENEX x6 | 7.0 | 7.5 | 6.0 | 7.0 |
| rate | | | | |
| 27 GENEX x2 + | 7.0 | 7.5 | 8.0 | 8.0 |
| AN + AC | | | | |
| 28 GENEX x3 + | 7.0 | 8.0 | 8.0 | 8.0 |
| AN + AC | | | | |
| 29 GENEX x6 + | 7.0 | 7.5 | 6.5 | 7.0 |
| AN + AC | | | | |
| 30 GENEX x2 + | 7.0 | 7.0 | 8.0 | 8.0 |
| SAF | | | | |
| 31 GENEX x3 + | 6.5 | 7.0 | 8.0 | 8.0 |
| SAF | | | | |
| 32 GENEX x6 + | 7.0 | 7.0 | 8.0 | 8.0 |
| SAF | | | | |
| 33 GENEX x2 + | 7.0 | 7.5 | 8.0 | 8.0 |
| AN + AC + SAF | | | | |
| 34 GENEX x3 + | 7.5 | 8.0 | 8.0 | 8.0 |
| AN + AC + | | | | |
| SAF | | | | |
| 35 GENEX x3 + | 7.5 | 8.0 | 7.0 | 8.0 |
| AN AC + SAF | | | | |

TABLE 1.7
LETTUCE - CROP SAFENING BENEFITS FROM ADDITION OF
SAFENER AND/OR ANTHRANILIC ACID AND/OR
ACETAMINOPHEN TO PHOSPHITE FERTILISER

| | Phyto- | Phyto- | | |
|---|---|---|---|---|
| | toxicity | toxicity | Vigour | |
| | (0-9) | (0-9) | (0-9) (9 = | |
| | (0 = | (0 = | Most | Vigour |
| | Dead) + | Dead) + | Vigour) + | (0-9) + |
| Treatment | 14 Days | 28 Days | 14 days | 28 Days |
| 1. Untreated | 7.5 | 7.5 | 8.0 | 8.0 |
| 2. Untreated | 7.5 | 8.0 | 8.0 | 8.0 |
| 3. AN (Anthranilic Acid) | 7.0 | 7.0 | 8.0 | 8.0 |
| 4. AC (Acetaminophen) | 7.0 | 6.5 | 8.0 | 8.0 |
| 5. AN + AC | 7.0 | 7.0 | 7.5 | 8.0 |
| 6. AN + AC + Terpene | 7.0 | 7.0 | 7.5 | 8.0 |
| 7. SAF | 7.0 | 7.0 | 7.5 | 8.0 |
| 8. AN + SAF | 7.5 | 7.5 | 8.0 | 8.0 |
| 9. AC + SAF | 7.5 | 7.5 | 8.0 | 8.0 |
| 10 AN + AC + SAF | 7.5 | 8.0 | 8.0 | 8.0 |
| 11 AN + AC + SAF + | 7.5 | 8.0 | 8.0 | 8.0 |
| Terpene | | | | |
| 12 Potassium Phosphite | 7.0 | 7.0 | 7.5 | 7.5 |
| (KP) - 2.0 l/ha = KP x1 | | | | |
| 13 KP x2 (3.0 l/ha) | 7.0 | 6.5 | 8.0 | 8.0 |
| 14 KP x3 (4.0 l/ha) | 7.0 | 6.5 | 7.5 | 7.5 |
| 15 KP x4 (5.0 l/ha) | 6.5 | 6.5 | 7.0 | 7.5 |
| 16 KP x1 + AN | 7.0 | 7.0 | 7.0 | 8.0 |
| 17 KP x2 + AN | 7.0 | 7.0 | 7.0 | 8.0 |
| 18 KP x3 + AN | 6.5 | 7.0 | 7.0 | 8.0 |
| 19 KP x4 + AN | 7.0 | 7.0 | 8.0 | 8.0 |
| 20 KP x1 + AC | 6.5 | 7.0 | 7.0 | 7.5 |
| 21 KP x2 + AC | 6.5 | 6.5 | 7.0 | 7.0 |
| 22 KP x3 + AC | 6.5 | 6.5 | 7.0 | 7.0 |
| 23 KP x4 + AC | 6.0 | 6.0 | 7.0 | 7.0 |
| 24 KP x1 + AN + AC | 7.0 | 7.0 | 8.0 | 8.0 |
| 25 KP x2 + AN + AC | 7.0 | 7.0 | 8.0 | 8.0 |
| 26 KP x3 + AN + AC | 7.0 | 7.0 | 7.5 | 7.5 |
| 27 KP x4 + AN + AC | 6.0 | 6.0 | 7.0 | 7.0 |
| 28 KP x1 + SAF | 7.5 | 7.0 | 8.0 | 8.0 |
| 29 KP x2 + SAF | 7.0 | 6.5 | 8.0 | 8.0 |
| 30 KP x3 + SAF | 7.0 | 6.5 | 8.0 | 8.0 |
| 31 KP x4 + SAF | 7.0 | 6.0 | 7.5 | 8.0 |
| 32 KP x1 + AN + SAF | 7.0 | 7.0 | 8.0 | 8.0 |
| 33 KP x2 + AN + SAF | 7.5 | 7.0 | 8.0 | 8.0 |
| 34 KP x3 + AN + SAF | 7.5 | 7.5 | 7.5 | 8.0 |
| 35 KP x4 + AN + SAF | 7.0 | 7.5 | 7.5 | 8.0 |
| 36 KP x1 + AC + SAF | 7.0 | 7.0 | 8.0 | 8.0 |
| 37 KP x2 + AC + SAF | 7.0 | 7.0 | 8.0 | 8.0 |
| 38 KP x3 + AC + SAF | 7.0 | 7.0 | 8.0 | 8.0 |
| 39 KP x4 + AC + SAF | 6.5 | 7.5 | 7.5 | 8.0 |
| 40 KP x1 + AN + AC + SAF | 8.0 | 8.0 | 7.5 | 8.0 |
| 41 KP x2 + AN + AC + SAF | 8.0 | 8.5 | 8.0 | 8.0 |
| 42 KP x3 + AN + AC + SAF | 8.0 | 8.0 | 8.0 | 8.0 |
| 44 KP x4 + AN + AC + SAF | 7.5 | 7.5 | 8.0 | 8.0 |
| 45 KP x1 fb (followed by) AN + | 7.0 | 7.0 | 7.0 | 8.0 |
| AC after 7 days | | | | |
| 46 KP x2 fb AN + AC after 7 | 6.5 | 7.0 | 7.0 | 8.0 |
| days | | | | |
| 47 KP x3 fb AN + AC after 7 | 7.0 | 6.6 | 7.0 | 8.0 |
| days | | | | |
| 48 KP x4 fb AN + AC after 7 | 6.5 | 6.5 | 7.0 | 7.5 |
| days | | | | |
| 49 KP x1 fb AN + AC + SAF | 6.5 | 7.0 | 7.0 | 7.5 |
| after 7 days | | | | |
| 50 KP x2 fb AN + AC + SAF | 6.5 | 6.5 | 7.0 | 7.0 |
| after 7 days | | | | |
| 51 KP x3 fb AN + AC + SAF | 6.5 | 6.0 | 7.5 | 7.0 |
| after 7 days | | | | |
| 52 KP x4 fb AN + AC + SAF | 6.5 | 6.0 | 7.0 | 7.5 |
| after 7 days | | | | |
| 53 KP x1 fb AN + AC + SAF + | 7.0 | 7.0 | 7.0 | 7.0 |
| Terpene after 7 days | | | | |
| 54 KP x2 fb AN + AC + SAF + | 7.0 | 7.0 | 6.5 | 7.0 |
| Terpene after 7 days | | | | |
| 55 KP x3 fb AN + AC + SAF + | 7.0 | 6.5 | 7.5 | 8.0 |
| Terpene after 7 days | | | | |
| 56 KP x4 fb AN + AC + SAF + | 6.5 | 6.5 | 7.0 | 7.0 |
| Terpene after 7 days | | | | |
| 57 KP x1 fb SAF after | 7.0 | 6.5 | 7.0 | 7.0 |
| 7 days | | | | |
| 58 KP x2 fb SAF after | 7.0 | 7.0 | 6.5 | 6.5 |
| 7 days | | | | |
| 59 KP x3 fb SAF after | 7.0 | 7.0 | 6.5 | 6.5 |
| 7 days | | | | |
| 60 KP x4 fb SAF after | 7.0 | 7.0 | 7.0 | 6.0 |
| 7 days | | | | |

TABLE 1.8
LETTUCE - CROP SAFENING BENEFITS FROM ADDITION OF
SAFENER AND/OR ANTHRANILIC ACID AND/OR
ACETAMINOPHEN TO PHOSPHITE FERTILISER.

| | Phyto- | Phyto- | Vigour | |
|---|---|---|---|---|
| | toxicity | toxicity | (0-9) (9 = | |
| | (0-9) (0 = | (0-9) (0 = | Most | Vigour |
| | Dead) + | Dead) + | Vigour) + | (0-9) + |
| Treatment | 14 Days | 28 Days | 14 days | 28 Days |
| 1. Untreated | 7.5 | 7.5 | 8.0 | 8.0 |
| 2. Untreated | 7.5 | 8.0 | 8.0 | 8.0 |
| 3. AN (Anthranilic Acid) | 7.0 | 7.0 | 8.0 | 8.0 |
| 4. AC (Acetaminophen) | 7.0 | 6.5 | 8.0 | 8.0 |
| 5. AN + AC | 7.0 | 7.0 | 7.5 | 8.0 |
| 6. AN + AC + Terpene | 7.0 | 7.0 | 7.5 | 8.0 |
| 7. SAF | 7.0 | 7.0 | 7.5 | 8.0 |
| 8. AN + SAF | 7.5 | 7.5 | 8.0 | 8.0 |
| 9. AC + SAF | 7.5 | 7.5 | 8.0 | 8.0 |
| 10 AN + AC + SAF | 7.5 | 8.0 | 8.0 | 8.0 |
| 11 AN + AC + SAF + | 7.5 | 8.0 | 8.0 | 8.0 |
| Terpene | | | | |
| 12 Potassium Phosphite | 7.5 | 7.5 | 8.0 | 8.0 |
| (KP) + Ammonium | | | | |
| Thiosulphate (ATS) - 2.0 | | | | |
| l/ha = KP/ATS x1 | | | | |
| 13 KP/ATS x2 (4.0 l/ha) | 7.0 | 7.0 | 8.0 | 8.0 |
| 14 KP/ATS x3 (6.0 l/ha) | 7.0 | 7.0 | 7.5 | 8.0 |
| 15 KP/ATS x4 (8.0 l/ha) | 6.5 | 7.0 | 7.0 | 8.0 |
| 16 KP/ATS x1 + AN + AC | 7.5 | 7.5 | 8.0 | 8.0 |
| 17 KP/ATS x2 + AN + AC | 7.5 | 7.5 | 8.0 | 8.0 |
| 18 KP/ATS x3 + AN + AC | 7.0 | 7.5 | 7.5 | 8.0 |
| 19 KP/ATS x4 + AN + AC | 7.0 | 7.0 | 7.5 | 8.0 |
| 20 KP/ATS x1 + SAF | 7.0 | 7.0 | 8.0 | 8.0 |
| 21 KP/ATS x2 + SAF | 7.0 | 7.0 | 8.0 | 8.0 |
| 22 KP/ATS x3 + SAF | 7.0 | 7.0 | 8.0 | 8.0 |
| 23 KP/ATS x4 + SAF | 7.0 | 7.5 | 8.0 | 8.0 |
| 24 KP/ATS x1 + AN + | 8.0 | 8.0 | 8.0 | 8.0 |
| AC + SAF | | | | |
| 25 KP/ATS x2 + AN + | 8.0 | 8.0 | 8.0 | 8.0 |
| AC + SAF | | | | |
| 26 KP/ATS x3 + AN + | 8.0 | 8.0 | 8.0 | 8.0 |
| AC + SAF | | | | |
| 27 KP/ATS x4 + AN + | 7.5 | 7.5 | 8.0 | 8.0 |
| AC + SAF | | | | |

TABLE 1.9
LETTUCE - CROP SAFENING BENEFITS FROM ADDITION OF
SAFENER AND/OR ANTHRANILIC ACID AND/OR
ACETAMINOPHEN TO GENERAL FERTILISERS.

| | Phyto- | Phyto- | | |
|---|---|---|---|---|
| | toxicity | toxicity | Vigour | |
| | (0-9) | (0-9) | (0-9) (9 = | |
| | (0 = | (0 = | Most | Vigour |
| | Dead) + | Dead) + | Vigour) + | (0-9) + |
| Treatment | 14 Days | 28 Days | 14 days | 28 Days |
| 1. Untreated | 7.5 | 7.5 | 8.0 | 8.0 |
| 2. Untreated | 7.5 | 8.0 | 8.0 | 8.0 |
| 3. AN (Anthranilic Acid) | 7.0 | 7.0 | 8.0 | 8.0 |
| 4. AC (Acetaminophen) | 7.0 | 6.5 | 8.0 | 8.0 |
| 5. AN + AC | 7.0 | 7.0 | 8.0 | 8.0 |
| 6. AN + AC + Terpene | 7.0 | 7.0 | 7.5 | 8.0 |
| 7. SAF | 7.0 | 7.0 | 7.5 | 8.0 |
| 8. AN + SAF | 7.5 | 7.5 | 8.0 | 8.0 |
| 9. AC + SAF | 7.5 | 7.5 | 8.0 | 8.0 |
| 10 AN + AC + SAF | 7.5 | 8.0 | 8.0 | 8.0 |
| 11 AN + AC + SAF + Terpene | 7.5 | 8.0 | 8.0 | 8.0 |
| 12 General NPK Fertiliser + | 7.0 | 7.0 | 7.0 | 7.5 |
| micronutrients, with added KP | | | | |
| @ x2 rate (4.0 l/ha) = | | | | |
| GEN + KP x2 | | | | |
| 13 GEN + KP x3 (6.0 l/ha) | 5.0 | 5.0 | 6.5 | 7.0 |
| 14 GEN + KP x6 (12.0 l/ha) | 4.5 | 4.0 | 7.0 | 6.5 |
| 15 GEN + KP x2 + AN + AC | 7.0 | 7.0 | 7.0 | 6.5 |
| 16 GEN + KP x3 + AN + AC | 6.0 | 6.0 | 6.5 | 7.0 |
| 17 GEN + KP x6 + AN + AC | 5.0 | 5.5 | 6.5 | 7.0 |
| 18 GEN + KP x2 + SAF | 7.0 | 7.0 | 8.0 | 8.0 |
| 19 GEN + KP x3 + SAF | 6.5 | 7.0 | 7.5 | 7.5 |
| 20 GEN + KP x6 + SAF | 7.0 | 6.5 | 7.5 | 7.5 |
| 21 GEN + KP x2 + AN + AC + | 7.5 | 7.0 | 8.0 | 8.0 |
| SAF | | | | |
| 22 GEN + KP x3 + AN + AC + | 7.0 | 7.0 | 7.5 | 8.0 |
| SAF | | | | |
| 23 GEN + KP x6 + AN + AC + | 7.0 | 7.0 | 8.0 | 8.0 |
| SAF | | | | |
| 24 General NPK Fertiliser + | 7.5 | 7.5 | 8.0 | 8.0 |
| micronutrients, but with NO | | | | |
| added KP = GENEX x2 rate | | | | |
| 25 GENEX x3 rate | 6.0 | 6.5 | 7.0 | 7.5 |
| 26 GENEX x6 rate | 4.5 | 5.0 | 7.0 | 8.0 |
| 27 GENEX x2 + AN + AC | 7.5 | 7.0 | 8.0 | 8.0 |
| 28 GENEX x3 + AN + AC | 6.5 | 7.0 | 7.0 | 8.0 |
| 29 GENEX x6 + AN + AC | 5.0 | 6.0 | 7.0 | 7.5 |
| 30 GENEX x2 + SAF | 7.0 | 7.5 | 8.0 | 8.0 |
| 31 GENEX x3 + SAF | 7.0 | 7.0 | 8.0 | 8.0 |
| 32 GENEX x6 + SAF | 6.5 | 7.0 | 8.0 | 8.0 |
| GENEX x2 + AN + AC + | 7.0 | 7.5 | 8.0 | 8.0 |
| SAF | | | | |
| GENEX x3 + AN + AC + | 7.0 | 7.0 | 8.0 | 8.0 |
| SAF | | | | |
| GENEX x3 + AN AC + SAF | 7.0 | 7.5 | 7.0 | 8.0 |

As shown in Tables 1.1 to 1.9, each of the safening formulations showed a significant reduction in phytotoxicity when applied to a range of species in combination with a fertilizer, when compared to the application of fertilizers alone. Thus the safening systems improve crop safening in a range of species. Vigour was also boosted.

### Example 2

### Safening of Fungicides

Safening systems were applied to crops of winter barley, winter wheat and maize treated with various fungicides (Prochloraz, Flutriafol, Fenpropidin). The safening system and the fungicide were applied to the crops either simultaneously or sequentially, either as foliar applications or as a seed treatment.

Winter Barley: cv Saffron, sown 27 May 2008, at four/five seeds per 9 cm pot, sown in standard multi-purpose compost of pH 6.5. Date of spraying: 23 July; Dates of measurement/scoring: 30 July, 14 August, 22 August. Sprayed: mid-tillering phase (GS23).
Winter Wheat: cv Limerick, sown 4 Jun. 2008, at four/five seeds per 9 cm pot, sown in standard multi-purpose compost of pH 6.5. Date of spraying: 23 July; Dates of measurement/scoring: 30 July, 14 August, 23 August. Sprayed: mid-tillering phase (GS23).
Maize: cv Sundance, sown 25 May 2008, at 10 seeds per 25 cm pot, in John Innes No 1 compost. Date of measurement/assessment: 15 June. Seed treatment trial. Randomised block, mean of five replicates.

### Safening Systems:

### 1. Anthranilic Acid+Acetaminophen (AN+AC).

### 2. AN+AC+Safener (SAF).

### 3. Safener (SAF).

SAF: at least one from class (f) each at <3 g/l, plus at least one from class (c).

Statistical Analyses (Least Significant Difference, 5% Level) for Tables 2.1 to 2.7:

Tables 2.1, 2.2 and 2.3 (Winter Barley):

| | | | Vigour + | |
|---|---|---|---|---|
| | Phyto + 14 | Phyto + 28 | 14 | Vigour + 28 |
| | Days | Days | Days | Days |
| LSD (5%) | 1.15 | 1.28 | 1.39 | 1.41 |
| Treatment Means | | | | |

Tables 2.4, 2.5 and 2.6 (Winter Wheat):

| | | | Vigour + | |
|---|---|---|---|---|
| | Phyto + 14 | Phyto + 28 | 14 | Vigour + 28 |
| | Days | Days | Days | Days |
| LSD (5%) | 1.27 | 1.33 | 1.38 | 1.40 |
| Treatment Means | | | | |

Table 2.7 (Maize):

| | Shoot Fresh | | Vigour |
|---|---|---|---|
| | Weight (g) | % | (0-9) |
| LSD (5%) | 2.30 | 9.6 | 1.51 |
| Treatment Means | | | |

The results are shown in Tables 2.1 to 2.7 below.

TABLE 2.1
WINTER BARLEY - CROP SAFENING BENEFITS FROM
ADDITION OF SAFENER AND/OR ANTHRANILIC ACID AND/OR
ACETAMINOPHEN TO THE FUNGICIDE PROCHLORAZ.

| | Phyto- | Phyto- | Vigour | |
|---|---|---|---|---|
| | toxicity | toxicity | (0-9) (9 = | |
| | (0-9) (0 = | (0-9) (0 = | Most | Vigour |
| | Dead) + | Dead) + | Vigour) + | (0-9) + |
| Treatment | 14 Days | 28 Days | 14 days | 28 Days |
| 1. Untreated | 8.0 | 7.5 | 8.0 | 8.0 |
| 2. Untreated | 7.5 | 8.0 | 8.0 | 8.0 |
| 3. AN (Anthranilic Acid) | 7.5 | 8.0 | 7.0 | 8.0 |
| 4. AC (Acetaminophen) | 8.0 | 8.0 | 7.0 | 8.0 |
| 5. AN + AC | 7.5 | 7.5 | 7.5 | 8.0 |
| 6. AN + AC + Terpene | 7.5 | 8.0 | 7.5 | 8.0 |
| 7. SAF | 7.5 | 8.0 | 7.5 | 8.0 |
| 8. AN + SAF | 8.0 | 8.0 | 8.0 | 8.0 |
| 9. AC + SAF | 7.5 | 7.5 | 8.0 | 7.5 |
| 10 AN + AC + SAF | 8.0 | 8.0 | 8.0 | 8.0 |
| 11 AN + AC + SAF + | 8.0 | 8.0 | 8.0 | 8.0 |
| Terpene | | | | |
| 12 Prochloraz (400 g/l) @ | 6.5 | 7.0 | 7.0 | 7.0 |
| 0.75 l/ha = PRO x1 | | | | |
| 13 PRO @ 1.25 l/ha = | 6.5 | 7.0 | 6.5 | 7.0 |
| PRO x2 | | | | |
| 14 PRO @ 1.75 l/ha = | 6.0 | 7.0 | 6.5 | 7.0 |
| PRO x3 | | | | |
| 15 PRO x1 + AN | 6.5 | 7.0 | 7.0 | 7.0 |
| 16 PRO x2 + AN | 6.0 | 7.0 | 6.0 | 7.0 |
| 17 PRO x3 + AN | 6.0 | 6.5 | 6.0 | 6.5 |
| 18 PRO x1 + AC | 6.0 | 6.5 | 6.5 | 7.0 |
| 19 PRO x2 + AC | 6.0 | 6.5 | 6.0 | 6.5 |
| 20 PRO x3 + AC | 6.0 | 6.5 | 6.0 | 6.0 |
| 21 PRO x1 + AN + AC | 7.0 | 8.0 | 7.5 | 7.0 |
| 22 PRO x2 + AN + AC | 7.0 | 7.0 | 7.0 | 7.0 |
| 23 PRO x3 + AN + AC | 6.5 | 7.0 | 7.0 | 7.0 |
| 24 PRO x1 + SAF | 7.0 | 8.0 | 8.0 | 8.0 |
| 25 PRO x2 + SAF | 7.0 | 7.5 | 7.5 | 8.0 |
| 26 PRO x3 + SAF | 7.0 | 7.0 | 7.5 | 8.0 |
| 27 PRO x1 + AN + SAF | 7.0 | 7.0 | 8.0 | 8.0 |
| 28 PRO x2 + AN + SAF | 7.0 | 7.0 | 7.0 | 7.5 |
| 29 PRO x3 + AN + SAF | 7.0 | 7.0 | 7.0 | 7.5 |
| 30 PRO x1 + AN + AC + | 7.0 | 7.0 | 8.0 | 8.0 |
| SAF | | | | |
| 31 PRO x2 + AN + AC + | 7.0 | 7.5 | 7.0 | 7.5 |
| SAF | | | | |
| 32 PRO x3 + AN + AC + | 7.5 | 7.0 | 7.5 | 7.5 |
| SAF | | | | |
| 33 PRO x1 + AN + AC + | 6.5 | 7.5 | 7.0 | 7.5 |
| POL | | | | |
| 34 PRO x2 + AN + AC + | 7.0 | 7.5 | 7.0 | 7.0 |
| POL | | | | |
| 35 PRO x3 + AN + AC + | 6.5 | 7.5 | 6.5 | 7.0 |
| POL | | | | |
| 36 PRO x1 + AN + AC + | 7.0 | 7.5 | 7.5 | 8.0 |
| SAF + POL | | | | |
| 37 PRO x2 + AN + AC + | 7.0 | 8.0 | 7.0 | 7.5 |
| SAF + POL | | | | |
| 38 PRO x3 + AN + AC + | 7.0 | 7.5 | 7.0 | 7.0 |
| SAF + POL | | | | |
| 39 PRO x1 + SAF + POL | 7.5 | 8.0 | 8.0 | 8.0 |
| 40 PRO x2 + SAF + POL | 7.5 | 8.0 | 7.0 | 8.0 |
| 41 PRO x3 + SAF + | 7.0 | 7.5 | 7.0 | 7.5 |
| POL | | | | |
| 42 PRO x1 fb (followed by) | 6.5 | 7.0 | 7.0 | 7.5 |
| AN + AC after 7 days | | | | |
| 43 PRO x2 fb AN + AC | 6.5 | 7.0 | 7.0 | 7.5 |
| after 7 days | | | | |
| 44 PRO x3 fb AN + AC | 6.0 | 7.0 | 6.5 | 7.0 |
| after 7 days | | | | |
| 45 PRO x1 fb AN after | 6.0 | 7.0 | 7.0 | 7.5 |
| 7 days | | | | |
| 46 PRO x2 fb AN after | 6.5 | 7.0 | 6.0 | 7.0 |
| 7 days | | | | |
| 47 PRO x3 fb AN after | 6.0 | 6.5 | 6.0 | 7.0 |
| 7 days | | | | |
| 48 PRO x1 fb AN + AC + | 7.0 | 7.0 | 7.5 | 8.0 |
| SAF after 7 days | | | | |
| 49 PRO x2 fb AN + AC + | 6.5 | 7.0 | 7.5 | 8.0 |
| SAF after 7 days | | | | |
| 50 PRO x3 fb AN + AC + | 6.0 | 7.0 | 6.5 | 7.0 |
| SAF after 7 days | | | | |
| 51 PRO x1 fb AN + AC + | 7.0 | 6.0 | 7.5 | 8.0 |
| SAF + POL after 7 days | | | | |
| 52 PRO x2 fb AN + AC + | 7.0 | 7.0 | 6.0 | 7.0 |
| SAF + POL after 7 days | | | | |
| 53 PRO x3 fb AN + AC + | 6.0 | 7.0 | 6.0 | 6.5 |
| SAF + POL after 7 days | | | | |
| 54 PRO x1 fb SAF after 7 | 6.5 | 7.0 | 7.5 | 7.5 |
| days | | | | |
| 55 PRO x2 fb SAF after 7 | 6.5 | 7.0 | 7.5 | 8.0 |
| days | | | | |
| 56 PRO x3 fb SAF after 7 | 6.0 | 7.0 | 7.5 | 7.5 |
| days | | | | |
| 57 PRO x1 fb AN + SAF | 7.0 | 7.0 | 8.0 | 7.5 |
| after 7 days | | | | |
| 58 PRO x2 fb AN + SAF | 6.0 | 6.5 | 7.5 | 8.0 |
| after 7 days | | | | |
| 59 PRO x3 fb AN + SAF | 6.0 | 7.0 | 7.0 | 7.0 |
| after 7 days | | | | |

TABLE 2.2
WINTER BARLEY - CROP SAFENING BENEFITS FROM ADDITION
OF SAFENER AND/OR ANTHRANILIC ACID AND/OR ACETAMINOPHEN
TO THE FUNGICIDE FLUTRIAFOL.

| | | | Vigour | |
|---|---|---|---|---|
| | Phytotoxicity | Phytotoxicity | (0-9) (9 = | |
| | (0-9) (0 = | (0-9) (0 = | Most | Vigour |
| | Dead) + | Dead) + | Vigour) + | (0-9) + |
| Treatment | 14 Days | 28 Days | 14 days | 28 Days |
| 1. Untreated | 8.0 | 7.5 | 8.0 | 8.0 |
| 2. Untreated | 7.5 | 8.0 | 8.0 | 8.0 |
| 3. AN (Anthranilic Acid) | 7.5 | 8.0 | 7.0 | 8.0 |
| 4. AC (Acetaminophen) | 8.0 | 8.0 | 7.0 | 8.0 |
| 5. AN + AC | 7.5 | 7.5 | 7.5 | 8.0 |
| 6. AN + AC + Terpene | 7.5 | 8.0 | 7.5 | 8.0 |
| 7. SAF | 7.5 | 8.0 | 7.5 | 8.0 |
| 8. AN + SAF | 8.0 | 8.0 | 8.0 | 8.0 |
| 9. AC + SAF | 7.5 | 7.5 | 8.0 | 7.5 |
| 10 AN + AC + SAF | 8.0 | 8.0 | 8.0 | 8.0 |
| 11 AN + AC + SAF + | 8.0 | 8.0 | 8.0 | 8.0 |
| Terpene | | | | |
| 12 Flutriafol (125 g/l) @ 0.75 l/ha = | 6.0 | 6.5 | 8.0 | 8.0 |
| FLU x1 | | | | |
| 13 FLU @ 1.25 l/ha = | 5.5 | 6.5 | 7.0 | 8.0 |
| FLU x2 | | | | |
| 14 FLU @ 2.0 l/ha = | 5.0 | 6.0 | 6.5 | 7.0 |
| FLU x3 | | | | |
| 15 FLU x1 + AN | 6.0 | 7.0 | 8.0 | 7.5 |
| 16 FLU x2 + AN | 5.0 | 7.0 | 7.0 | 7.0 |
| 17 FLU x3 + AN | 5.0 | 6.5 | 7.0 | 7.0 |
| 18 FLU x1 + AC | 6.0 | 6.5 | 7.0 | 7.5 |
| 19 FLU x2 + AC | 5.5 | 6.5 | 6.5 | 7.0 |
| 20 FLU x3 + AC | 5.0 | 6.0 | 6.5 | 7.0 |
| 21 FLU x1 + AN + AC | 6.0 | 7.0 | 8.0 | 7.5 |
| 22 FLU x2 + AN + AC | 6.0 | 6.5 | 7.5 | 8.0 |
| 23 FLU x3 + AN + AC | 5.0 | 6.0 | 7.5 | 7.0 |
| 24 FLU x1 + SAF | 7.5 | 8.0 | 7.5 | 8.0 |
| 25 FLU x2 + SAF | 7.0 | 7.5 | 8.0 | 8.0 |
| 26 FLU x3 + SAF | 7.0 | 7.5 | 7.5 | 8.0 |
| 27 FLU x1 + AN + SAF | 8.0 | 8.0 | 8.0 | 8.0 |
| 28 FLU x2 + AN + SAF | 7.5 | 7.5 | 7.5 | 8.0 |
| 29 FLU x3 + AN + SAF | 7.0 | 7.0 | 7.5 | 8.0 |
| 30 FLU x1 + AN + AC + SAF | 8.0 | 8.0 | 8.0 | 8.0 |
| 31 FLU x2 + AN + AC + SAF | 7.0 | 8.0 | 7.0 | 8.0 |
| 32 FLU x3 + AN + AC + | 7.0 | 8.0 | 7.0 | 8.0 |
| SAF | | | | |
| 33 FLU x1 + AN + AC + | 7.0 | 7.0 | 6.5 | 7.0 |
| POL | | | | |
| 34 FLU x2 + AN + AC + | 6.5 | 7.0 | 6.5 | 7.0 |
| POL | | | | |
| 35 FLU x3 + AN + AC + | 6.0 | 7.0 | 6.0 | 7.0 |
| POL | | | | |
| 36 FLU x1 + AN + AC + SAF + | 7.5 | 7.5 | 6.0 | 7.5 |
| POL | | | | |
| 37 FLU x2 + AN + AC + | 7.5 | 7.5 | 6.0 | 7.5 |
| SAF + POL | | | | |
| 38 FLU x3 + AN + AC + SAF + | 6.5 | 7.0 | 6.5 | 7.5 |
| POL | | | | |
| 39 FLU x1 + SAF + POL | 7.0 | 7.0 | 7.0 | 7.5 |
| 40 FLU x2 + SAF + POL | 7.0 | 7.5 | 6.5 | 7.0 |
| 41 FLU x3 + SAF + POL | 7.0 | 7.5 | 6.5 | 7.0 |
| 42 FLU x1 fb (followed by) | 6.0 | 7.0 | 7.0 | 7.5 |
| AN + AC after 7 days | | | | |
| 43 FLU x2 fb AN + AC after | 5.5 | 7.0 | 7.0 | 7.5 |
| 7 days | | | | |
| 44 FLU x3 fb AN + AC after | 5.5 | 7.0 | 6.5 | 8.0 |
| 7 days | | | | |
| 45 FLU x1 fb AN after 7 days | 6.5 | 7.0 | 6.5 | 8.0 |
| 46 FLU x2 fb AN after 7 days | 6.0 | 6.5 | 7.0 | 7.5 |
| 47 FLU x3 fb AN after 7 days | 5.0 | 6.5 | 7.0 | 7.0 |
| 48 FLU x1 fb AN + AC + | 5.0 | 6.0 | 6.5 | 8.0 |
| SAF after 7 days | | | | |
| 49 FLU x2 fb AN + AC + | 5.0 | 6.0 | 7.0 | 7.5 |
| SAF after 7 days | | | | |
| 50 FLU x3 fb AN + AC + | 5.0 | 6.0 | 6.5 | 8.0 |
| SAF after 7 days | | | | |
| 51 FLU x1 fb AN + AC + | 6.0 | 7.0 | 6.5 | 8.0 |
| SAF + POL after 7 days | | | | |
| 52 FLU x2 fb AN + AC + | 5.5 | 6.0 | 7.0 | 8.0 |
| SAF + POL after 7 days | | | | |
| 53 FLU x3 fb AN + AC + | 5.5 | 6.0 | 7.0 | 7.5 |
| SAF + POL after 7 days | | | | |
| 54 FLU x1 fb SAF after 7 | 5.5 | 7.0 | 7.0 | 8.0 |
| days | | | | |
| 55 FLU x2 fb SAF after 7 | 5.5 | 6.5 | 6.5 | 7.5 |
| days | | | | |
| 56 FLU x3 fb SAF after 7 | 5.5 | 6.5 | 6.5 | 7.0 |
| days | | | | |
| 57 FLU x1 fb AN + SAF | 6.0 | 7.0 | 7.0 | 8.0 |
| after 7 days | | | | |
| 58 FLU x2 fb AN + SAF | 6.0 | 7.0 | 6.0 | 7.0 |
| after 7 days | | | | |
| 59 FLU x3 fb AN + SAF | 5.5 | 6.5 | 6.0 | 7.0 |
| after 7 days | | | | |

TABLE 2.3
WINTER BARLEY - CROP SAFENING BENEFITS FROM
ADDITION OF SAFENER AND/OR ANTHRANILIC ACID AND/OR
ACETAMINOPHEN TO THE FUNGICIDES FENPROPIDIN AND FLUTRIAFOL.

| | | | Vigour | |
|---|---|---|---|---|
| | Phytotoxicity | Phytotoxicity | (0-9) (9 = | |
| | (0-9) (0 = | (0-9) (0 = | Most | Vigour |
| | Dead) + 14 | Dead) + | Vigour) + | (0-9) + |
| Treatment | Days | 28 Days | 14 days | 28 Days |
| 1. Untreated | 8.0 | 7.5 | 8.0 | 8.0 |
| 2. Untreated | 7.5 | 8.0 | 8.0 | 8.0 |
| 3. AN (Anthranilic Acid) | 7.5 | 8.0 | 7.0 | 8.0 |
| 4. AC (Acetaminophen) | 8.0 | 8.0 | 7.0 | 8.0 |
| 5. AN + AC | 7.5 | 7.5 | 7.5 | 8.0 |
| 6. AN + AC + Terpene | 7.5 | 8.0 | 7.5 | 8.0 |
| 7. SAF | 7.5 | 8.0 | 7.5 | 8.0 |
| 8. AN + SAF | 8.0 | 8.0 | 8.0 | 8.0 |
| 9. AC + SAF | 7.5 | 7.5 | 8.0 | 7.5 |
| 10 AN + AC + SAF | 8.0 | 8.0 | 8.0 | 8.0 |
| 11 AN + AC + SAF + | 8.0 | 8.0 | 8.0 | 8.0 |
| Terpene | | | | |
| 12 Fenpropidin (750 g/l) @ | 4.0 | 6.0 | 7.5 | 7.0 |
| 0.75 l/ha + Flutriafol (125 g/l) | | | | |
| @ 0.75 l/ha = FE + FL x1 | | | | |
| 13 FE @ 1.0 l/ha + FL @ 1.0 l/ha = | 4.0 | 6.0 | 6.0 | 6.5 |
| FE + FL x2 | | | | |
| 14 FE @ 1.3 l/ha + FL @ 1.3 l/ha = | 3.5 | 5.5 | 6.0 | 6.5 |
| FE + FL x3 | | | | |
| 15 FE + FL x1 + AN | 4.0 | 6.0 | 7.5 | 7.0 |
| 16 FE + FL x2 + AN | 4.0 | 6.0 | 7.0 | 7.0 |
| 17 FE + FL x3 + AN | 3.5 | 6.0 | 6.0 | 6.0 |
| 18 FE + FL x1 + AC | 4.0 | 6.0 | 7.5 | 7.0 |
| 19 FE + FL x2 + AC | 4.0 | 6.0 | 6.5 | 6.5 |
| 20 FE + FL x3 + AC | 4.0 | 5.5 | 6.0 | 6.5 |
| 21 FE + FL x1 + AN + AC | 4.5 | 6.5 | 7.5 | 7.5 |
| 22 FE + FL x2 + AN + AC | 4.0 | 6.0 | 7.0 | 7.0 |
| 23 FE + FL x3 + AN + AC | 4.0 | 6.0 | 6.5 | 7.0 |
| 24 FE + FL x1 + SAF | 6.5 | 7.0 | 7.5 | 8.0 |
| 25 FE + FL x2 + SAF | 6.5 | 7.0 | 7.5 | 8.0 |
| 26 FE + FL x3 + SAF | 5.5 | 6.0 | 7.5 | 7.5 |
| 27 FE + FL x1 + AN + SAF | 6.5 | 7.0 | 8.0 | 7.5 |
| 28 FE + FL x2 + AN + SAF | 6.5 | 6.5 | 7.5 | 7.5 |
| 29 FE + FL x3 + AN + SAF | 5.5 | 6.5 | 7.5 | 7.5 |
| 30 FE + FL x1 + AN + AC + | 6.0 | 7.0 | 8.0 | 7.5 |
| SAF | | | | |
| 31 FE + FL x2 + AN + AC + | 6.0 | 7.0 | 7.0 | 7.0 |
| SAF | | | | |
| 32 FE + FL x3 + AN + AC + | 6.0 | 7.0 | 7.0 | 7.0 |
| SAF | | | | |
| 33 FE + FL x1 + AN + AC + | 6.0 | 7.0 | 7.0 | 7.0 |
| POL | | | | |
| 34 FE + FL x2 + AN + AC + | 5.5 | 6.5 | 6.5 | 7.0 |
| POL | | | | |
| 35 FE + FL x3 + AN + AC + | 5.5 | 6.0 | 6.0 | 6.0 |
| POL | | | | |
| 36 FE + FL x1 + AN + AC + | 6.0 | 7.0 | 7.5 | 7.5 |
| SAF + POL | | | | |
| 37 FE + FL x2 + AN + AC + | 6.0 | 7.0 | 7.5 | 8.0 |
| SAF + POL | | | | |
| 38 FE + FL x3 + AN + AC + | 5.0 | 7.0 | 7.0 | 7.5 |
| SAF + POL | | | | |
| 39 FE + FL x1 + SAF + POL | 6.5 | 7.0 | 7.5 | 8.0 |
| 40 FE + FL x2 + SAF + POL | 6.5 | 7.0 | 7.0 | 8.0 |
| 41 FE + FL x3 + SAF + | 6.0 | 6.5 | 7.0 | 7.0 |
| POL | | | | |

TABLE 2.4
WINTER WHEAT - CROP SAFENING BENEFITS FROM
ADDITION OF SAFENER AND/OR ANTHRANILIC ACID AND/OR
ACETAMINOPHEN TO THE FUNGICIDE PROCHLORAZ.

| | Phyto- | Phyto- | Vigour | |
|---|---|---|---|---|
| | toxicity | toxicity | (0-9) (9 = | |
| | (0-9) (0 = | (0-9) (0 = | Most | Vigour |
| | Dead) + | Dead) + | Vigour) + | (0-9) + |
| Treatment | 14 Days | 28 Days | 14 days | 28 Days |
| 1. Untreated | 8.0 | 7.5 | 8.0 | 8.0 |
| 2. Untreated | 7.5 | 8.0 | 8.0 | 8.0 |
| 3. AN (Anthranilic Acid) | 7.5 | 8.0 | 7.0 | 8.0 |
| 4. AC (Acetaminophen) | 8.0 | 8.0 | 7.0 | 8.0 |
| 5. AN + AC | 7.5 | 7.5 | 7.5 | 8.0 |
| 6. AN + AC + Terpene | 7.5 | 8.0 | 7.5 | 8.0 |
| 7. SAF | 7.5 | 8.0 | 7.5 | 8.0 |
| 8. AN + SAF | 8.0 | 8.0 | 8.0 | 8.0 |
| 9. AC + SAF | 7.5 | 7.5 | 8.0 | 7.5 |
| 10 AN + AC + SAF | 8.0 | 8.0 | 8.0 | 8.0 |
| 11 AN + AC + SAF + | 7.5 | 8.0 | 7.5 | 8.0 |
| Terpene | | | | |
| 12 Prochloraz (400 g/l) @ | 7.0 | 7.0 | 8.0 | 8.0 |
| 0.75 l/ha = PRO x1 | | | | |
| 13 PRO @ 1.25 l/ha = | 5.0 | 5.5 | 8.0 | 8.0 |
| PRO x2 | | | | |
| 14 PRO @ 1.75 l/ha = | 5.0 | 6.0 | 8.0 | 8.0 |
| PRO x3 | | | | |
| 15 PRO x1 + AN | 7.0 | 7.0 | 8.0 | 8.0 |
| 16 PRO x2 + AN | 4.5 | 5.0 | 8.0 | 8.0 |
| 17 PRO x3 + AN | 5.0 | 6.0 | 7.5 | 8.0 |
| 18 PRO x1 + AC | 7.0 | 7.0 | 8.0 | 8.0 |
| 19 PRO x2 + AC | 5.0 | 6.0 | 7.5 | 7.5 |
| 20 PRO x3 + AC | 4.0 | 5.5 | 8.0 | 8.0 |
| 21 PRO x1 + AN + AC | 7.0 | 7.5 | 8.0 | 8.0 |
| 22 PRO x2 + AN + AC | 5.5 | 6.5 | 8.0 | 8.0 |
| 23 PRO x3 + AN + AC | 5.0 | 6.0 | 7.5 | 8.0 |
| 24 PRO x1 + SAF | 7.0 | 7.0 | 8.0 | 8.0 |
| 25 PRO x2 + SAF | 6.5 | 7.0 | 8.5 | 8.0 |
| 26 PRO x3 + SAF | 6.5 | 7.0 | 8.0 | 7.5 |
| 27 PRO x1 + AN + SAF | 6.5 | 6.5 | 8.0 | 8.0 |
| 28 PRO x2 + AN + SAF | 7.0 | 7.0 | 7.5 | 8.0 |
| 29 PRO x3 + AN + SAF | 6.5 | 7.0 | 8.0 | 8.0 |
| 30 PRO x1 + AN + AC + | 7.5 | 7.0 | 8.0 | 8.0 |
| SAF | | | | |
| 31 PRO x2 + AN + AC + | 7.0 | 7.0 | 8.0 | 8.0 |
| SAF | | | | |
| 32 PRO x3 + AN + AC + | 7.0 | 7.0 | 8.0 | 8.0 |
| SAF | | | | |
| 33 PRO x1 + AN + AC + | 7.0 | 7.0 | 8.0 | 8.0 |
| POL | | | | |
| 34 PRO x2 + AN + AC + | 5.5 | 6.0 | 8.0 | 8.0 |
| POL | | | | |
| 35 PRO x3 + AN + AC + | 5.0 | 6.0 | 8.0 | 8.0 |
| POL | | | | |
| 36 PRO x1 + AN + AC + | 7.0 | 7.0 | 8.0 | 8.0 |
| SAF + POL | | | | |
| 37 PRO x2 + AN + AC + | 7.0 | 7.5 | 8.0 | 8.0 |
| SAF + POL | | | | |
| 38 PRO x3 + AN + AC + | 7.0 | 7.0 | 7.5 | 8.0 |
| SAF + POL | | | | |
| 39 PRO x1 + SAF + POL | 7.0 | 7.0 | 8.0 | 8.0 |
| 40 PRO x2 + SAF + POL | 7.5 | 7.0 | 8.0 | 8.0 |
| 41 PRO x3 + SAF + | 7.0 | 7.0 | 7.5 | 8.0 |
| POL | | | | |
| 42 PRO x1 fb (followed by) | 7.0 | 7.0 | 8.0 | 8.0 |
| AN + AC after 7 days | | | | |
| 43 PRO x2 fb AN + AC | 5.5 | 6.0 | 8.0 | 8.0 |
| after 7 days | | | | |
| 44 PRO x3 fb AN + AC | 5.0 | 6.0 | 8.0 | 8.0 |
| after 7 days | | | | |
| 45 PRO x1 fb AN after | 6.5 | 7.0 | 8.0 | 8.0 |
| 7 days | | | | |
| 46 PRO x2 fb AN after | 5.0 | 5.5 | 7.5 | 8.0 |
| 7 days | | | | |
| 47 PRO x3 fb AN after | 5.0 | 5.0 | 7.5 | 8.0 |
| 7 days | | | | |
| 48 PRO x1 fb AN + AC + | 6.5 | 7.0 | 8.0 | 8.0 |
| SAF after 7 days | | | | |
| 49 PRO x2 fb AN + AC + | 5.0 | 5.5 | 8.0 | 8.0 |
| SAF after 7 days | | | | |
| 50 PRO x3 fb AN + AC + | 4.5 | 5.5 | 8.0 | 7.5 |
| SAF after 7 days | | | | |
| 51 PRO x1 fb AN + AC + | 7.0 | 7.0 | 8.0 | 8.0 |
| SAF + POL after 7 days | | | | |
| 52 PRO x2 fb AN + AC + | 5.5 | 6.0 | 8.0 | 8.5 |
| SAF + POL after 7 days | | | | |
| 53 PRO x3 fb AN + AC + | 5.0 | 6.0 | 8.0 | 8.0 |
| SAF + POL after 7 days | | | | |
| 54 PRO x1 fb SAF after 7 | 7.5 | 7.0 | 7.5 | 8.0 |
| days | | | | |
| 55 PRO x2 fb SAF after 7 | 5.5 | 6.0 | 8.0 | 8.0 |
| days | | | | |
| 56 PRO x3 fb SAF after 7 | 4.5 | 6.0 | 8.0 | 8.0 |
| days | | | | |
| 57 PRO x1 fb AN + SAF | 6.5 | 7.0 | 7.5 | 8.0 |
| after 7 days | | | | |
| 58 PRO x2 fb AN + SAF | 7.0 | 6.0 | 7.5 | 8.0 |
| after 7 days | | | | |
| 59 PRO x3 fb AN + SAF | 5.0 | 5.5 | 7.5 | 8.0 |
| after 7 days | | | | |

TABLE 2.5
WINTER WHEAT - CROP SAFENING BENEFITS FROM ADDITION
OF SAFENER AND/OR ANTHRANILIC ACID AND/OR ACETAMINOPHEN
TO THE FUNGICIDE FLUTRIAFOL.

| | | | Vigour | |
|---|---|---|---|---|
| | Phytotoxicity | Phytotoxicity | (0-9) (9 = | |
| | (0-9) (0 = | (0-9) (0 = | Most | Vigour |
| | Dead) + | Dead) + | Vigour) + | (0-9) + |
| Treatment | 14 Days | 28 Days | 14 days | 28 Days |
| 1. Untreated | 8.0 | 7.5 | 8.0 | 8.0 |
| 2. Untreated | 7.5 | 8.0 | 8.0 | 8.0 |
| 3. AN (Anthranilic Acid) | 7.5 | 8.0 | 7.0 | 8.0 |
| 4. AC (Acetaminophen) | 8.0 | 8.0 | 7.0 | 8.0 |
| 5. AN + AC | 7.5 | 7.5 | 7.5 | 8.0 |
| 6. AN + AC + Terpene | 7.5 | 8.0 | 7.5 | 8.0 |
| 7. SAF | 7.5 | 8.0 | 7.5 | 8.0 |
| 8. AN + SAF | 8.0 | 8.0 | 8.0 | 8.0 |
| 9. AC + SAF | 7.5 | 7.5 | 8.0 | 7.5 |
| 10 AN + AC + SAF | 8.0 | 8.0 | 8.0 | 8.0 |
| 11 AN + AC + SAF + | 7.5 | 8.0 | 7.5 | 8.0 |
| Terpene | | | | |
| 12 Flutriafol (125 g/l) @ 0.75 l/ha = | 7.0 | 7.0 | 8.0 | 8.0 |
| FLU x1 | | | | |
| 13 FLU @ 1.25 l/ha = FLU x2 | 7.0 | 8.0 | 7.0 | 7.0 |
| 14 FLU @ 2.0 l/ha = FLU x3 | 6.5 | 7.0 | 6.5 | 7.0 |
| 15 FLU x1 + AN | 6.5 | 7.0 | 7.5 | 7.0 |
| 16 FLU x2 + AN | 7.0 | 7.0 | 7.0 | 7.0 |
| 17 FLU x3 + AN | 6.5 | 7.0 | 6.5 | 6.5 |
| 18 FLU x1 + AC | 7.0 | 7.0 | 8.0 | 8.0 |
| 19 FLU x2 + AC | 7.0 | 7.0 | 7.0 | 7.0 |
| 20 FLU x3 + AC | 6.5 | 7.0 | 6.5 | 7.0 |
| 21 FLU x1 + AN + AC | 7.0 | 7.0 | 7.0 | 7.5 |
| 22 FLU x2 + AN + AC | 6.0 | 6.5 | 6.5 | 6.5 |
| 23 FLU x3 + AN + AC | 6.0 | 7.0 | 6.5 | 7.0 |
| 24 FLU x1 + SAF | 7.0 | 7.0 | 8.0 | 8.0 |
| 25 FLU x2 + SAF | 7.0 | 7.5 | 8.0 | 8.0 |
| 26 FLU x3 + SAF | 7.0 | 7.0 | 7.0 | 7.0 |
| 27 FLU x1 + AN + SAF | 7.0 | 7.0 | 8.0 | 8.0 |
| 28 FLU x2 + AN + SAF | 7.0 | 7.5 | 6.5 | 7.0 |
| 29 FLU x3 + AN + SAF | 7.0 | 7.0 | 6.0 | 6.5 |
| 30 FLU x1 + AN + AC + SAF | 7.5 | 7.0 | 8.0 | 8.0 |
| 31 FLU x2 + AN + AC + SAF | 7.0 | 7.0 | 8.0 | 8.0 |
| 32 FLU x3 + AN + AC + | 7.0 | 7.0 | 8.0 | 8.0 |
| SAF | | | | |
| 33 FLU x1 + AN + AC + | 7.0 | 7.0 | 7.0 | 7.5 |
| POL | | | | |
| 34 FLU x2 + AN + AC + | 6.0 | 6.5 | 7.0 | 7.5 |
| POL | | | | |
| 35 FLU x3 + AN + AC + | 6.5 | 6.5 | 6.0 | 6.5 |
| POL | | | | |
| 36 FLU x1 + AN + AC + SAF + | 7.0 | 7.5 | 8.0 | 8.0 |
| POL | | | | |
| 37 FLU x2 + AN + AC + | 7.0 | 7.0 | 8.0 | 7.5 |
| SAF + POL | | | | |
| 38 FLU x3 + AN + AC + SAF + | 7.0 | 7.0 | 7.5 | 7.5 |
| POL | | | | |
| 39 FLU x1 + SAF + POL | 7.5 | 7.0 | 8.0 | 8.0 |
| 40 FLU x2 + SAF + POL | 7.0 | 7.0 | 8.0 | 8.0 |
| 41 FLU x3 + SAF + | 7.0 | 7.0 | 7.5 | 8.0 |
| POL | | | | |
| 42 FLU x1 fb (followed by) | 7.0 | 7.5 | 8.0 | 8.0 |
| AN + AC after 7 days | | | | |
| 43 FLU x2 fb AN + AC after | 6.0 | 6.5 | 7.0 | 7.0 |
| 7 days | | | | |
| 44 FLU x3 fb AN + AC after | 6.0 | 6.5 | 7.0 | 6.5 |
| 7 days | | | | |
| 45 FLU x1 fb AN after 7 days | 7.0 | 7.0 | 7.0 | 6.5 |
| 46 FLU x2 fb AN after 7 days | 7.0 | 7.0 | 7.0 | 6.5 |
| 47 FLU x3 fb AN after 7 days | 7.0 | 7.0 | 6.5 | 6.5 |
| 48 FLU x1 fb AN + AC + | 7.0 | 7.0 | 8.0 | 7.0 |
| SAF after 7 days | | | | |
| 49 FLU x2 fb AN + AC + | 7.0 | 7.0 | 7.0 | 6.5 |
| SAF after 7 days | | | | |
| 50 FLU x3 fb AN + AC + | 6.5 | 7.0 | 6.0 | 6.0 |
| SAF after 7 days | | | | |
| 51 FLU x1 fb AN + AC + | 6.5 | 6.5 | 7.5 | 7.5 |
| SAF + POL after 7 days | | | | |
| 52 FLU x2 fb AN + AC + | 7.0 | 7.0 | 7.0 | 7.5 |
| SAF + POL after 7 days | | | | |
| 53 FLU x3 fb AN + AC + | 7.0 | 7.0 | 7.0 | 7.0 |
| SAF + POL after 7 days | | | | |
| 54 FLU x1 fb SAF after 7 | 7.0 | 6.5 | 8.0 | 8.0 |
| days | | | | |
| 55 FLU x2 fb SAF after 7 | 6.5 | 6.5 | 7.0 | 7.0 |
| days | | | | |
| 56 FLU x3 fb SAF after 7 | 6.5 | 6.5 | 6.5 | 7.0 |
| days | | | | |
| 57 FLU x1 fb AN + SAF | 7.0 | 7.0 | 8.0 | 8.0 |
| after 7 days | | | | |
| 58 FLU x2 fb AN + SAF | 6.5 | 6.5 | 7.0 | 7.5 |
| after 7 days | | | | |
| 59 FLU x3 fb AN + SAF | 6.0 | 7.0 | 6.5 | 7.0 |
| after 7 days | | | | |

TABLE 2.6
WINTER WHEAT - CROP SAFENING BENEFITS FROM
ADDITION OF SAFENER AND/OR ANTHRANILIC ACID AND/OR
ACETAMINOPHEN TO THE FUNGICIDES FENPROPIDIN AND FLUTRIAFOL

| | | | Vigour | |
|---|---|---|---|---|
| | Phytotoxicity | Phytotoxicity | (0-9) (9 = | |
| | (0-9) (0 = | (0-9) (0 = | Most | Vigour |
| | Dead) + | Dead) + | Vigour) + | (0-9) + |
| Treatment | 14 Days | 28 Days | 14 days | 28 Days |
| 1. Untreated | 8.0 | 7.5 | 8.0 | 8.0 |
| 2. Untreated | 7.5 | 8.0 | 8.0 | 8.0 |
| 3. AN (Anthranilic Acid) | 7.5 | 8.0 | 7.0 | 8.0 |
| 4. AC (Acetaminophen) | 8.0 | 8.0 | 7.0 | 8.0 |
| 5. AN + AC | 7.5 | 7.5 | 7.5 | 8.0 |
| 6. AN + AC + Terpene | 7.5 | 8.0 | 7.5 | 8.0 |
| 7. SAF | 7.5 | 8.0 | 7.5 | 8.0 |
| 8. AN + SAF | 8.0 | 8.0 | 8.0 | 8.0 |
| 9. AC + SAF | 7.5 | 7.5 | 8.0 | 7.5 |
| 10 AN + AC + SAF | 8.0 | 8.0 | 8.0 | 8.0 |
| 11 AN + AC + SAF + | 7.5 | 8.0 | 7.5 | 8.0 |
| Terpene | | | | |
| 12 Fenpropidin (750 g/l) @ | 7.0 | 7.0 | 7.0 | 7.0 |
| 0.75 l/ha + Flutriafol (125 g/l) | | | | |
| @ 0.75 l/ha = FE + FLx1 | | | | |
| 13 FE @ 1.0 l/ha + FL @ 1.0 l/ha = | 6.5 | 6.5 | 6.0 | 6.5 |
| FE + FL x2 | | | | |
| 14 FE @ 1.3 l/ha + FL @ 1.3 l/ha = | 5.0 | 5.0 | 5.5 | 6.5 |
| FE + FL x3 | | | | |
| 15 FE + FL x1 + AN | 6.5 | 6.5 | 7.0 | 7.0 |
| 16 FE + FL x2 + AN | 6.0 | 7.0 | 7.0 | 6.5 |
| 17 FE + FL x3 + AN | 6.0 | 7.0 | 6.0 | 6.0 |
| 18 FE + FL x1 + AC | 6.5 | 7.0 | 7.0 | 7.0 |
| 19 FE + FL x2 + AC | 6.0 | 6.5 | 6.0 | 6.5 |
| 20 FE + FL x3 + AC | 6.0 | 6.0 | 6.0 | 6.5 |
| 21 FE + FL x1 + AN + AC | 6.5 | 7.0 | 7.0 | 7.0 |
| 22 FE + FL x2 + AN + AC | 6.5 | 7.0 | 6.0 | 6.5 |
| 23 FE + FL x3 + AN + AC | 6.5 | 7.0 | 5.5 | 6.0 |
| 24 FE + FL x1 + SAF | 7.0 | 7.0 | 7.0 | 7.0 |
| 25 FE + FL x2 + SAF | 7.0 | 7.5 | 7.0 | 7.0 |
| 26 FE + FL x3 + SAF | 7.0 | 7.0 | 7.0 | 7.0 |
| 27 FE + FL x1 + AN + SAF | 7.0 | 7.0 | 7.5 | 7.5 |
| 28 FE + FL x2 + AN + SAF | 6.5 | 7.0 | 7.0 | 7.0 |
| 29 FE + FL x3 + AN + SAF | 6.5 | 7.0 | 7.0 | 7.5 |
| 30 FE + FL x1 + AN + AC + | 7.5 | 7.5 | 7.5 | 7.5 |
| SAF | | | | |
| 31 FE + FL x2 + AN + AC + | 7.0 | 7.0 | 7.0 | 7.0 |
| SAF | | | | |
| 32 FE + FL x3 + AN + AC + | 7.0 | 7.0 | 7.0 | 7.0 |
| SAF | | | | |
| 33 FE + FL x1 + AN + AC + | 7.0 | 7.0 | 7.0 | 7.0 |
| POL | | | | |
| 34 FE + FL x2 + AN + AC + | 6.5 | 7.0 | 6.5 | 6.5 |
| POL | | | | |
| 35 FE + FL x3 + AN + AC + | 6.5 | 7.0 | 6.5 | 6.5 |
| POL | | | | |
| 36 FE + FL x1 + AN + AC + | 7.0 | 7.0 | 7.0 | 7.0 |
| SAF + POL | | | | |
| 37 FE + FL x2 + AN + AC + | 6.5 | 7.0 | 7.0 | 7.5 |
| SAF + POL | | | | |
| 38 FE + FL x3 + AN + AC + | 6.5 | 6.5 | 7.0 | 7.0 |
| SAF + POL | | | | |
| 39 FE + FL x1 + SAF + POL | 7.0 | 7.0 | 7.0 | 7.0 |
| 40 FE + FL x2 + SAF + POL | 6.0 | 7.0 | 7.0 | 7.0 |
| 41 FE + FL x3 + SAF + | 6.0 | 6.0 | 7.0 | 7.0 |
| POL | | | | |

TABLE 2.7
MAIZE - BENEFITS TO CROP SAFENING/VIGOUR AND EARLY
SHOOT FRESH WEIGHT 21 DAYS AFTER SOWING FROM ADDITION OF
SAFENER PLUS ANTHRANILIC ACID PLUS ACETAMINOPHEN TO THE
FUNGICIDE PROCHLORAZ WHEN APPLIED AS A SEED TREATMENT.

| | | | Percent (%) of | |
|---|---|---|---|---|
| | | | Untreated | |
| | | | Control (% of | |
| | | | relevant | Vigour (0-9); |
| | | Shoot Fresh | Fungicide | 9 = most |
| Treatment | Rate(s) | Weight (g) | Control) | vigour. |
| 1. Untreated | — | 9.0 | 100 | 3.9 |
| 2. Prochloraz (400 g/l) | 50 ml per 100 kg | 13.2 | 146 (100) | 5.0 |
| x1 Seed | seed | | | |
| Treatment Rate | | | | |
| 3. Prochloraz (400 g/l) | 100 ml per | 14.8 | 164 (100) | 6.1 |
| x2 Rate | 100 kg seed | | | |
| 4. Prochloraz (400 g/l) | 150 ml per | 15.9 | 177 (100) | 7.3 |
| x3 Rate | 100 kg seed | | | |
| 5. Prochloraz (400 g/l) | 50 ml per 100 kg | 15.5 | 172 (117) | 7.4 |
| x1 Rate + AN + | seed + 3 ml | | | |
| AC + SAF | per 500 g seed | | | |
| 6. Prochloraz (400 g/l) | 100 ml per | 17.8 | 198 (120) | 7.8 |
| x2 Rate + AN + | 100 kg seed + | | | |
| AC + SAF | 3 ml per 500 g | | | |
| | seed | | | |
| 7. Prochloraz (400 g/l) | 150 ml per | 16.4 | 182 (103) | 7.5 |
| x3 Rate + AN + | 100 kg seed + | | | |
| AC + SAF | 3 ml per 500 g | | | |
| | seed | | | |

As shown in Tables 2.1 to 2.7, each of the safening formulations showed a significant reduction in phytotoxicity when applied to a range of species in combination with fungicides, when compared to the application of fungicides alone. Thus the safening systems improve crop safening in a range of species. This applies to either the safening formulations applied in foliar applications (Tables 2.1 to 2.6) or as seed treatments (Table 2.7). Increases in vigour and early shoot weight are also noted.

### Example 3

### Safening of Herbicides

Safening systems were applied to crops of oilseed rape and winter treated with various herbicides (Bifenox (with insecticide), Carbetamide, Propaquizafop, Chlorotoluron, Isoproturon, Flumioxazin). The safening system and the herbicide were applied to the crops either simultaneously or sequentially.

Oilseed rape: cv Excalibur, sown 26 Apr. 2008, at two seeds per 9 cm pot, sown in normal pH multi-purpose compost. Date of spraying: 6 June; Dates of measurement/scoring: 13 June, 20 June, 5 July.
Winter wheat: cv Alchemy, sown 23 Apr. 2008, at seven seeds per 9 cm pot, sown in normal pH multi-purpose compost. Date of spraying: 24 May; Dates of measurement/scoring: 31 May, 7 June, 21 June.
SAF: at least one from class (f) each at <3 g/l, plus at least one from class (c).

The results are shown in Tables 3.1 to 3.5 below.

Statistical Layout: Randomised Complete Block trials, under glasshouse conditions, United Kingdom.

Statistical Analyses (Least Significant Difference, 5% Level) for Tables 3.1 to 3.5:

Tables 3.1 and 3.2:

| | | | | | Green- | Green- |
|---|---|---|---|---|---|---|
| LSD (5%) | Phyto + | Phyto + | Vigour + | Vigour + | ness + | ness + |
| Treatment | 14 | 28 | 14 | 28 | 14 | 28 |
| Means | Days | Days | Days | Days | Days | Days |
| | 1.22 | 1.31 | 1.44 | 1.37 | 1.35 | 1.36 |

Tables 3.3, 3.4 and 3.5:

| | | | | | Green- | Green- |
|---|---|---|---|---|---|---|
| LSD (5%) | Phyto + | Phyto + | Vigour + | Vigour + | ness + | ness + |
| Treatment | 14 | 28 | 14 | 28 | 14 | 28 |
| Means | Days | Days | Days | Days | Days | Days |
| | 1.19 | 1.28 | 1.47 | 1.42 | 1.32 | 1.37 |

TABLE 3.1
OILSEED RAPE - CROP SAFENING BENEFITS FROM ADDITION OF SAFENER AND/OR ANTHRANILIC
ACID AND/OR ACETAMINOPHEN TO THE HERBICIDE BIFENOX (with insecticide).

| | | Phytotoxicity | Phytotoxicity | Vigour | | Greenness | |
|---|---|---|---|---|---|---|---|
| | | (0-9) (0 = | (0-9) (0 = | (0-9) (9 = Most | Vigour | (0-9) (9 = Deeper | Greenness |
| | | Dead) + | Dead) + | Vigour) + | (0-9) + | Green) + | (0-9) + |
| Treatment | | 14 Days | 28 Days | 14 days | 28 Days | 14 Days | 28 Days |
| 1. | Untreated | 8.0 | 8.0 | 8.0 | 8.0 | 8.0 | 7.5 |
| 2. | AN (Anthranilic Acid) | 9.0 | 8.0 | 9.0 | 8.0 | 8.0 | 8.0 |
| 3. | AC (Acetaminophen) | 8.0 | 8.0 | 8.0 | 8.0 | 8.0 | 8.0 |
| 4. | AN + AC | 8.0 | 8.0 | 8.0 | 8.0 | 8.0 | 8.0 |
| 5. | AN + AC + Terpene | 7.5 | 7.5 | 7.0 | 7.0 | 7.0 | 7.0 |
| 6. | Safeners | 8.0 | 8.0 | 8.0 | 8.0 | 8.0 | 8.0 |
| 7. | AN + SAF | 7.5 | 8.0 | 7.5 | 8.0 | 7.0 | 7.5 |
| 8. | AC + SAF | 8.0 | 8.0 | 8.0 | 8.0 | 8.0 | 8.0 |
| 9. | AN + AC + SAF | 7.5 | 8.0 | 7.0 | 7.5 | 8.0 | 8.0 |
| 10. | AN + AC + SAF + | 7.5 | 7.5 | 7.5 | 7.0 | 7.0 | 7.0 |
| | Terpene | | | | | | |
| 11. | 1.0 l/ha Bifenox (480 g/l) + | 5.0 | 3.5 | 5.5 | 4.5 | 4.0 | 2.5 |
| | Cypermethrin (rec rate) − | | | | | | |
| | Bif + CP | | | | | | |
| 12. | 1.5 l/ha Bif + x1 CP | 4.5 | 3.5 | 4.5 | 3.0 | 4.0 | 2.5 |
| 13. | 2.0 l/ha Bif + x1 CP | 4.0 | 3.0 | 4.0 | 3.5 | 4.0 | 2.5 |
| 14. | 1.0 l/ha Bif + x1 CP + AN | 6.5 | 5.0 | 7.0 | 5.0 | 3.5 | 4.0 |
| 15. | 1.5 l/ha Bif + x1 CP + AN | 6.0 | 5.0 | 6.0 | 5.0 | 3.0 | 3.0 |
| 16. | 2.0 l/ha Bif + x1 CP + AN | 5.0 | 4.5 | 5.5 | 5.0 | 2.5 | 3.0 |
| 17. | 1.0 l/ha Bif + x1 CP + AC | 5.0 | 4.0 | 6.0 | 4.5 | 4.0 | 2.5 |

| | | Phyto | Phyto | Vigour | Vigour | Greenness | Greenness |
|---|---|---|---|---|---|---|---|
| | | (0-9) + | (0-9) + | (0-9) + | (0-9) + | (0-9) + | (0-9) + |
| Treatment | | 14 Days | 28 Days | 14 Days | 28 Days | 14 Days | 28 Days |
| 18. | 1.5 l/ha Bif + x1 CP + AC | 4.5 | 3.5 | 4.5 | 3.0 | 4.0 | 2.5 |
| 19. | 2.0 l/ha Bif + x1 CP + AC | 4.0 | 3.0 | 4.0 | 3.5 | 4.0 | 2.5 |
| 20. | 1.0 l/ha Bif + x1 CP + | 4.0 | 5.5 | 5.0 | 5.5 | 4.0 | 4.0 |
| | AN + AC | | | | | | |
| 21. | 1.5 l/ha Bif + x1 CP + | 3.5 | 5.0 | 4.0 | 4.5 | 4.0 | 4.0 |
| | AN + AC | | | | | | |
| 22. | 2.0 l/ha Bif + x1 CP + | 3.5 | 5.0 | 4.0 | 5.5 | 2.5 | 2.0 |
| | AN + AC | | | | | | |
| 23. | 1.0 l/ha Bif + x1 CP + SAF | 6.5 | 6.5 | 6.0 | 6.0 | 6.0 | 6.0 |
| 24. | 1.5 l/ha Bif + x1 CP + SAF | 6.0 | 6.5 | 6.0 | 7.0 | 6.0 | 6.0 |
| 25. | 2.0 l/ha Bif + x1 CP + SAF | 5.5 | 7.0 | 5.0 | 6.0 | 5.5 | 5.5 |
| 26. | 1.0 l/ha Bif + x1 CP + | 6.0 | 6.5 | 6.0 | 6.0 | 6.0 | 6.0 |
| | AN + SAF | | | | | | |
| 27. | 1.5 l/ha Bif + x1 CP + | 6.0 | 6.5 | 6.0 | 7.0 | 6.0 | 6.0 |
| | AN + SAF | | | | | | |
| 28. | 2.0 l/ha Bif + x1 CP + | 5.0 | 7.0 | 5.0 | 6.0 | 5.5 | 5.5 |
| | AN + SAF | | | | | | |
| 29. | 1.0 l/ha Bif + x1 CP + | 6.0 | 7.0 | 6.0 | 6.0 | 6.0 | 6.5 |
| | AC + SAF | | | | | | |
| 30. | 1.5 l/ha Bif + x1 CP + | 5.5 | 7.0 | 5.5 | 6.0 | 6.0 | 6.0 |
| | AC + SAF | | | | | | |
| 31. | 2.0 l/ha Bif + x1 CP + | 5.0 | 6.5 | 5.0 | 6.0 | 6.0 | 6.0 |
| | AC + SAF | | | | | | |
| 32. | 1.0 l/ha Bif + x1 CP + AN + | 8.0 | 8.0 | 7.5 | 7.5 | 6.0 | 7.0 |
| | AC + SAF | | | | | | |
| 33. | 1.5 l/ha Bif + x1 CP + AN + | 7.0 | 8.0 | 7.0 | 7.5 | 6.0 | 6.5 |
| | AC + SAF | | | | | | |
| 34. | 2.0 l/ha Bif + x1 CP + AN + | 6.5 | 7.5 | 6.5 | 7.0 | 6.5 | 6.5 |
| | AC + SAF | | | | | | |
| 35. | 1.0 l/ha Bif + x1 CP + AN + | 6.0 | 7.0 | 7.0 | 7.0 | 7.0 | 7.0 |
| | AC + SAF + Terpene | | | | | | |
| 36. | 1.5 l/ha Bif + x1 CP + AN + | 5.5 | 6.0 | 6.0 | 6.0 | 6.5 | 6.0 |
| | AC + SAF + Terpene | | | | | | |
| 37. | 2.0 l/ha Bif + x1 CP + AN + | 5.0 | 7.0 | 6.0 | 6.0 | 6.5 | 6.0 |
| | AC + SAF + Terpene | | | | | | |
| 38. | 1.0 l/ha Bif + x1 CP + AN + | 5.5 | 6.5 | 5.5 | 6.5 | 5.5 | 5.5 |
| | AC + Terpene | | | | | | |
| 39. | 1.5 l/ha Bif + x1 CP + AN + | 5.0 | 5.5 | 5.5 | 5.5 | 6.0 | 5.5 |
| | AC + Terpene | | | | | | |
| 40. | 2.0 l/ha Bif + x1 CP + AN + | 4.5 | 5.0 | 5.0 | 5.5 | 5.0 | 5.0 |
| | AC + Terpene | | | | | | |
| 41. | 1.0 l/ha Bif + x1 CP + | 5.0 | 6.0 | 5.0 | 5.0 | 5.0 | 4.5 |
| | Terpene | | | | | | |
| 42. | 1.5 l/ha Bif + x1 CP + | 4.5 | 5.0 | 4.5 | 5.5 | 5.0 | 4.0 |
| | Terpene | | | | | | |
| 43. | 2.0 l/ha Bif + x1 CP + | 4.5 | 5.0 | 5.0 | 5.0 | 4.5 | 4.0 |
| | Terpene | | | | | | |
| 44. | 1.0 l/ha Bif + x1 CP fb | 6.0 | 5.0 | 6.0 | 5.0 | 5.0 | 4.0 |
| | AN + AC after 7 Days. | | | | | | |
| 45. | 1.5 l/ha Bif + x1 CP fb | 5.5 | 5.0 | 6.5 | 5.5 | 4.0 | 3.5 |
| | AN + AC after 7 Days | | | | | | |
| 46. | 2.0 l/ha Bif + x1 CP fb | 5.0 | 4.5 | 6.0 | 5.0 | 3.5 | 3.5 |
| | AN + AC after 7 Days | | | | | | |
| 47. | 1.0 l/ha Bif + x1 CP fb AN + | 5.5 | 5.0 | 6.0 | 6.0 | 5.0 | 5.0 |
| | AC + SAF after 7 Days | | | | | | |
| 48. | 1.5 l/ha Bif + x1 CP fb AN + | 5.0 | 4.5 | 6.0 | 4.5 | 5.0 | 4.5 |
| | AC + SAF after 7 Days | | | | | | |
| 49. | 2.0 l/ha Bif + x1 CP fb AN + | 4.5 | 4.5 | 5.5 | 4.5 | 4.5 | 4.5 |
| | AC + SAF after 7 Days. | | | | | | |
| 50. | 1.0 l/ha Bif + x1 CP fb AN + | 6.0 | 5.0 | 6.0 | 5.5 | 6.0 | 6.0 |
| | AC + SAF + Terpene | | | | | | |
| | after 7 Days | | | | | | |
| 51. | 1.5 l/ha Bif + x1 CP fb AN + | 6.0 | 4.5 | 6.0 | 4.5 | 5.0 | 5.0 |
| | AC + SAF + Terpene | | | | | | |
| | after 7 Days | | | | | | |
| 52. | 2.0 l/ha Bif + x1 CP fb AN + | 5.0 | 4.5 | 5.5 | 5.0 | 5.0 | 5.0 |
| | AC + SAF + Terpene | | | | | | |
| | after 7 Days | | | | | | |
| 53. | 1.0 l/ha Bif + x1 CP fb SAF | 6.0 | 4.5 | 6.0 | 5.0 | 4.0 | 3.0 |
| | after 7 Days | | | | | | |
| 54. | 1.5 l/ha Bif + x1 CP fb SAF | 5.5 | 4.5 | 6.0 | 4.5 | 4.0 | 3.5 |
| | after 7 Days | | | | | | |
| 55. | 2.0 l/ha Bif + x1 CP fb SAF | 5.0 | 4.5 | 5.0 | 5.0 | 3.5 | 3.0 |
| | after 7 Days | | | | | | |

TABLE 3.2
OILSEED RAPE - CROP SAFENING BENEFITS FROM ADDITION OF SAFENER AND/OR ANTHRANILIC
ACID AND/OR ACETAMINOPHEN TO THE HERBICIDES CARBETAMIDE AND PROPAQUIZAFOP

| | | Phytotoxicity | | Vigour | | Greenness | |
|---|---|---|---|---|---|---|---|
| | | (0-9) (0 = | Phytotoxicity | (0-9) (9 = Most | Vigour | (0-9) (9 = Deeper | Greenness |
| | | Dead) + | (0-9) + | Vigour) + | (0-9) + | Green) + | (0-9) + |
| Treatment | | 14 Days | 28 Days | 14 days | 28 Days | 14 Days | 28 Days |
| 1. | Untreated | 8.0 | 8.0 | 8.0 | 8.0 | 8.0 | 7.5 |
| 2. | AN (Anthranilic Acid) | 9.0 | 8.0 | 9.0 | 8.0 | 8.0 | 8.0 |
| 3. | AC (Acetaminophen) | 8.0 | 8.0 | 8.0 | 8.0 | 8.0 | 8.0 |
| 4. | AN + AC | 8.0 | 8.0 | 8.0 | 8.0 | 8.0 | 8.0 |
| 5. | AN + AC + Terpene | 7.5 | 7.5 | 7.0 | 7.0 | 7.0 | 7.0 |
| 6. | SAF | 8.0 | 8.0 | 8.0 | 8.0 | 8.0 | 8.0 |
| 7. | AN + SAF | 7.5 | 8.0 | 7.5 | 8.0 | 7.0 | 7.5 |
| 8. | AC + SAF | 8.0 | 8.0 | 8.0 | 8.0 | 8.0 | 8.0 |
| 9. | AN + AC + SAF | 7.5 | 8.0 | 7.0 | 7.5 | 8.0 | 8.0 |
| 10. | AN + AC + SAF + | 7.5 | 7.5 | 7.5 | 7.0 | 7.0 | 7.0 |
| | Terpene | | | | | | |
| 11. | 2.5 kg/ha Carbetamide | 6.0 | 4.5 | 5.5 | 4.0 | 7.0 | 6.5 |
| | (60% w/w) + 0.5 l/ha | | | | | | |
| | Propaquizafop = Car + Prop | | | | | | |
| 12. | 3.5 kg/ha Car + 0.7 Prop | 6.0 | 4.5 | 5.0 | 4.0 | 6.5 | 6.0 |
| 13. | 4.5 kg/ha Car + 0.8 Prop | 4.0 | 4.0 | 4.5 | 3.5 | 7.0 | 5.5 |
| 14. | x1 Car + Prop + AN | 5.5 | 3.5 | 6.0 | 5.5 | 7.0 | 6.5 |
| 15. | x2 Car + Prop + AN | 5.5 | 3.5 | 6.0 | 5.0 | 6.5 | 6.0 |
| 16. | x3 Car + Prop + AN | 4.5 | 3.5 | 6.0 | 5.0 | 6.5 | 6.0 |
| 17. | x1 Car + Prop + AC | 6.0 | 5.0 | 5.5 | 4.5 | 7.0 | 7.0 |
| 18. | x2 Car + Prop + AC | 5.5 | 4.0 | 5.0 | 4.5 | 6.5 | 6.5 |
| 19. | x3 Car + Prop + AC | 4.5 | 3.0 | 4.5 | 4.5 | 6.0 | 6.0 |
| 20. | x1 Car + Prop + AN + AC | 5.0 | 5.0 | 5.5 | 5.5 | 6.0 | 6.0 |
| 21. | x2 Car + Prop + AN + AC | 4.0 | 4.0 | 6.0 | 5.0 | 6.0 | 6.0 |
| 22. | x3 Car + Prop + AN + AC | 3.0 | 4.0 | 4.0 | 3.5 | 6.0 | 5.5 |
| 23. | x1 Car + Prop + SAF | 6.0 | 6.5 | 6.5 | 6.5 | 7.0 | 7.0 |
| 24. | x2 Car + Prop + SAF | 6.0 | 6.5 | 6.0 | 6.5 | 7.0 | 7.0 |
| 25. | x3 Car + Prop + SAF | 6.0 | 6.0 | 6.0 | 6.0 | 7.0 | 6.5 |
| 26. | x1 Car + Prop + AN + SAF | 6.5 | 6.5 | 6.5 | 6.5 | 6.5 | 6.5 |
| 27. | x2 Car + Prop + AN + SAF | 6.0 | 6.5 | 5.5 | 6.0 | 7.0 | 7.0 |
| 28. | x3 Car + Prop + AN + SAF | 5.5 | 6.0 | 5.5 | 5.5 | 6.5 | 6.5 |
| 29. | x1 Car + Prop + AC + SAF | 6.0 | 5.5 | 6.0 | 5.0 | 6.0 | 6.0 |
| 30. | x2 Car + Prop + AC + SAF | 5.5 | 5.5 | 5.5 | 5.5 | 6.0 | 6.0 |
| 31. | x3 Car + Prop + AC + SAF | 5.0 | 5.0 | 5.0 | 5.0 | 6.0 | 6.0 |
| 32. | x1 Car + Prop + AN + | 6.0 | 7.0 | 7.0 | 7.0 | 7.0 | 6.5 |
| | AC + SAF | | | | | | |
| 33. | x2 Car + Prop + AN + | 6.0 | 7.0 | 7.5 | 7.0 | 7.0 | 7.0 |
| | AC + SAF | | | | | | |
| 34. | x3 Car + Prop + AN + | 6.0 | 6.5 | 7.5 | 6.5 | 6.5 | 6.0 |
| | AC + SAF | | | | | | |
| 35. | x1 Car + Prop + AN + AC + | 6.0 | 6.5 | 6.0 | 6.0 | 6.5 | 6.5 |
| | SAF + Terpene | | | | | | |
| 36. | x2 Car + Prop + AN + AC + | 5.0 | 5.5 | 6.5 | 5.5 | 7.0 | 6.5 |
| | SAF + Terpene | | | | | | |
| 37. | x3 Car + Prop + AN + AC + | 5.0 | 5.5 | 5.0 | 5.5 | 6.5 | 6.5 |
| | SAF + Terpene | | | | | | |
| 38. | x1 Car + Prop + AN + | 5.0 | 4.5 | 5.5 | 4.5 | 5.5 | 6.0 |
| | AC + Terpene | | | | | | |
| 39. | x2 Car + Prop + AN + | 5.0 | 5.0 | 5.5 | 5.5 | 6.0 | 6.0 |
| | AC + Terpene | | | | | | |
| 40. | x3 Car + Prop + AN + | 4.5 | 4.0 | 5.0 | 4.0 | 5.5 | 5.5 |
| | AC + Terpene | | | | | | |
| 41. | x1 Car + Prop + Terpene | 6.0 | 5.0 | 6.0 | 5.0 | 6.0 | 5.5 |
| 42. | x2 Car + Prop + Terpene | 5.5 | 5.0 | 5.5 | 4.5 | 5.5 | 5.5 |
| 43. | x3 Car + Prop + Terpene | 5.5 | 4.5 | 5.0 | 4.0 | 5.5 | 5.0 |
| 44. | x1 Car + Prop fb (followed | 6.0 | 5.0 | 5.5 | 4.0 | 6.0 | 6.0 |
| | by) AN + AC after 7 Days. | | | | | | |
| 45. | x2 Car + Prop fb AN + AC | 6.0 | 5.0 | 5.5 | 5.5 | 5.5 | 5.5 |
| | after 7 Days | | | | | | |
| 46. | x3 Car + Prop fb AN + AC | 6.0 | 4.5 | 5.0 | 5.0 | 6.0 | 5.0 |
| | after 7 Days | | | | | | |
| 47. | x1 Car + Prop fb AN + | 5.5 | 6.0 | 5.5 | 5.5 | 6.0 | 6.0 |
| | AC + SAF after 7 Days | | | | | | |
| 48. | x2 Car + Prop fb AN + | 5.5 | 6.0 | 5.0 | 5.5 | 5.0 | 5.0 |
| | AC + SAF after 7 Days | | | | | | |
| 49. | x3 Car + Prop fb AN + | 5.5 | 5.0 | 6.0 | 5.0 | 5.0 | 5.0 |
| | AC + SAF after 7 Days. | | | | | | |
| 50. | x1 Car + Prop fb AN + | 5.5 | 5.5 | 5.5 | 5.5 | 6.0 | 6.0 |
| | AC + SAF + Terpene | | | | | | |
| | after 7 Days | | | | | | |
| 51. | x2 Car + Prop fb AN + | 5.5 | 5.5 | 5.0 | 5.5 | 5.0 | 5.0 |
| | AC + SAF + Terpene | | | | | | |
| | after 7 Days | | | | | | |
| 52. | x3 Car + Prop fb AN + | 5.0 | 5.5 | 5.0 | 5.0 | 5.0 | 5.0 |
| | AC + SAF + Terpene | | | | | | |
| | after 7 Days | | | | | | |
| 53. | x1 Car + Prop fb SAF | 6.0 | 5.5 | 6.0 | 5.0 | 6.0 | 6.0 |
| | after 7 Days | | | | | | |
| 54. | x2 Car + Prop fb SAF | 5.5 | 5.0 | 5.5 | 5.5 | 5.0 | 5.0 |
| | after 7 Days | | | | | | |
| 55. | x3 Car + Prop fb SAF | 6.0 | 5.0 | 5.5 | 5.0 | 5.5 | 5.0 |
| | after 7 Days | | | | | | |

TABLE 3.3
WINTER WHEAT - CROP SAFENING BENEFITS FROM ADDITION OF SAFENING SYSTEM AND/OR
ANTHRANILIC ACID AND/OR ACETAMINOPHEN TO THE HERBICIDE CHLOROTOLURON

| | | Phytotoxicity | | Vigour | | Greenness | |
|---|---|---|---|---|---|---|---|
| | | (0-9) (0 = | Phytotoxicity | (0-9) (9 = Most | Vigour | (0-9) (9 = Deeper | Greenness |
| | | Dead) + | (0-9) + | Vigour) + | (0-9) + | Green) + | (0-9) + |
| Treatment | | 14 Days | 28 Days | 14 days | 28 Days | 14 Days | 28 Days |
| 1. | Untreated | 8.0 | 8.0 | 8.0 | 8.0 | 8.0 | 7.5 |
| 2. | AN (Anthranilic Acid) | 9.0 | 8.0 | 9.0 | 8.0 | 8.0 | 8.0 |
| 3. | AC (Acetaminophen) | 8.0 | 8.0 | 8.0 | 8.0 | 8.0 | 8.0 |
| 4. | AN + AC | 8.0 | 8.0 | 8.0 | 8.0 | 8.0 | 8.0 |
| 5. | AN + AC + Terpene | 7.5 | 7.5 | 7.0 | 7.0 | 7.0 | 7.0 |
| 6. | SAF | 8.0 | 8.0 | 8.0 | 8.0 | 8.0 | 8.0 |
| 7. | AN + SAF | 7.5 | 8.0 | 7.5 | 8.0 | 7.0 | 7.5 |
| 8. | AC + SAF | 8.0 | 8.0 | 8.0 | 8.0 | 8.0 | 8.0 |
| 9. | AN + AC + SAF | 7.5 | 8.0 | 7.0 | 7.5 | 8.0 | 8.0 |
| 10. | AN + AC + SAF + | 7.5 | 7.5 | 7.5 | 7.0 | 7.0 | 7.0 |
| | Terpene | | | | | | |
| 11. | 4.0 l/ha Chlorotoluron 500 | 6.5 | 5.5 | 7.0 | 4.5 | 8.0 | 8.0 |
| | (500 g/l) (x1 rate) = Chlor | | | | | | |
| 12. | 7.0 l/ha Chlor (x2 rate) | 6.0 | 5.0 | 7.0 | 5.0 | 8.0 | 7.5 |
| 13. | 10.0 l/ha Chlor (x3 rate) | 6.0 | 4.0 | 6.5 | 4.5 | 8.0 | 7.5 |
| 14. | x1 Chlor + AN | 7.0 | 5.0 | 7.0 | 5.0 | 7.5 | 8.0 |
| 15. | x2 Chlor + AN | 7.0 | 5.0 | 7.0 | 5.0 | 7.5 | 8.5 |
| 16. | x3 Chlor + AN | 7.0 | 4.0 | 6.5 | 4.5 | 8.0 | 8.0 |
| 17. | x1 Chlor + AC | 7.0 | 5.5 | 7.0 | 4.5 | 8.0 | 8.0 |
| 18. | x2 Chlor + AC | 6.5 | 5.0 | 6.5 | 5.0 | 7.5 | 7.0 |
| 19. | x3 Chlor + AC | 6.0 | 5.0 | 6.5 | 4.5 | 8.0 | 8.0 |
| 20. | x1 Chlor + AN + AC | 7.0 | 5.5 | 6.5 | 4.5 | 8.0 | 8.0 |
| 21. | x2 Chlor + AN + AC | 6.0 | 5.5 | 7.0 | 5.0 | 8.0 | 8.0 |
| 22. | x3 Chlor + AN + AC | 6.5 | 4.5 | 6.5 | 5.0 | 7.5 | 7.5 |
| 23. | x1 Chlor + SAF | 7.0 | 6.5 | 6.5 | 6.0 | 7.5 | 7.5 |
| 24. | x2 Chlor + SAF | 7.5 | 6.0 | 7.0 | 6.5 | 7.5 | 7.5 |
| 25. | x3 Chlor + SAF | 7.0 | 6.0 | 6.5 | 6.0 | 8.0 | 7.5 |
| 26. | x1 Chlor + AN + SAF | 7.0 | 6.5 | 6.5 | 6.0 | 8.0 | 8.0 |
| 27. | x2 Chlor + AN + SAF | 7.0 | 7.0 | 6.5 | 6.0 | 8.0 | 8.0 |
| 28. | x3 Chlor + AN + SAF | 7.0 | 6.0 | 7.0 | 6.0 | 8.0 | 8.0 |
| 29. | x1 Chlor + AC + SAF | 7.5 | 6.5 | 6.5 | 6.0 | 7.0 | 8.0 |
| 30. | x2 Chlor + AC + SAF | 7.0 | 7.0 | 7.0 | 5.5 | 7.5 | 8.0 |
| 31. | x3 Chlor + AC + SAF | 6.5 | 5.5 | 7.0 | 5.5 | 8.0 | 7.5 |
| 32. | x1 Chlor + AN + | 7.0 | 7.0 | 7.0 | 6.5 | 8.0 | 7.5 |
| | AC + SAF | | | | | | |
| 33. | x2 Chlor + AN + | 7.0 | 6.0 | 6.5 | 5.5 | 7.5 | 7.5 |
| | AC + SAF | | | | | | |
| 34. | x3 Chlor + AN + | 6.5 | 6.0 | 7.0 | 5.0 | 7.5 | 8.0 |
| | AC + SAF | | | | | | |
| 35. | x1 Chlor + AN + AC + | 6.0 | 7.0 | 7.5 | 6.0 | 8.0 | 7.5 |
| | SAF + Terpene | | | | | | |
| 36. | x2 Chlor + AN + AC + | 6.5 | 7.0 | 6.5 | 5.0 | 7.5 | 8.0 |
| | SAF + Terpene | | | | | | |
| 37. | x3 Chlor + AN + AC + | 6.5 | 6.5 | 6.5 | 5.0 | 8.0 | 7.5 |
| | SAF + Terpene | | | | | | |
| 38. | x1 Chlor + AN + AC + | 7.0 | 7.0 | 6.5 | 5.5 | 7.5 | 8.0 |
| | Terpene | | | | | | |
| 39. | x2 Chlor + AN + AC + | 6.5 | 7.0 | 6.5 | 5.0 | 7.5 | 8.0 |
| | Terpene | | | | | | |
| 40. | x3 Chlor + AN + AC + | 7.0 | 6.0 | 6.5 | 5.0 | 8.0 | 7.5 |
| | Terpene | | | | | | |
| 41. | x1 Chlor + Terpene | 7.0 | 6.0 | 7.0 | 5.0 | 8.0 | 7.5 |
| 42. | x2 Chlor + Terpene | 7.0 | 5.5 | 6.5 | 4.5 | 8.0 | 8.0 |
| 43. | x3 Chlor + Terpene | 7.0 | 5.0 | 7.0 | 4.5 | 7.5 | 8.0 |
| 44. | x1 Chlor fb (followed by) | 6.5 | 6.0 | 7.0 | 7.0 | 8.0 | 8.0 |
| | AN + AC after 7 Days. | | | | | | |
| 45. | x2 Chlor fb AN + AC | 7.0 | 5.0 | 6.5 | 5.0 | 8.0 | 7.0 |
| | after 7 Days | | | | | | |
| 46. | x3 Chlor fb AN + AC | 6.5 | 5.0 | 6.0 | 5.0 | 7.5 | 7.5 |
| | after 7 Days | | | | | | |
| 47. | x1 Chlor fb AN + AC + SAF | 7.0 | 6.0 | 6.5 | 6.5 | 8.0 | 8.0 |
| | after 7 Days | | | | | | |
| 48. | x2 Chlor fb AN + AC + SAF | 7.0 | 6.0 | 7.0 | 6.0 | 8.0 | 8.0 |
| | after 7 Days | | | | | | |
| 49. | x3 Chlor fb AN + AC + SAF | 7.0 | 6.0 | 7.0 | 7.0 | 8.0 | 8.0 |
| | after 7 Days. | | | | | | |
| 50. | x1 Chlor fb AN + AC + SAF + | 7.0 | 6.0 | 7.0 | 5.5 | 8.0 | 8.0 |
| | Terpene after 7 Days | | | | | | |
| 51. | x2 Chlor fb AN + AC + SAF + | 7.0 | 6.0 | 6.5 | 5.0 | 8.0 | 8.0 |
| | Terpene after 7 Days | | | | | | |
| 52. | x3 Chlor fb AN + AC + SAF + | 7.0 | 6.0 | 7.0 | 5.0 | 8.0 | 7.5 |
| | Terpene after 7 Days | | | | | | |
| 53. | x1 Chlor fb SAF after | 6.5 | 6.0 | 7.0 | 6.0 | 7.0 | 7.5 |
| | 7 Days | | | | | | |
| 54. | x2 Chlor fb SAF after | 6.5 | 5.5 | 7.0 | 6.0 | 8.0 | 8.0 |
| | 7 Days | | | | | | |
| 55. | x3 Chlor fb SAF after | 6.5 | 6.0 | 6.5 | 5.5 | 8.0 | 7.0 |
| | 7 Days | | | | | | |

TABLE 3.4
WINTER WHEAT - CROP SAFENING BENEFITS FROM ADDITION OF SAFENING SYSTEM AND/OR
ANTHRANILIC ACID AND/OR ACETAMINOPHEN TO THE HERBICIDE ISOPROTURON

| | | Phytotoxicity | | Vigour | | Greenness | |
|---|---|---|---|---|---|---|---|
| | | (0-9) (0 = | Phytotoxicity | (0-9) (9 = Most | Vigour | (0-9) (9 = Deeper | Greenness |
| | | Dead) + | (0-9) + | Vigour) + | (0-9) + | Green) + | (0-9) + |
| Treatment | | 14 Days | 28 Days | 14 days | 28 Days | 14 Days | 28 Days |
| 1. | Untreated | 8.0 | 8.0 | 8.0 | 8.0 | 8.0 | 7.5 |
| 2. | AN (Anthranilic Acid) | 9.0 | 8.0 | 9.0 | 8.0 | 8.0 | 8.0 |
| 3. | AC (Acetaminophen) | 8.0 | 8.0 | 8.0 | 8.0 | 8.0 | 8.0 |
| 4. | AN + AC | 8.0 | 8.0 | 8.0 | 8.0 | 8.0 | 8.0 |
| 5. | AN + AC + Terpene | 7.5 | 7.5 | 7.0 | 7.0 | 7.0 | 7.0 |
| 6. | SAF | 8.0 | 8.0 | 8.0 | 8.0 | 8.0 | 8.0 |
| 7. | AN + SAF | 7.5 | 8.0 | 7.5 | 8.0 | 7.0 | 7.5 |
| 8. | AC + SAF | 8.0 | 8.0 | 8.0 | 8.0 | 8.0 | 8.0 |
| 9. | AN + AC + SAF | 7.5 | 8.0 | 7.0 | 7.5 | 8.0 | 8.0 |
| 10. | AN + AC + SAF + | 7.5 | 7.5 | 7.5 | 7.0 | 7.0 | 7.0 |
| | Terpene | | | | | | |
| 11. | 3.0 l/ha Isoproturon (500 | 6.5 | 3.5 | 7.0 | 6.0 | 8.0 | 8.0 |
| | g/l) (x1 rate) = IPU | | | | | | |
| 12. | 5.0 l/ha IPU (x2 rate) | 7.0 | 3.0 | 7.0 | 5.5 | 7.5 | 8.0 |
| 13. | 7.0 l/ha IPU (x3 rate) | 7.0 | 2.5 | 6.5 | 5.0 | 7.0 | 8.0 |
| 14. | x1 IPU + AN | 6.0 | 4.0 | 6.5 | 6.5 | 8.0 | 7.5 |
| 15. | x2 IPU + AN | 7.0 | 3.0 | 7.0 | 6.0 | 8.0 | 7.5 |
| 16. | x3 IPU + AN | 7.0 | 3.0 | 7.0 | 6.0 | 8.0 | 7.5 |
| 17. | x1 IPU + AC | 7.0 | 3.0 | 7.0 | 5.0 | 7.5 | 8.0 |
| 18. | x2 IPU + AC | 7.0 | 3.0 | 6.0 | 5.0 | 7.5 | 8.0 |
| 19. | x3 IPU + AC | 6.5 | 3.0 | 7.0 | 5.0 | 8.0 | 8.0 |
| 20. | x1 IPU + AN + AC | 7.0 | 3.5 | 7.0 | 5.5 | 8.0 | 8.0 |
| 21. | x2 IPU + AN + AC | 7.0 | 3.5 | 7.0 | 5.5 | 8.0 | 8.0 |
| 22. | x3 IPU + AN + AC | 6.0 | 3.0 | 7.0 | 5.5 | 7.5 | 8.0 |
| 23. | x1 IPU + SAF | 6.0 | 4.5 | 6.5 | 6.5 | 7.5 | 8.0 |
| 24. | x2 IPU + SAF | 7.0 | 4.5 | 7.0 | 6.5 | 8.0 | 7.5 |
| 25. | x3 IPU + SAF | 7.0 | 4.0 | 7.5 | 6.5 | 8.0 | 8.0 |
| 26. | x1 IPU + AN + SAF | 7.0 | 4.5 | 7.0 | 6.5 | 8.0 | 8.0 |
| 27. | x2 IPU + AN + SAF | 6.5 | 4.5 | 7.0 | 6.0 | 7.5 | 8.0 |
| 28. | x3 IPU + AN + SAF | 7.0 | 4.0 | 6.5 | 6.5 | 7.5 | 8.0 |
| 29. | x1 IPU + AC + SAF | 7.0 | 5.0 | 7.0 | 7.0 | 7.5 | 8.0 |
| 30. | x2 IPU + AC + SAF | 6.5 | 4.0 | 6.5 | 6.5 | 8.0 | 7.5 |
| 31. | x3 IPU + AC + SAF | 7.0 | 4.0 | 6.0 | 6.5 | 8.0 | 8.0 |
| 32. | x1 IPU + AN + AC + SAF | 7.0 | 5.0 | 6.0 | 7.0 | 8.0 | 8.0 |
| 33. | x2 IPU + AN + AC + SAF | 7.0 | 4.5 | 6.5 | 6.0 | 8.0 | 8.0 |
| 34. | x3 IPU + AN + AC + SAF | 6.5 | 4.0 | 7.0 | 6.0 | 8.0 | 7.5 |
| 35. | x1 IPU + AN + AC + | 7.0 | 5.5 | 7.0 | 7.0 | 8.0 | 7.0 |
| | SAF + Terpene | | | | | | |
| 36. | x2 IPU + AN + AC + | 7.0 | 5.0 | 6.5 | 6.0 | 7.5 | 7.5 |
| | SAF + Terpene | | | | | | |
| 37. | x3 IPU + AN + AC + | 7.0 | 5.0 | 6.0 | 6.0 | 8.0 | 7.5 |
| | SAF + Terpene | | | | | | |
| 38. | x1 IPU + AN + AC + | 7.0 | 5.5 | 7.0 | 6.0 | 8.0 | 7.5 |
| | Terpene | | | | | | |
| 39. | x2 IPU + AN + AC + | 7.0 | 4.5 | 7.0 | 5.0 | 7.5 | 7.5 |
| | Terpene | | | | | | |
| 40. | x3 IPU + AN + AC + | 7.0 | 4.0 | 6.5 | 5.0 | 8.0 | 8.0 |
| | Terpene | | | | | | |
| 41. | x1 IPU + Terpene | 7.0 | 4.5 | 7.0 | 5.0 | 8.0 | 7.5 |
| 42. | x2 IPU + Terpene | 7.0 | 4.0 | 6.5 | 5.0 | 7.5 | 8.0 |
| 43. | x3 IPU + Terpene | 7.0 | 3.5 | 7.0 | 5.0 | 7.0 | 8.0 |
| 44. | x1 IPU fb (followed by) | 7.0 | 3.5 | 7.0 | 5.0 | 8.0 | 8.0 |
| | AN + AC after 7 Days | | | | | | |
| 45. | x2 IPU fb AN + AC | 7.0 | 3.5 | 7.0 | 4.5 | 8.0 | 8.0 |
| | after 7 Days | | | | | | |
| 46. | x3 IPU fb AN + AC | 7.0 | 3.0 | 6.5 | 4.5 | 8.0 | 8.0 |
| | after 7 Days | | | | | | |
| 47. | x1 IPU fb AN + AC + SAF | 7.0 | 3.5 | 6.5 | 5.0 | 8.0 | 8.0 |
| | after 7 Days | | | | | | |
| 48. | x2 IPU fb AN + AC + SAF | 6.0 | 3.5 | 7.0 | 4.0 | 7.5 | 7.5 |
| | after 7 Days | | | | | | |
| 49. | x3 IPU fb AN + AC + SAF | 6.5 | 3.0 | 6.5 | 4.0 | 7.5 | 8.0 |
| | after 7 Days. | | | | | | |
| 50. | x1 IPU fb AN + AC + SAF + | 6.0 | 4.5 | 7.0 | 5.5 | 8.0 | 7.5 |
| | Terpene after 7 Days | | | | | | |
| 51. | x2 IPU fb AN + AC + SAF + | 6.5 | 4.5 | 7.0 | 4.0 | 8.0 | 7.5 |
| | Terpene after 7 Days | | | | | | |
| 52. | x3 IPU fb AN + AC + SAF + | 6.5 | 4.0 | 6.5 | 4.5 | 8.0 | 7.5 |
| | Terpene after 7 Days | | | | | | |
| 53. | x1 IPU fb SAF after | 7.0 | 4.0 | 7.0 | 5.0 | 8.0 | 8.0 |
| | 7 Days | | | | | | |
| 54. | x2 IPU fb SAF after | 6.5 | 3.0 | 7.0 | 4.0 | 8.0 | 8.0 |
| | 7 Days | | | | | | |
| 55. | x3 IPU fb SAF after | 7.0 | 4.0 | 7.0 | 4.5 | 8.0 | 8.0 |
| | 7 Days | | | | | | |

TABLE 3.5
WINTER WHEAT - CROP SAFENING BENEFITS FROM ADDITION OF SAFENING SYSTEM AND/OR
ANTHRANILIC ACID AND/OR ACETAMINOPHEN TO THE HERBICIDE FLUMIOXAZIN

| | | Phytotoxicity | | Vigour | | Greenness | |
|---|---|---|---|---|---|---|---|
| | | (0-9) (0 = | Phytotoxicity | (0-9) (9 = Most | Vigour | (0-9) (9 = Deeper | Greenness |
| | | Dead) + | (0-9) + | Vigour) + | (0-9) + | Green) + | (0-9) + |
| Treatment | | 14 Days | 28 Days | 14 days | 28 Days | 14 Days | 28 Days |
| 1. | Untreated | 8.0 | 8.0 | 8.0 | 8.0 | 8.0 | 7.5 |
| 2. | AN (Anthranilic Acid) | 9.0 | 8.0 | 9.0 | 8.0 | 8.0 | 8.0 |
| 3. | AC (Acetaminophen) | 8.0 | 8.0 | 8.0 | 8.0 | 8.0 | 8.0 |
| 4. | AN + AC | 8.0 | 8.0 | 8.0 | 8.0 | 8.0 | 8.0 |
| 5. | AN + AC + Terpene | 7.5 | 7.5 | 7.0 | 7.0 | 7.0 | 7.0 |
| 6. | SAF | 8.0 | 8.0 | 8.0 | 8.0 | 8.0 | 8.0 |
| 7. | AN + SAF | 7.5 | 8.0 | 7.5 | 8.0 | 7.0 | 7.5 |
| 8. | AC + SAF | 8.0 | 8.0 | 8.0 | 8.0 | 8.0 | 8.0 |
| 9. | AN + AC + SAF | 7.5 | 8.0 | 7.0 | 7.5 | 8.0 | 8.0 |
| 10. | AN + AC + SAF + | 7.5 | 8.0 | 7.5 | 7.0 | 7.0 | 7.0 |
| | Terpene | | | | | | |
| 11. | 75 ml/ha flumioxazin − | 4.0 | 3.5 | 7.0 | 6.0 | 6.0 | 6.0 |
| | Guillotine (300 g/l) − (x1 | | | | | | |
| | Rate) − Flu x1 | | | | | | |
| 12. | 100 ml/ha Flu x2 | 4.0 | 3.0 | 7.0 | 6.0 | 6.0 | 6.0 |
| 13. | 125 ml/ha Flu x3 | 4.0 | 3.0 | 7.5 | 5.5 | 6.0 | 4.5 |
| 14. | x1 Flu + AN | 3.5 | 3.0 | 6.5 | 6.0 | 6.5 | 5.5 |
| 15. | x2 Flu + AN | 3.5 | 3.0 | 6.5 | 6.0 | 6.5 | 6.0 |
| 16. | x3 Flu + AN | 4.0 | 3.0 | 7.0 | 5.5 | 6.0 | 4.5 |
| 17. | x1 Flu + AC | 4.5 | 3.5 | 7.5 | 6.0 | 6.0 | 5.0 |
| 18. | x2 Flu + AC | 4.5 | 3.0 | 7.0 | 6.0 | 6.0 | 5.0 |
| 19. | x3 Flu + AC | 4.0 | 3.0 | 6.5 | 5.5 | 6.0 | 5.0 |
| 20. | x1 Flu + AN + AC | 5.0 | 4.5 | 7.0 | 6.5 | 7.0 | 6.0 |
| 21. | x2 Flu + AN + AC | 5.0 | 4.0 | 7.0 | 6.5 | 6.5 | 6.0 |
| 22. | x3 Flu + AN + AC | 5.0 | 4.0 | 7.0 | 6.0 | 6.5 | 5.5 |
| 23. | x1 Flu + SAF | 6.0 | 6.0 | 6.5 | 6.5 | 6.5 | 6.5 |
| 24. | x2 Flu + SAF | 6.0 | 6.0 | 6.5 | 7.0 | 6.5 | 6.0 |
| 25. | x3 Flu + SAF | 5.5 | 5.0 | 6.5 | 6.5 | 6.5 | 6.0 |
| 26. | x1 Flu + AN + SAF | 5.5 | 5.5 | 7.0 | 6.5 | 6.5 | 6.5 |
| 27. | x2 Flu + AN + SAF | 5.5 | 6.0 | 7.0 | 7.0 | 6.0 | 6.5 |
| 28. | x3 Flu + AN + SAF | 5.0 | 5.5 | 6.5 | 6.5 | 6.0 | 6.0 |
| 29. | x1 Flu + AC + SAF | 5.0 | 5.0 | 6.5 | 6.5 | 7.0 | 7.0 |
| 30. | x2 Flu + AC + SAF | 5.0 | 5.0 | 6.5 | 6.5 | 6.0 | 6.5 |
| 31. | x3 Flu + AC + SAF | 5.0 | 4.5 | 6.5 | 6.5 | 6.5 | 6.0 |
| 32. | x1 Flu + AN + AC + SAF | 6.0 | 5.0 | 6.5 | 6.5 | 6.0 | 6.5 |
| 33. | x2 Flu + AN + AC + SAF | 6.0 | 5.0 | 6.5 | 6.0 | 6.0 | 7.0 |
| 34. | x3 Flu + AN + AC + SAF | 6.0 | 5.0 | 6.0 | 6.0 | 6.0 | 6.0 |
| 35. | x1 Flu + AN + AC + | 5.0 | 5.0 | 7.0 | 6.0 | 6.0 | 6.0 |
| | SAF + Terpene | | | | | | |
| 36. | x2 Flu + AN + AC + | 5.0 | 5.0 | 7.0 | 5.5 | 7.0 | 6.5 |
| | SAF + Terpene | | | | | | |
| 37. | x3 Flu + AN + AC + | 5.0 | 5.0 | 6.5 | 5.0 | 6.5 | 6.0 |
| | SAF + Terpene | | | | | | |
| 38. | x1 Flu + AN + AC + | 6.0 | 6.0 | 7.5 | 6.5 | 6.0 | 5.5 |
| | Terpene | | | | | | |
| 39. | x2 Flu + AN + AC + | 5.0 | 5.5 | 7.0 | 6.0 | 7.0 | 5.0 |
| | Terpene | | | | | | |
| 40. | x3 Flu + AN + AC + | 5.5 | 5.0 | 7.0 | 6.0 | 7.0 | 5.0 |
| | Terpene | | | | | | |
| 41. | x1 Flu + Terpene | 4.5 | 4.5 | 7.0 | 5.0 | 7.0 | 5.0 |
| 42. | x2 Flu + Terpene | 5.0 | 4.0 | 6.5 | 5.0 | 6.0 | 5.0 |
| 43. | x3 Flu + Terpene | 4.0 | 4.0 | 6.5 | 5.0 | 6.0 | 5.0 |
| 44. | x1 Flu fb (followed by) | 4.5 | 3.5 | 6.5 | 5.5 | 5.5 | 5.0 |
| | AN + AC after 7 Days. | | | | | | |
| 45. | x2 Flu fb AN + AC | 4.5 | 4.0 | 6.5 | 5.0 | 6.0 | 5.5 |
| | after 7 Days | | | | | | |
| 46. | x3 Flu fb AN + AC | 5.0 | 3.5 | 6.0 | 6.0 | 6.0 | 5.0 |
| | after 7 Days | | | | | | |
| 47. | x1 Flu fb AN + AC + SAF | 5.0 | 5.5 | 6.5 | 5.5 | 6.0 | 6.0 |
| | after 7 Days | | | | | | |
| 48. | x2 Flu fb AN + AC + SAF | 5.0 | 5.5 | 6.0 | 6.0 | 6.0 | 6.0 |
| | after 7 Days | | | | | | |
| 49. | x3 Flu fb AN + AC + SAF | 5.5 | 5.5 | 7.0 | 5.5 | 6.0 | 6.0 |
| | after 7 Days. | | | | | | |
| 50. | x1 Flu fb AN + AC + SAF + | 5.5 | 5.0 | 7.0 | 5.0 | 6.0 | 6.5 |
| | Terpene after 7 Days | | | | | | |
| 51. | x2 Flu fb AN + AC + SAF + | 5.5 | 5.0 | 7.0 | 5.0 | 6.0 | 6.0 |
| | Terpene after 7 Days | | | | | | |
| 52. | x3 Flu fb AN + AC + SAF + | 5.5 | 5.0 | 6.0 | 5.0 | 5.0 | 5.5 |
| | Terpene after 7 Days | | | | | | |
| 53. | x1 Flu fb SAF after | 5.0 | 6.0 | 7.0 | 5.0 | 6.0 | 6.0 |
| | 7 Days | | | | | | |
| 54. | x2 Flu fb SAF after | 5.0 | 5.0 | 7.0 | 5.5 | 6.0 | 5.0 |
| | 7 Days | | | | | | |
| 55. | x3 Flu fb SAF after | 4.0 | 4.5 | 7.0 | 6.0 | 5.5 | 5.5 |
| | 7 Days | | | | | | |

As shown in Tables 3.1 to 3.5, each of the safening formulations showed a significant reduction in phytotoxicity when applied to a range of species in combination with an herbicide, when compared to the addition of herbicides alone. Thus the safening systems improve crop safening in a range of species. An increase in vigour and greenness is also noted.

### Example 4

### Safening of Glyphosate Herbicide (non-GM Maize, UK)

Maize cv Sundance (i.e. not Roundup Ready) sown 27 Apr. 2008, to obtain 1 even plant per 1 litre pot, grown in John Innes No 3 compost of pH 6.5. Treated with glyphospate, date of first spraying 15 June. Dates of measurement/scoring: 29 June, 13 July, 26 July.

Statistical Layout: Randomised Complete Block trial, under glasshouse conditions, United Kingdom.
SAF: at least one from class (f) each at <3 g/l, plus at least one from class (c).

Results are shown in Table 4.

Statistical Analyses (Least Significant Difference, 5% Level) for Table 4:

| | Phyto + | Phyto + | Phyto + | Vigour + | Vigour + | Vigour + |
|---|---|---|---|---|---|---|
| | 14 Days | 28 Days | 41 Days | 14 Days | 28 Days | 41 Days |
| LSD | 1.07 | 1.22 | 1.21 | 1.10 | 1.18 | 1.20 |
| (5%) | | | | | | |
| Treat- | | | | | | |
| ment | | | | | | |
| Means | | | | | | |

TABLE 4
MAIZE - CROP SAFENING BENEFITS FROM ADDITION OF SAFENER AND/OR
ANTHRANILIC ACID AND/OR ACETAMINOPHEN TO THE HERBICIDE GLYPHOSATE
(360 g/l formulation).

| | Phytotoxicity | Phytotoxicity | Phytotoxicity | | | |
|---|---|---|---|---|---|---|
| | (0-9) (0 = | (0-9) (0 = | (0-9) (0 = | Vigour | Vigour | Vigour |
| | Dead) + | Dead) + | Dead) + | (0-9) + | (0-9) + | (0-9) + |
| Treatment | 14 Days | 28 Days | 41 days | 14 Days | 28 Days | 41 Days |
| 1. Untreated | 8.0 | 8.0 | 8.0 | 8.0 | 8.0 | 7.5 |
| 2. AN (Anthranilic Acid) | 8.0 | 8.0 | 8.0 | 8.0 | 8.0 | 8.0 |
| 3. AC (Acetaminophen) | 8.0 | 8.0 | 8.0 | 8.0 | 8.0 | 8.0 |
| 4. AN + AC | 8.0 | 8.0 | 8.0 | 8.0 | 8.0 | 8.0 |
| 5. AN + AC + Terpene | 7.5 | 7.5 | 7.5 | 7.0 | 7.0 | 7.0 |
| 6. SAF | 8.0 | 8.0 | 8.0 | 8.0 | 8.0 | 8.0 |
| 7. AN + SAF | 7.5 | 7.5 | 8.0 | 8.0 | 7.0 | 7.5 |
| 8. AC + SAF | 7.5 | 7.5 | 8.0 | 8.0 | 8.0 | 8.0 |
| 9. AN + AC + SAF | 8.0 | 8.0 | 8.0 | 7.5 | 8.0 | 8.0 |
| 10 AN + AC + SAF + | 8.0 | 7.5 | 7.5 | 7.0 | 7.0 | 7.0 |
| Terpene | | | | | | |
| 11 0.5 l/ha Glyphosate 360 | 8.0 | 3.0 | 0.0 | 7.0 | 3.5 | 0.0 |
| (360 g/l) = G-360 below | | | | | | |
| (= “x1” rate) | | | | | | |
| 12 1.0 l/ha G-360 (= “x2” | 8.0 | 3.0 | 0.0 | 7.0 | 3.0 | 0.0 |
| rate) | | | | | | |
| 13 2.0 l/ha G-360 (= “x3” | 8.0 | 3.0 | 0.0 | 7.0 | 3.0 | 0.0 |
| rate) | | | | | | |
| 14 x1 G-360 + AN | 7.5 | 4.0 | 0.0 | 7.0 | 4.5 | 0.0 |
| 15 x2 G-360 + AN | 8.0 | 3.5 | 0.0 | 6.5 | 4.0 | 0.0 |
| 16 x3 G-360 + AN | 8.0 | 4.0 | 0.0 | 7.0 | 4.0 | 0.0 |
| 17 x1 G-360 + AC | 7.5 | 4.0 | 0.0 | 7.0 | 4.5 | 0.0 |
| 18 x2 G-360 + AC | 8.0 | 4.0 | 0.0 | 7.0 | 4.0 | 0.0 |
| 19 x3 G-360 + AC | 8.0 | 4.0 | 0.0 | 7.0 | 4.0 | 0.0 |
| 20 x1 G-360 + AN + AC | 8.0 | 6.0 | 4.0 | 7.0 | 5.5 | 4.0 |
| 21 x2 G-360 + AN + AC | 8.0 | 6.0 | 3.5 | 7.0 | 5.0 | 4.0 |
| 22 x3 G-360 + AN + AC | 8.0 | 6.0 | 3.5 | 7.0 | 5.0 | 3.5 |
| 23 x1 G-360 + SAF | 8.0 | 7.0 | 6.5 | 7.0 | 6.0 | 6.5 |
| 24 x2 G-360 + SAF | 8.0 | 6.5 | 6.5 | 6.5 | 6.0 | 6.0 |
| 25 x3 G-360 + SAF | 8.0 | 7.5 | 6.0 | 7.0 | 6.0 | 5.5 |
| 26 x1 G-360 + AN + SAF | 8.0 | 7.0 | 6.0 | 7.0 | 6.0 | 6.0 |
| 27 x2 G-360 + AN + SAF | 8.0 | 7.0 | 6.0 | 7.0 | 6.0 | 6.0 |
| 28 X3 G-360 + AN + SAF | 8.0 | 7.0 | 5.5 | 7.0 | 6.0 | 5.5 |
| 29 x1 G-360 + AC + SAF | 8.0 | 6.5 | 6.0 | 7.0 | 6.0 | 6.0 |
| 30 x2 G-360 + AC + | 7.5 | 6.5 | 6.0 | 7.0 | 6.0 | 6.0 |
| SAF | | | | | | |
| 31 x3 G-360 + AC + | 7.5 | 6.0 | 6.5 | 7.0 | 6.0 | 6.0 |
| SAF | | | | | | |
| 32 x1 G-360 + AN + AC + | 8.0 | 7.0 | 7.0 | 7.0 | 7.0 | 7.0 |
| SAF | | | | | | |
| 33 x2 G-360 + AN + AC + | 8.0 | 7.0 | 7.0 | 7.0 | 7.0 | 6.5 |
| SAF | | | | | | |
| 34 x3 G-360 + AN + AC + | 8.0 | 7.0 | 6.0 | 7.0 | 7.0 | 6.5 |
| SAF | | | | | | |
| 35 x1 G-360 + AN + AC + | 8.0 | 7.0 | 6.0 | 7.0 | 6.5 | 6.0 |
| SAF + Terpene | | | | | | |
| 36 x2 G-360 + AN + AC + | 8.0 | 7.0 | 6.0 | 7.0 | 6.5 | 6.0 |
| SAF + Terpene | | | | | | |
| 37 x3 G-360 + AN + AC + | 8.0 | 7.0 | 6.0 | 7.0 | 6.5 | 6.0 |
| SAF + Terpene | | | | | | |
| 38 x1 G-360 + AN + AC + | 7.5 | 7.0 | 3.5 | 7.0 | 5.5 | 4.0 |
| Terpene | | | | | | |
| 39 x2 G-360 + AN + AC + | 7.5 | 6.5 | 3.5 | 7.0 | 5.5 | 3.5 |
| Terpene | | | | | | |
| 40 x3 G-360 + AN + AC + | 7.5 | 6.5 | 4.0 | 7.0 | 5.5 | 3.5 |
| Terpene | | | | | | |
| 41 x1 G-360 + Terpene | 8.0 | 6.5 | 0.0 | 7.0 | 5.0 | 0.0 |
| 42 x2 G-360 + Terpene | 8.0 | 6.0 | 0.0 | 7.0 | 5.0 | 0.0 |
| 43 x3 G-360 + Terpene | 8.0 | 5.5 | 0.0 | 7.0 | 4.5 | 0.0 |
| 44 x1 G-360 fb (followed by) | 7.5 | 6.0 | 0.0 | 7.0 | 5.5 | 0.0 |
| AN + AC after 7 Days. | | | | | | |
| 45 x2 G-360 fb AN + AC | 8.0 | 5.5 | 0.0 | 7.0 | 5.0 | 0.0 |
| after 7 Days | | | | | | |
| 46 x3 G-360 fb AN + AC | 8.0 | 5.0 | 0.0 | 7.0 | 5.0 | 0.0 |
| after 7 Days | | | | | | |
| 47 x1 G-360 fb AN + AC + | 7.5 | 5.5 | 5.0 | 7.0 | 5.0 | 5.5 |
| SAF after 7 Days | | | | | | |
| 48 x2 G-360 fb AN + AC + | 8.0 | 5.0 | 5.5 | 7.0 | 5.0 | 5.0 |
| SAF after 7 Days | | | | | | |
| 49 x3 G-360 fb AN + AC + | 7.5 | 5.0 | 5.5 | 7.0 | 5.0 | 5.5 |
| SAF after 7 Days. | | | | | | |
| 50 x1 G-360 fb AN + AC + | 8.0 | 5.5 | 5.5 | 7.0 | 5.0 | 5.0 |
| SAF + Terpene after 7 Days | | | | | | |
| 51 x2 G-360 fb AN + AC + | 8.0 | 6.0 | 5.0 | 7.0 | 5.0 | 5.0 |
| SAF + Terpene after 7 Days | | | | | | |
| 52 x3 G-360 fb AN + AC + | 8.0 | 5.5 | 5.5 | 7.0 | 5.0 | 5.0 |
| SAF + Terpene after 7 Days | | | | | | |
| 53 x1 G-360 fb SAF after 7 | 7.5 | 5.0 | 5.5 | 6.5 | 5.0 | 6.0 |
| Days | | | | | | |
| 54 x2 G-360 fb SAF after 7 | 7.0 | 5.0 | 5.0 | 7.0 | 4.5 | 5.0 |
| Days | | | | | | |
| 55 x3 G-360 fb SAF after 7 | 7.0 | 5.0 | 5.0 | 7.0 | 4.0 | 5.0 |
| Days | | | | | | |

Each of the safening systems used to safen glyphosate showed a reduction in phytotoxicity (measured on a scale of 0-9, where 0=dead and 9=least phytotoxicity). Vigour was also boosted (measured on a scale of 0-9, where 0=least vigour and 9=most vigour).

### Example 5

### Safening of Glyphosate Herbicide (GM Maize, University of Illinois)

Trial Details: Randomised complete block, with four replicates per treatment. Plot size=10 ft×30 ft=300 ft area.

Two varieties Roundup ready soybean (glycine max)—Asgrow 3302 RR/STS and Pioneer 93M42 treated with glyphosate at crop growth stage V4-V5. Glyphosate was applied in the form of Roundup PowerMax, at a rate of 3.0 l/ha. This is a high rate of glyphospate, which was used in order to induce a phytotoxic response.

SAF: at least one from class (f) each at <3 g/l, plus at least one from class (c).

TABLE 5.1
Phytotoxicity and Yield Results Variety A - Asgrow 3302 RR/STS; Application
timing: V4-V5 trifoliate leaf stage.

| | | | | | Mean % | Yield | Mean |
|---|---|---|---|---|---|---|---|
| | | | | | Phyto 21/7 | Bushels | Yield |
| | | % Phyto - | % Phyto - | % Phyto - | (four | Per | (4 |
| Treatment | Rate/Ha | 21/7 | 30/7 | 7/8 | replicates) | Acre | reps) |
| Roundup | 3.00 + | 18 | 3 | 0 | 18.0d | 59.7 | 58.6 |
| PowerMax + | 5.00 | | | | | | |
| Liquid | | | | | | | |
| AMS - R1 | | | | | | | |
| Roundup | 3.00 + | 15 | 3 | 0 | | 61.7 | |
| PowerMax + | 5.00 | | | | | | |
| Liquid | | | | | | | |
| AMS - R2 | | | | | | | |
| Roundup | 3.00 + | 18 | 5 | 0 | | 59.7 | |
| PowerMax + | 5.00 | | | | | | |
| Liquid | | | | | | | |
| AMS - R3 | | | | | | | |
| Roundup | 3.00 + | 20 | 5 | 0 | | 53.4 | |
| PowerMax + | 5.00 | | | | | | |
| Liquid | | | | | | | |
| AMS - R4 | | | | | | | |
| Roundup | 3.00 + | 8 | 0 | 0 | 5.0e | 62.6 | 60.9 |
| PowerMax + | 5.00 + | | | | | | |
| Liquid | 1.00 | | | | | | |
| AMS + | | | | | | | |
| AN + AC - | | | | | | | |
| R1 | | | | | | | |
| Roundup | 3.00 + | 5 | 0 | 0 | | 60.8 | |
| PowerMax + | 5.00 + | | | | | | |
| Liquid | 1.00 | | | | | | |
| AMS + | | | | | | | |
| AN + AC - | | | | | | | |
| R2 | | | | | | | |
| Roundup | 3.00 + | 3 | 0 | 0 | | 52.5 | |
| PowerMax + | 5.00 + | | | | | | |
| Liquid | 1.00 | | | | | | |
| AMS + | | | | | | | |
| AN + AC - | | | | | | | |
| R3 | | | | | | | |
| Roundup | 3.00 + | 3 | 0 | 0 | | 67.7 | |
| PowerMax + | 5.00 + | | | | | | |
| Liquid | 1.00 | | | | | | |
| AMS + | | | | | | | |
| AN + AC - | | | | | | | |
| R4 | | | | | | | |
| Roundup | 3.00 + | 8 | 0 | 0 | 6.0e | 60.0 | 58.3 |
| PowerMax + | 5.00 + | | | | | | |
| Liquid | 1.00 | | | | | | |
| AMS + | | | | | | | |
| AN + AC + | | | | | | | |
| SAF - | | | | | | | |
| R1 | | | | | | | |
| Roundup | 3.00 + | 5 | 0 | 0 | | 50.4 | |
| PowerMax + | 5.00 + | | | | | | |
| Liquid | 1.00 | | | | | | |
| AMS + | | | | | | | |
| AN + AC + | | | | | | | |
| SAF - | | | | | | | |
| R2 | | | | | | | |
| Roundup | 3.00 + | 5 | 0 | 0 | | 51.6 | |
| PowerMax + | 5.00 + | | | | | | |
| Liquid | 1.00 | | | | | | |
| AMS + | | | | | | | |
| AN + AC + | | | | | | | |
| SAF - | | | | | | | |
| R3 | | | | | | | |
| Roundup | 3.00 + | 7 | 0 | 0 | | 71.0 | |
| PowerMax + | 5.00 + | | | | | | |
| Liquid | 1.00 | | | | | | |
| AMS + | | | | | | | |
| AN + AC + | | | | | | | |
| SAF - | | | | | | | |
| R4 | | | | | | | |
| Roundup | 3.00 + | 5 | 0 | 0 | 5.0e | 58.4 | 61.8 |
| PowerMax + | 5.00 + | | | | | | |
| Liquid | 1.00 | | | | | | |
| AMS + | | | | | | | |
| SAF - R1 | | | | | | | |
| Roundup | 3.00 + | 7 | 0 | 0 | | 59.3 | |
| PowerMax + | 5.00 + | | | | | | |
| Liquid | 1.00 | | | | | | |
| AMS + | | | | | | | |
| SAF - R2 | | | | | | | |
| Roundup | 3.00 + | 3 | 0 | 0 | | 60.8 | |
| PowerMax + | 5.00 + | | | | | | |
| Liquid | 1.00 | | | | | | |
| AMS + | | | | | | | |
| SAF - R3 | | | | | | | |
| Roundup | 3.00 + | 5 | 0 | 0 | | 68.6 | |
| PowerMax + | 5.00 + | | | | | | |
| Liquid | 1.00 | | | | | | |
| AMS + | | | | | | | |
| SAF - R4 | | | | | | | |
| Roundup | 3.00 + | 5 | 0 | 0 | 6.0e | 61.0 | 55.1 |
| PowerMax + | 5.00 + | | | | | | |
| Liquid | 1.00 | | | | | | |
| AMS + | | | | | | | |
| AN + AC + | | | | | | | |
| SAF + | | | | | | | |
| POL - R1 | | | | | | | |
| Roundup | 3.00 + | 5 | 0 | 0 | | 55.7 | |
| PowerMax + | 5.00 + | | | | | | |
| Liquid | 1.00 | | | | | | |
| AMS + | | | | | | | |
| AN + AC + | | | | | | | |
| SAF + | | | | | | | |
| POL - R2 | | | | | | | |
| Roundup | 3.00 + | 5 | 0 | 0 | | 53.8 | |
| PowerMax + | 5.00 + | | | | | | |
| Liquid | 1.00 | | | | | | |
| AMS + | | | | | | | |
| AN + AC + | | | | | | | |
| SAF + | | | | | | | |
| POL - R3 | | | | | | | |
| Roundup | 3.00 + | 7 | 3 | 0 | | 49.8 | |
| PowerMax + | 5.00 + | | | | | | |
| Liquid | 1.00 | | | | | | |
| AMS + | | | | | | | |
| AN + AC + | | | | | | | |
| SAF + | | | | | | | |
| POL - R4 | | | | | | | |
| LSD (5%) | | 1.65 | 1.35 | 0.81 | | | 7.00 |
| Means | | | | | | | |
| St Dev | | 0.83 | 0.68 | 0.41 | | | 3.54 |

TABLE 3.2
Phytotoxicity and Yield Results Variety B - Pioneer 93M42. Application timing: V4-V5
trifoliate leaf stage.

| | | | | | Mean % | | |
|---|---|---|---|---|---|---|---|
| | | | | | Phyto | Yield | Mean |
| | | | % | | (four | Bushels | Yield |
| | | % Phyto - | Phyto - | % Phyto - | replicates) - | Per | (4 |
| Treatment | Rate/Ha | 21/7 | 30/7 | 7/8 | 21/7 | Acre | reps) |
| Roundup | 3.00 + | 22 | 3 | 0 | 24.0c | 54.2 | 55.5 |
| PowerMax + | 5.00 | | | | | | |
| Liquid | | | | | | | |
| AMS - R1 | | | | | | | |
| Roundup | 3.00 + | 22 | 5 | 0 | | 55.6 | |
| PowerMax + | 5.00 | | | | | | |
| Liquid | | | | | | | |
| AMS - R2 | | | | | | | |
| Roundup | 3.00 + | 25 | 8 | 0 | | 52.9 | |
| PowerMax + | 5.00 | | | | | | |
| Liquid | | | | | | | |
| AMS - R3 | | | | | | | |
| Roundup | 3.00 + | 28 | 5 | 0 | | 59.4 | |
| PowerMax + | 5.00 | | | | | | |
| Liquid | | | | | | | |
| AMS - R4 | | | | | | | |
| Roundup | 3.00 + | 12 | 3 | 0 | 11.0d | 57.7 | 57.4 |
| PowerMax + | 5.00 + | | | | | | |
| Liquid | 1.00 | | | | | | |
| AMS + | | | | | | | |
| AN + AC - | | | | | | | |
| R1 | | | | | | | |
| Roundup | 3.00 + | 15 | 0 | 0 | | 56.4 | |
| PowerMax + | 5.00 + | | | | | | |
| Liquid | 1.00 | | | | | | |
| AMS + | | | | | | | |
| AN + AC - | | | | | | | |
| R2 | | | | | | | |
| Roundup | 3.00 + | 8 | 3 | 0 | | 59.0 | |
| PowerMax + | 5.00 + | | | | | | |
| Liquid | 1.00 | | | | | | |
| AMS + | | | | | | | |
| AN + AC - | | | | | | | |
| R3 | | | | | | | |
| Roundup | 3.00 + | 8 | 0 | 0 | | 56.4 | |
| PowerMax + | 5.00 + | | | | | | |
| Liquid | 1.00 | | | | | | |
| AMS + | | | | | | | |
| AN + AC - | | | | | | | |
| R4 | | | | | | | |
| Roundup | 3.00 + | 15 | 3 | 0 | 12.0d | 52.2 | 55.2 |
| PowerMax + | 5.00 + | | | | | | |
| Liquid | 1.00 | | | | | | |
| AMS + | | | | | | | |
| AN + AC + | | | | | | | |
| SAF - | | | | | | | |
| R1 | | | | | | | |
| Roundup | 3.00 + | 10 | 0 | 0 | | 55.8 | |
| PowerMax + | 5.00 + | | | | | | |
| Liquid | 1.00 | | | | | | |
| AMS + | | | | | | | |
| AN + AC + | | | | | | | |
| SAF - | | | | | | | |
| R2 | | | | | | | |
| Roundup | 3.00 + | 10 | 0 | 0 | | 53.6 | |
| PowerMax + | 5.00 + | | | | | | |
| Liquid | 1.00 | | | | | | |
| AMS + | | | | | | | |
| AN + AC + | | | | | | | |
| SAF - | | | | | | | |
| R3 | | | | | | | |
| Roundup | 3.00 + | 12 | 3 | 0 | | 59.3 | |
| PowerMax + | 5.00 + | | | | | | |
| Liquid | 1.00 | | | | | | |
| AMS + | | | | | | | |
| AN + AC + | | | | | | | |
| SAF - | | | | | | | |
| R4 | | | | | | | |
| Roundup | 3.00 + | 12 | 3 | 0 | 12.0d | 55.2 | 57.5 |
| PowerMax + | 5.00 + | | | | | | |
| Liquid | 1.00 | | | | | | |
| AMS + | | | | | | | |
| SAF - R1 | | | | | | | |
| Roundup | 3.00 + | 15 | 0 | 0 | | 61.5 | |
| PowerMax + | 5.00 + | | | | | | |
| Liquid | 1.00 | | | | | | |
| AMS + | | | | | | | |
| SAF - R2 | | | | | | | |
| Roundup | 3.00 + | 10 | 0 | 0 | | 56.5 | |
| PowerMax + | 5.00 + | | | | | | |
| Liquid | 1.00 | | | | | | |
| AMS + | | | | | | | |
| SAF - R3 | | | | | | | |
| Roundup | 3.00 + | 10 | 3 | 0 | | 56.6 | |
| PowerMax + | 5.00 + | | | | | | |
| Liquid | 1.00 | | | | | | |
| AMS + | | | | | | | |
| SAF - R4 | | | | | | | |
| Roundup | 3.00 + | 7 | 0 | 0 | 9.0d | 54.2 | 57.3 |
| PowerMax + | 5.00 + | | | | | | |
| Liquid | 1.00 | | | | | | |
| AMS + | | | | | | | |
| AN + AC + | | | | | | | |
| SAF + | | | | | | | |
| POL - R1 | | | | | | | |
| Roundup | 3.00 + | 10 | 0 | 0 | | 56.0 | |
| PowerMax + | 5.00 + | | | | | | |
| Liquid | 1.00 | | | | | | |
| AMS + | | | | | | | |
| AN + AC + | | | | | | | |
| SAF + | | | | | | | |
| POL - R2 | | | | | | | |
| Roundup | 3.00 + | 8 | 0 | 0 | | 60.0 | |
| PowerMax + | 5.00 + | | | | | | |
| Liquid | 1.00 | | | | | | |
| AMS + | | | | | | | |
| AN + AC + | | | | | | | |
| SAF + | | | | | | | |
| POL - R3 | | | | | | | |
| Roundup | 3.00 + | 12 | 5 | 0 | | 59.0 | |
| PowerMax + | 5.00 + | | | | | | |
| Liquid | 1.00 | | | | | | |
| AMS + | | | | | | | |
| AN + AC + | | | | | | | |
| SAF + | | | | | | | |
| POL - R4 | | | | | | | |
| LSD (5%) | | 2.42 | 1.94 | 0.92 | | | 3.66 |
| St Dev | | 1.22 | 1.00 | 0.46 | | | 1.85 |

Each of the safening systems showed a statistically significant reduction in % phytotoxicity (Duncan's Multiple Range Test at 95% probability level: letters which are different between mean values are statistically different). This reduction in % phytotoxicity was seen for each of the two varieties of soybean. Yields were improved as a consequence. No notable difference between the effectiveness of any of the safening systems was evident.

### Example 6

### Safening Oilseed Rape Using a Variety of Safening Systems

Safening systems were applied to crops of oilseed rape and winter wheat treated with various herbicides (Bifenox (with insecticide), Carbetamide, Propaquizafop), either without or without AN and/or AC. The safener/safening system and the herbicide were applied to the crops either simultaneously or sequentially.

Safening compounds were selected from the list of compounds below. The compounds used are highlighted in bold.
(a) Glucose (GL), hydrolysed starch, sucrose (S), fructose (FR), glycerol (G), glyceraldehydes, erythrose, ribulose, xylulose or arabinose or an ester or glycoside or metabolic equivalent of such a carbohydrate;
(b) an organic acid of the Krebs Tricarboxylic Acid Cycle or a metabolic precursor thereof (including citric (C), succinic (SU), malic, pyruvic, acetic and fumaric acids);
(c) a vitamin or coenzyme, eg thiamine (T), riboflavin (R), pyridoxine (P), pyridoxamine, pyridoxal, nicotinamide (N), folic acid (F), ascorbic acid (AA), Biotin (B) and vitamin B12 (B12) or a precursor thereof including nicotinic acid
(d) a purine or pyrimidine nucleoside, nucleotide or a metabolic precursor thereof, eg adenine, adenosine, thymine, thymidine, cytosine, guanine, guanosine, hypoxanthine, uracil, uridine or inosine, to act as structural precursors for nucleic acid synthesis.
(e) a naturally occurring fat or oil including olive, soya, coconut and corn (Oil) oils;
(f) an amino acid of a type that occurs naturally in plant proteins, eg glycine (GLY), alanine (AL), valine, leucine (LE), isoleucine, serine, threonine (THR), cysteine (CY), methionine (ME), aspartic acid, glutamic acid, glutamine (GLU), asparagine (AS), lysine (LY), hydroxylysine, arginine, histidine, phenylalanine, tyrosine, tryptophan, proline, or hydroxyproline.
   Statistical Layout: Randomised Complete Block trial, under glasshouse conditions, United Kingdom.

Statistical Analyses (Least Significant Difference, 5% Level) for Table 6.1:

### Table 6.1:

| | Phyto + | Phyto + | Vigour + 14 | Vigour + 28 | Rooting + 28 |
|---|---|---|---|---|---|
| | 14 Days | 28 Days | Days | Days | Days |
| LSD (5%) | 1.01 | 1.12 | 1.07 | 1.14 | 1.15 |
| Treatment | | | | | |
| Means | | | | | |

TABLE 6.1
OILSEED RAPE - CROP SAFENING BENEFITS FROM ADDITION OF VARIOUS
SAFENING COMPOUNDS FROM CATEGORIES (a) to (f) ABOVE, TO THE
HERBICIDE BIFENOX (with insecticide). EXAMPLES ARE SHOWN WITH AND
WITHOUT ANTHRANILIC ACID/ANTHRANILIC ACID + ACETAMINOPHEN

| | Phytotoxicity | Phytotoxicity | Vigour | Vigour | Rooting |
|---|---|---|---|---|---|
| | (0-9) (0 = | (0-9) (0 = | (0-9) (0 = | (0-9) (0 = | (0-9) (9 = Best |
| | Dead) + | Dead) + | Dead) + | Dead) + | Rooting) + |
| Treatment | 14 Days | 28 Days | 14 days | 28 Days | 28 Days |
| 1. Untreated | 7.5 | 7.5 | 7.5 | 8.0 | 8.0 |
| 2. AN (Anthranilic Acid) | 8.0 | 8.0 | 8.0 | 8.0 | 8.0 |
| 3. AC (Acetaminophen) | 8.0 | 8.0 | 8.0 | 8.0 | 8.0 |
| 4. AN + AC | 8.0 | 8.0 | 8.0 | 8.0 | 8.0 |
| 5. 1.0 l/ha Bifenox (480 g/l) + | 6.0 | 5.0 | 6.0 | 5.5 | 6.0 |
| cypermethrin (rec rate) = | | | | | |
| x1 Bif + C | | | | | |
| 6. 1.5 l/ha Bifenox + x1 | 5.5 | 5.5 | 6.0 | 5.5 | 5.0 |
| cypermethrin = | | | | | |
| x2 Bif + C | | | | | |
| 7. 2.0 l/ha Bifenox + x1 | 5.0 | 4.5 | 5.0 | 4.5 | 4.5 |
| Cypermethrin = x3 Bif + C | | | | | |
| 8. x3 Bif + C + AN | 5.0 | 5.0 | 5.0 | 4.5 | 5.0 |
| 9. x3 Bif + C + AN + AC | 5.5 | 5.5 | 5.5 | 5.0 | 5.5 |
| With added Category (a) | | | | | |
| Safeners (10-33) | | | | | |
| 10 x1 Bif + C + GL | 7.0 | 7.0 | 7.0 | 6.5 | 8.0 |
| 11 x2 Bif + C + GL | 7.0 | 6.5 | 8.0 | 7.0 | 7.0 |
| 12 x3 Bif + C + GL | 6.5 | 6.0 | 7.0 | 6.5 | 7.0 |
| 12 x3 Bif + C + AN + GL | 6.5 | 6.0 | 7.0 | 6.5 | 7.0 |
| 13 x3 Bif + C + AN + AC + | 6.5 | 7.0 | 7.0 | 7.0 | 7.0 |
| GL | | | | | |
| 14 x1 Bif + C + FR | 7.0 | 6.5 | 7.0 | 7.0 | 7.5 |
| 15 x2 Bif + C + FR | 6.5 | 7.0 | 7.5 | 7.0 | 8.0 |
| 16 x3 Bif + C + FR | 6.5 | 7.0 | 7.0 | 6.5 | 7.5 |
| 17 x3 Bif + C + AN + FR | 6.5 | 6.5 | 6.5 | 6.5 | 7.0 |
| 18 x3 Bif + C + AN + AC + | 7.0 | 7.0 | 6.5 | 6.5 | 7.5 |
| FR | | | | | |
| 19 x1 Bif + C + S | 7.0 | 6.5 | 7.0 | 7.0 | 7.5 |
| 20 x2 Bif + C + S | 7.0 | 6.5 | 7.0 | 7.0 | 7.0 |
| 21 x3 Bif + C + S | 7.0 | 7.0 | 7.0 | 6.0 | 7.0 |
| 22 x3 Bif + C + AN + S | 6.5 | 6.5 | 7.0 | 6.0 | 7.0 |
| 23 x3 Bif + C + AN + AC + S | 7.0 | 7.0 | 7.0 | 7.0 | 7.0 |
| 24 x1 Bif + C + G | 7.5 | 7.0 | 6.5 | 6.5 | 7.5 |
| 25 x2 Bif + C + G | 7.5 | 7.0 | 6.5 | 6.5 | 7.5 |
| 26 x3 Bif + C + G | 7.0 | 7.0 | 6.5 | 6.0 | 7.5 |
| 27 x3 Bif + C + AN + G | 7.0 | 7.0 | 6.5 | 6.0 | 7.0 |
| 28 x3 Bif + C + AN + AC + G | 7.5 | 7.5 | 7.0 | 7.0 | 8.0 |
| 29 x1 Bif + C + FR + G | 7.5 | 7.5 | 7.0 | 6.5 | 7.0 |
| 30 x2 Bif + C + FR + G | 7.0 | 7.0 | 7.0 | 6.5 | 7.5 |
| 31 x3 Bif + C + FR + G | 7.0 | 7.0 | 6.5 | 7.0 | 7.5 |
| 32 x3 Bif + C + AN + FR + G | 7.0 | 7.0 | 7.0 | 6.5 | 7.0 |
| 33 x3 Bif + C + AN + AC + | 7.0 | 7.0 | 7.0 | 7.0 | 7.5 |
| FR + G | | | | | |
| With added Category (a) + (b) | | | | | |
| Safeners (34-58) | | | | | |
| 34 x1 Bif + C + GL + SU | 6.5 | 6.5 | 6.5 | 6.0 | 7.0 |
| 35 x2 Bif + C + GL + SU | 6.0 | 6.0 | 6.5 | 6.0 | 6.5 |
| 36 x3 Bif + C + GL + SU | 6.0 | 5.5 | 7.0 | 6.5 | 6.5 |
| 37 x3 Bif + C + AN + | 6.0 | 5.5 | 6.5 | 6.5 | 6.5 |
| GL + SU | | | | | |
| 38 x3 Bif + C + AN + AC + | 7.0 | 6.0 | 7.5 | 6.5 | 7.0 |
| GL + SU | | | | | |
| 39 x1 Bif + C + FR + SU | 7.0 | 6.5 | 6.5 | 6.0 | 7.0 |
| 40 x2 Bif + C + FR + SU | 6.5 | 6.5 | 6.5 | 6.0 | 7.0 |
| 41 x3 Bif + C + FR + SU | 7.0 | 6.5 | 7.0 | 6.5 | 6.5 |
| 42 x3 Bif + C + AN + FR + | 6.5 | 7.0 | 7.0 | 6.5 | 7.0 |
| SU | | | | | |
| 43 x3 Bif + C + AN + AC + | 7.0 | 7.0 | 7.0 | 6.5 | 7.5 |
| FR + SU | | | | | |
| 44 x1 Bif + C + GL + S + C | 7.0 | 7.0 | 7.0 | 7.0 | 7.5 |
| 45 x2 Bif + C + GL + S + C | 6.0 | 7.0 | 6.5 | 6.5 | 7.5 |
| 46 x3 Bif + C + GL + S + C | 6.0 | 6.5 | 7.0 | 6.5 | 7.5 |
| 47 x3 Bif + C + AN + GL + S + C | 6.0 | 6.5 | 6.5 | 6.5 | 7.0 |
| 48 x3 Bif + C + AN + AC + | 6.5 | 7.0 | 7.0 | 7.0 | 7.5 |
| GL + S + C | | | | | |
| 49 x1 Bif + C + GL + C + G | 7.0 | 7.0 | 7.0 | 7.0 | 7.0 |
| 50 x2 Bif + C + GL + C + G | 7.0 | 7.5 | 6.5 | 6.5 | 8.0 |
| 51 x3 Bif + C + GL + C + G | 7.0 | 7.0 | 6.5 | 6.5 | 8.0 |
| 52 x3 Bif + C + AN + GL + C + G | 7.0 | 7.0 | 6.5 | 6.5 | 7.0 |
| 53 x3 Bif + C + AN + AC + | 7.0 | 7.5 | 7.0 | 7.0 | 8.0 |
| GL + C + G | | | | | |
| 54 x1 Bif + C + FR + SU + G | 7.0 | 7.5 | 7.0 | 6.0 | 7.0 |
| 55 x2 Bif + C + FR + SU + G | 7.5 | 7.5 | 7.0 | 6.5 | 7.0 |
| 56 x3 Bif + C + FR + SU + G | 7.0 | 7.0 | 7.0 | 7.0 | 7.5 |
| 57 x3 Bif + C + AN + FR + | 7.0 | 7.0 | 6.5 | 7.0 | 7.0 |
| SU + G | | | | | |
| 58 x3 Bif + C + AN + AC + | 7.5 | 7.5 | 7.0 | 7.0 | 7.5 |
| FR + SU + G | | | | | |
| With added Category (a) + (e) | | | | | |
| Safeners (59-78) | | | | | |
| 59 x1 Bif + C + Oil + GL | 6.5 | 6.5 | 7.0 | 6.5 | 7.0 |
| 60 x2 Bif + C + Oil + GL | 7.0 | 5.5 | 7.0 | 6.5 | 6.0 |
| 61 x3 Bif + C + Oil + GL | 6.0 | 5.0 | 6.0 | 6.5 | 5.0 |
| 62 x3 Bif + C + AN + Oil + | 6.0 | 5.0 | 6.0 | 6.5 | 5.5 |
| GL | | | | | |
| 63 x3 Bif + C + AN + AC + | 6.5 | 6.0 | 6.0 | 7.0 | 6.0 |
| Oil + GL | | | | | |
| 64 x1 Bif + C + Oil + FR | 6.0 | 6.0 | 6.0 | 5.5 | 7.0 |
| 65 x2 Bif + C + Oil + FR | 6.0 | 5.0 | 6.5 | 5.5 | 7.0 |
| 66 x3 Bif + C + Oil + FR | 6.0 | 5.0 | 6.0 | 5.5 | 7.0 |
| 67 x3 Bif + C + AN + Oil + | 6.0 | 5.0 | 6.0 | 5.5 | 6.5 |
| FR | | | | | |
| 68 x3 Bif + C + AN + AC + | 6.5 | 6.0 | 6.0 | 6.0 | 7.0 |
| Oil + FR | | | | | |
| 69 x1 Bif + C + Oil + S | 6.5 | 5.5 | 6.0 | 5.5 | 7.5 |
| 70 x2 Bif + C + Oil + S | 5.5 | 5.0 | 6.0 | 5.0 | 6.0 |
| 71 x3 Bif + C + Oil + S | 5.5 | 5.0 | 5.5 | 4.5 | 5.0 |
| 72 x3 Bif + C + AN + Oil + S | 5.5 | 5.0 | 5.5 | 4.5 | 5.5 |
| 73 x3 Bif + C + AN + AC + | 6.0 | 6.0 | 5.5 | 5.0 | 6.0 |
| Oil + S | | | | | |
| 74 x1 Bif + C + Oil + G | 7.0 | 6.0 | 6.5 | 6.0 | 6.5 |
| 75 x2 Bif + C + Oil + G | 6.5 | 6.5 | 6.5 | 6.0 | 7.5 |
| 76 x3 Bif + C + Oil + G | 7.0 | 6.0 | 7.0 | 6.0 | 7.5 |
| 77 x3 Bif + C + AN + Oil + G | 7.0 | 6.0 | 7.0 | 6.0 | 7.0 |
| 78 x3 Bif + C + AN + AC + | 7.5 | 7.0 | 7.0 | 7.0 | 8.0 |
| Oil + G | | | | | |
| With added Category (a) + (f) | | | | | |
| Safeners (78-83) | | | | | |
| 79 x1 Bif + C + G + GLU | 7.0 | 7.0 | 7.0 | 7.0 | 7.5 |
| 80 x2 Bif + C + G + GLU | 7.0 | 7.0 | 7.0 | 7.0 | 7.5 |
| 81 x3 Bif + C + G + GLU | 7.0 | 7.0 | 7.0 | 6.5 | 7.5 |
| 82 x3 Bif + C + AN + | 7.0 | 7.0 | 7.0 | 7.0 | 7.0 |
| G + GLU | | | | | |
| 83 x3 Bif + C + AN + AC + | 7.0 | 7.5 | 7.0 | 7.0 | 8.0 |
| G + GLU | | | | | |
| With added Category (a) + (b) + | | | | | |
| (f) Safeners (84-93) | | | | | |
| 84 x1 Bif + C + GL + SU + | 7.0 | 6.5 | 7.0 | 7.0 | 6.5 |
| AS | | | | | |
| 85 x2 Bif + C + GL + SU + | 7.0 | 7.0 | 6.5 | 6.0 | 7.0 |
| AS | | | | | |
| 86 x3 Bif + C + GL + SU + | 6.0 | 6.5 | 6.5 | 6.0 | 7.0 |
| AS | | | | | |
| 87 x3 Bif + C + AN + GL + | 6.0 | 6.5 | 6.5 | 6.0 | 7.0 |
| SU + AS | | | | | |
| 88 x3 Bif + C + AN + AC + | 6.0 | 7.0 | 7.0 | 6.5 | 7.0 |
| GL + SU + AS | | | | | |
| 89 x1 Bif + C + S + C + AS | 7.0 | 6.0 | 7.0 | 6.0 | 7.5 |
| 90 x2 Bif + C + S + C + AS | 6.5 | 6.0 | 7.0 | 6.5 | 7.0 |
| 91 x3 Bif + C + S + C + AS | 7.0 | 5.5 | 6.5 | 6.0 | 7.0 |
| 92 x3 Bif + C + AN + S + C + | 7.0 | 5.5 | 6.5 | 6.5 | 7.0 |
| AS | | | | | |
| 93 x3 Bif + C + AN + AC + | 7.0 | 6.0 | 7.0 | 6.5 | 7.5 |
| S + C + AS | | | | | |
| With added Category (c) | | | | | |
| Safeners (94-153) | | | | | |
| 94 x1 Bif + C + AA + B12 | 7.0 | 7.0 | 7.5 | 7.0 | 7.0 |
| 95 x2 Bif + C + AA + B12 | 6.5 | 7.0 | 7.0 | 7.0 | 7.5 |
| 96 x3 Bif + C + AA + B12 | 7.0 | 6.5 | 7.0 | 6.5 | 7.0 |
| 97 x3 Bif + C + AN + AA + | 7.0 | 7.0 | 7.0 | 7.0 | 7.0 |
| B12 | | | | | |
| 98 x3 Bif + C + AN + AC + | 7.5 | 7.5 | 7.5 | 7.0 | 8.0 |
| AA + B12 | | | | | |
| 99 x1 Bif + C + AA + B12 + B | 6.5 | 6.5 | 7.0 | 6.5 | 8.0 |
| 100 x2 Bif + C + AA + B12 + B | 6.5 | 6.5 | 7.5 | 6.5 | 8.0 |
| 101 x3 Bif + C + AA + B12 + B | 7.0 | 7.0 | 7.0 | 7.0 | 7.0 |
| 102 x3 Bif + C + AN + AA + | 7.0 | 7.0 | 7.0 | 7.0 | 7.0 |
| B12 + B | | | | | |
| 103 x3 Bif + C + AN + AC + | 7.0 | 7.5 | 7.0 | 7.5 | 8.0 |
| AA + B12 + B | | | | | |
| 104 x1 Bif + C + AA + B12 + | 6.5 | 7.0 | 7.0 | 7.0 | 7.5 |
| B + R | | | | | |
| 105 x2 Bif + C + AA + B12 + | 6.0 | 7.0 | 7.0 | 6.5 | 7.5 |
| B + R | | | | | |
| 106 x3 Bif + C + AA + B12 + | 6.5 | 7.0 | 7.0 | 7.0 | 7.5 |
| B + R | | | | | |
| 107 x3 Bif + C + AN + AA + | 6.0 | 7.0 | 7.0 | 7.0 | 7.5 |
| B12 + B + R | | | | | |
| 108 x3 Bif + C + AN + AC + | 7.0 | 7.0 | 7.0 | 7.0 | 7.5 |
| AA + B12 + B + R | | | | | |
| 109 x1 Bif + C + AA + B12 + | 7.0 | 7.0 | 7.0 | 7.0 | 8.0 |
| B + R + T | | | | | |
| 110 x2 Bif + C + AA + B12 + | 6.5 | 6.0 | 7.0 | 7.0 | 7.5 |
| B + R + T | | | | | |
| 111 x3 Bif + C + AA + B12 + | 6.5 | 6.5 | 7.0 | 6.5 | 8.0 |
| B + R + T | | | | | |
| 112 x3 Bif + C + AN + AA + | 6.5 | 6.5 | 7.0 | 7.0 | 8.0 |
| B12 + B + R + T | | | | | |
| 113 x3 Bif + C + AN + AC + | 7.0 | 7.0 | 7.0 | 7.5 | 8.0 |
| AA + B12 + B + R + T | | | | | |
| 114 x1 Bif + C + AA + B12 + | 7.0 | 6.5 | 7.0 | 6.5 | 7.0 |
| B + R + T + F | | | | | |
| 115 x2 Bif + C + AA + B12 + | 6.0 | 7.0 | 7.0 | 6.5 | 7.5 |
| B + R + T + F | | | | | |
| 116 x3 Bif + C + AA + B12 + | 7.0 | 7.0 | 7.0 | 7.0 | 8.0 |
| B + R + T + F | | | | | |
| 117 x3 Bif + C + AN + AA + | 7.0 | 7.0 | 6.5 | 7.0 | 7.5 |
| B12 + B + R + T + F | | | | | |
| 118 x3 Bif + C + AN + AC + | 7.0 | 7.5 | 7.0 | 7.5 | 8.0 |
| AA + B12 + B + R + T + F | | | | | |
| 119 x1 Bif + C + AA + B12 + | 7.0 | 7.0 | 7.0 | 6.5 | 7.0 |
| B + R + T + F + N | | | | | |
| 120 x2 Bif + C + AA + B12 + | 7.0 | 7.0 | 7.0 | 7.0 | 7.0 |
| B + R + T + F + N | | | | | |
| 121 x3 Bif + C + AA + B12 + | 7.0 | 6.5 | 7.0 | 7.0 | 7.5 |
| B + R + T + F + N | | | | | |
| 122 x3 Bif + C + AN + AA + | 6.5 | 6.5 | 7.0 | 7.0 | 7.5 |
| B12 + B + R + T + F + N | | | | | |
| 123 x3 Bif + C + AN + AC + | 7.0 | 7.0 | 7.0 | 7.5 | 8.0 |
| AA + B12 + B + R + T + | | | | | |
| F + N | | | | | |
| 124 x1 Bif + C + AA + B12 + | 7.0 | 6.5 | 6.5 | 6.5 | 8.0 |
| B + R + T + F + P | | | | | |
| 125 x2 Bif + C + AA + B12 + | 7.0 | 7.0 | 7.0 | 7.0 | 7.0 |
| B + R + T + F + P | | | | | |
| 126 x3 Bif + C + AA + B12 + | 7.0 | 7.0 | 6.5 | 6.0 | 6.5 |
| B + R + T + F + P | | | | | |
| 127 x3 Bif + C + AN + AA + | 7.0 | 7.0 | 6.5 | 6.0 | 6.5 |
| B12 + B + R + T + F + P | | | | | |
| 128 x3 Bif + C + AN + AC + | 7.0 | 7.0 | 7.0 | 6.5 | 7.5 |
| AA + B12 + B + R + T + | | | | | |
| F + P | | | | | |
| 129 x1 Bif + C + AA + B12 + | 6.0 | 5.5 | 6.5 | 6.5 | 7.0 |
| B + R + T | | | | | |
| 130 x2 Bif + C + AA + B12 + | 6.0 | 6.0 | 6.5 | 6.5 | 7.0 |
| B + R + T | | | | | |
| 131 x3 Bif + C + AA + B12 + | 5.5 | 5.5 | 6.5 | 6.5 | 7.0 |
| B + R + T | | | | | |
| 132 x3 Bif + C + AN + AA + | 5.5 | 5.5 | 6.0 | 6.5 | 7.0 |
| B12 + B + R + T | | | | | |
| 133 x3 Bif + C + AN + AC + | 6.0 | 6.0 | 6.5 | 7.0 | 7.0 |
| AA + B12 + B + R + T | | | | | |
| 134 x1 Bif + C + N + P + F | 6.5 | 6.5 | 7.5 | 7.0 | 7.5 |
| 135 x2 Bif + C + N + P + F | 6.5 | 6.5 | 7.0 | 6.5 | 7.0 |
| 136 x3 Bif + C + N + P + F | 7.0 | 7.0 | 7.5 | 7.0 | 7.0 |
| 137 x3 Bif + C + AN + N + P + F | 7.0 | 7.0 | 7.0 | 7.0 | 7.0 |
| 138 x3 Bif + C + AN + AC + | 7.0 | 7.5 | 7.5 | 7.5 | 8.0 |
| N + P + F | | | | | |
| 139 x1 Bif + C + N + P + F + T | 7.0 | 6.0 | 7.0 | 6.0 | 6.5 |
| 140 x2 Bif + C + N + P + F + T | 6.5 | 6.0 | 7.0 | 7.0 | 7.5 |
| 141 x3 Bif + C + N + P + F + T | 6.5 | 6.5 | 7.0 | 7.0 | 7.5 |
| 142 x3 Bif + C + AN + N + P + | 6.5 | 6.5 | 7.0 | 7.0 | 7.0 |
| F + T | | | | | |
| 143 x3 Bif + C + AN + AC + | 7.0 | 7.0 | 7.0 | 7.5 | 8.0 |
| N + P + F + T | | | | | |
| 144 x1 Bif + C + N + P + F + | 6.5 | 6.0 | 7.0 | 6.5 | 7.0 |
| T + R | | | | | |
| 145 x2 Bif + C + N + P + F + | 6.5 | 6.5 | 7.0 | 6.5 | 7.0 |
| T + R | | | | | |
| 146 x3 Bif + C + N + P + F + | 7.0 | 6.5 | 7.0 | 6.5 | 7.0 |
| T + R | | | | | |
| 147 x3 Bif + C + AN + N + P + | 6.5 | 7.0 | 7.0 | 6.5 | 7.0 |
| F + T + R | | | | | |
| 148 x3 Bif + C + AN + AC + | 7.0 | 7.0 | 7.0 | 7.0 | 7.5 |
| N + P + F + T + R | | | | | |
| 149 x1 Bif + C + N + P + F + | 6.0 | 6.0 | 7.0 | 6.0 | 7.5 |
| T + R + AA | | | | | |
| 150 x2 Bif + C + N + P + F + | 6.0 | 7.0 | 7.0 | 6.5 | 7.0 |
| T + R + AA | | | | | |
| 151 x3 Bif + C + N + P + F + | 6.0 | 6.0 | 7.0 | 6.5 | 8.0 |
| T + R + AA | | | | | |
| 152 x3 Bif + C + AN + N + P + | 6.0 | 6.0 | 6.5 | 6.5 | 7.5 |
| F + T + R + AA | | | | | |
| 153 x3 Bif + C + AN + AC + | 6.0 | 6.5 | 7.0 | 7.0 | 8.0 |
| N + P + F + T + R + AA | | | | | |
| With added Category (f) | | | | | |
| Safeners (154-198) | | | | | |
| 154 x1 Bif + C + LE + ME | 8.0 | 7.5 | 7.0 | 6.0 | 7.0 |
| 155 x2 Bif + C + LE + ME | 7.5 | 7.0 | 7.0 | 6.5 | 7.0 |
| 156 x3 Bif + C + LE + ME | 7.5 | 7.0 | 7.0 | 6.0 | 7.5 |
| 157 x3 Bif + C + AN + LE + | 7.0 | 7.0 | 7.0 | 6.0 | 7.5 |
| ME | | | | | |
| 158 x3 Bif + C + AN + AC + | 8.0 | 7.5 | 7.0 | 7.0 | 8.0 |
| LE + ME | | | | | |
| 159 x1 Bif + C + GLY + LY | 7.5 | 7.0 | 7.0 | 6.5 | 7.0 |
| 160 x2 Bif + C + GLY + LY | 7.0 | 6.5 | 7.0 | 7.0 | 8.0 |
| 161 x3 Bif + C + GLY + LY | 7.0 | 7.0 | 7.0 | 7.0 | 7.0 |
| 162 x3 Bif + C + AN + GLY + | 7.0 | 7.0 | 7.0 | 7.0 | 7.0 |
| LY | | | | | |
| 163 x3 Bif + C + AN + AC + | 7.0 | 7.5 | 7.0 | 7.5 | 8.0 |
| GLY + LY | | | | | |
| 164 x1 Bif + C + LE + GLU + | 7.0 | 7.0 | 6.5 | 7.0 | 7.5 |
| AL + THR | | | | | |
| 165 x2 Bif + C + LE + GLU + | 7.0 | 7.0 | 7.0 | 6.5 | 7.5 |
| AL + THR | | | | | |
| 166 x3 Bif + C + LE + GLU + | 7.0 | 7.0 | 7.0 | 7.0 | 8.0 |
| AL + THR | | | | | |
| 167 x3 Bif + C + AN + GLU + | 7.0 | 7.0 | 7.0 | 6.5 | 7.5 |
| AL + THR | | | | | |
| 168 x3 Bif + C + AN + AC + | 7.0 | 7.0 | 7.0 | 7.5 | 8.0 |
| GLU + AL + THR | | | | | |
| 169 x1 Bif + C + AS + ME + | 7.5 | 7.0 | 6.5 | 6.0 | 8.0 |
| CY | | | | | |
| 170 x2 Bif + C + AS + ME + | 7.5 | 7.5 | 7.0 | 7.0 | 7.5 |
| CY | | | | | |
| 171 x3 Bif + C + AS + ME + | 7.0 | 7.0 | 7.0 | 7.0 | 7.5 |
| CY | | | | | |
| 172 x3 Bif + C + AN + AS + | 7.0 | 7.0 | 7.0 | 7.0 | 7.0 |
| ME + CY | | | | | |
| 173 x3 Bif + C + AN + AC + | 7.5 | 7.5 | 7.5 | 7.5 | 8.0 |
| AS + ME + CY | | | | | |
| 174 x1 Bif + C + ME + CY + | 6.5 | 6.0 | 6.0 | 6.0 | 6.5 |
| GLU | | | | | |
| 175 x2 Bif + C + ME + CY + | 6.5 | 6.0 | 6.5 | 6.5 | 6.5 |
| GLU | | | | | |
| 176 x3 Bif + C + ME + CY + | 6.0 | 6.0 | 6.5 | 6.5 | 6.5 |
| GLU | | | | | |
| 177 x3 Bif + C + AN + ME + | 6.0 | 6.0 | 6.5 | 6.5 | 6.5 |
| CY + GLU | | | | | |
| 178 x3 Bif + C + AN + AC + | 6.0 | 6.5 | 6.5 | 6.5 | 7.0 |
| ME + CY + GLU | | | | | |
| 179 x1 Bif + C + LE + GLU + | 6.5 | 6.5 | 7.0 | 7.0 | 7.0 |
| AL + THR + AS | | | | | |
| 180 x2 Bif + C + LE + GLU + | 6.5 | 6.5 | 7.0 | 6.5 | 7.0 |
| AL + THR + AS | | | | | |
| 181 x3 Bif + C + LE + GLU + | 6.0 | 6.5 | 6.5 | 6.5 | 7.5 |
| AL + THR + AS | | | | | |
| 182 x3 Bif + C + AN + LE + | 6.0 | 6.5 | 7.0 | 6.5 | 7.0 |
| GLU + AL + THR + AS | | | | | |
| 183 x3 Bif + C + AN + AC + | 6.5 | 6.5 | 6.5 | 6.5 | 7.5 |
| LE + GLU + AL + THR + | | | | | |
| AS | | | | | |
| 184 x1 Bif + C + LE + GLU + | 6.5 | 6.5 | 7.0 | 7.0 | 6.5 |
| AL + THR + AS + N + P | | | | | |
| 185 x2 Bif + C + LE + GLU + | 6.5 | 6.0 | 6.5 | 6.5 | 7.0 |
| AL + THR + AS + N + P | | | | | |
| 186 x3 Bif + C + LE + GLU + | 7.0 | 6.0 | 6.5 | 7.0 | 6.5 |
| AL + THR + AS + N + P | | | | | |
| 187 x3 Bif + C + AN + LE + | 6.5 | 6.5 | 6.5 | 7.0 | 6.5 |
| GLU + AL + THR + AS + | | | | | |
| N + P | | | | | |
| 188 x3 Bif + C + AN + AC + | 7.0 | 7.0 | 7.0 | 7.5 | 7.0 |
| LE + GLU + AL + THR + | | | | | |
| AS + N + P | | | | | |
| 189 x1 Bif + C + LE + GLU + | 7.5 | 7.0 | 7.0 | 7.0 | 7.0 |
| AL + THR + LY | | | | | |
| 190 x2 Bif + C + LE + GLU + | 7.0 | 7.0 | 7.5 | 6.5 | 7.5 |
| AL + THR + LY | | | | | |
| 191 x3 Bif + C + LE + GLU + | 7.0 | 6.5 | 7.0 | 7.0 | 7.5 |
| AL + THR + LY | | | | | |
| 192 x3 Bif + C + AN + LE + | 7.0 | 7.0 | 7.0 | 7.0 | 7.5 |
| GLU + AL + THR + LY | | | | | |
| 193 x3 Bif + C + AN + AC + | 7.0 | 7.0 | 7.0 | 7.0 | 7.5 |
| LE + GLU + AL + THR + | | | | | |
| LY | | | | | |
| 194 x1 Bif + C + LE + CY + | 6.0 | 5.5 | 6.0 | 6.5 | 7.0 |
| ME + GLU + GLY + | | | | | |
| AL + THR + LY + AS | | | | | |
| 195 x2 Bif + C + LE + CY + | 5.5 | 5.5 | 6.5 | 6.5 | 7.0 |
| ME + GLU + GLY + | | | | | |
| AL + THR + LY + AS | | | | | |
| 196 x3 Bif + C + LE + CY + | 5.5 | 5.0 | 6.5 | 6.5 | 6.5 |
| ME + GLU + GLY + | | | | | |
| AL + THR + LY + AS | | | | | |
| 197 x3 Bif + C + AN + LE + | 5.5 | 5.5 | 6.5 | 6.5 | 6.5 |
| CY + ME + GLU + | | | | | |
| GLY + AL + THR + | | | | | |
| LY + AS | | | | | |
| 198 x3 Bif + C + AN + AC + | 6.0 | 6.0 | 6.5 | 7.0 | 7.0 |
| LE + CY + ME + GLU + | | | | | |
| GLY + AL + THR + | | | | | |
| LY + AS | | | | | |
| With added Category (c) + (f) | | | | | |
| Safeners (199-223) | | | | | |
| 199 x1 Bif + ME + CY + | 6.0 | 6.0 | 7.0 | 6.5 | 8.0 |
| GLU + F | | | | | |
| 200 x2 Bif + C + ME + CY + | 6.5 | 6.5 | 6.5 | 7.0 | 7.0 |
| GLU + F | | | | | |
| 201 x3 Bif + C + ME + CY + | 6.5 | 7.0 | 6.5 | 7.0 | 7.5 |
| GLU + F | | | | | |
| 202 x3 Bif + C + AN + ME + | 6.5 | 6.5 | 6.5 | 7.0 | 7.5 |
| CY + GLU + F | | | | | |
| 203 x3 Bif + C + AN + AC + | 6.5 | 7.0 | 7.0 | 7.0 | 8.0 |
| ME + CY + GLU + F | | | | | |
| 204 x1 Bif + ME + CY + | 7.0 | 6.0 | 6.0 | 6.0 | 6.5 |
| GLU + F + N | | | | | |
| 205 x2 Bif + C + ME + CY + | 6.5 | 6.5 | 6.5 | 6.5 | 7.0 |
| GLU + F + N | | | | | |
| 206 x3 Bif + C + ME + CY + | 6.5 | 7.0 | 6.5 | 6.5 | 7.0 |
| GLU + F + N | | | | | |
| 207 x3 Bif + C + AN + ME + | 6.5 | 7.0 | 6.5 | 6.5 | 7.0 |
| CY + GLU + F + N | | | | | |
| 208 x3 Bif + C + AN + AC + | 7.0 | 7.0 | 6.5 | 7.0 | 7.0 |
| ME + CY + GLU + F + N | | | | | |
| 209 x1 Bif + ME + CY + | 6.5 | 6.0 | 7.0 | 6.5 | 7.0 |
| GLU + F + N + P | | | | | |
| 210 x2 Bif + C + ME + CY + | 6.0 | 6.0 | 6.5 | 6.5 | 6.5 |
| GLU + F + N + P | | | | | |
| 211 x3 Bif + C + ME + CY + | 6.5 | 6.5 | 7.0 | 6.0 | 6.5 |
| GLU + F + N + P | | | | | |
| 212 x3 Bif + C + AN + ME + | 6.5 | 6.0 | 6.5 | 6.0 | 6.5 |
| CY + GLU + F + N + P | | | | | |
| 213 x3 Bif + C + AN + AC + | 6.5 | 7.0 | 6.5 | 6.5 | 7.0 |
| ME + CY + GLU + F + | | | | | |
| N + P | | | | | |
| 214 x1 Bif + C + ME + CY + | 6.5 | 7.0 | 7.0 | 6.5 | 7.0 |
| GLU + F + P | | | | | |
| 215 x2 Bif + C + ME + CY + | 7.0 | 7.0 | 7.0 | 6.5 | 7.0 |
| GLU + F + P | | | | | |
| 216 x3 Bif + C + ME + CY + | 6.5 | 6.5 | 7.0 | 6.5 | 7.0 |
| GLU + F + P | | | | | |
| 217 x3 Bif + C + AN + ME + | 6.5 | 6.5 | 6.5 | 6.5 | 7.0 |
| CY + GLU + F + P | | | | | |
| 218 x3 Bif + C + AN + AC + | 6.5 | 7.0 | 7.0 | 7.0 | 7.5 |
| ME + CY + GLU + F + P | | | | | |
| 219 x1 Bif + C + LE + AA + | 6.5 | 5.5 | 6.5 | 5.5 | 7.0 |
| B12 | | | | | |
| 220 x2 Bif + C + LE + AA + | 6.0 | 5.5 | 6.5 | 5.5 | 6.5 |
| B12 | | | | | |
| 221 x3 Bif + C + LE + AA + | 5.5 | 5.0 | 7.0 | 6.0 | 6.0 |
| B12 | | | | | |
| 222 x3 Bif + C + AN + LE + | 5.5 | 5.5 | 6.5 | 6.5 | 6.0 |
| AA + B12 | | | | | |
| 223 x3 Bif + C + AN + AC + | 6.0 | 6.0 | 6.5 | 6.5 | 7.0 |
| LE + AA + B12 | | | | | |
| With added Category (a) + (c) | | | | | |
| Safeners (224-238) | | | | | |
| 224 x1 Bif + C + S + N + P | 6.5 | 7.0 | 7.0 | 7.0 | 7.0 |
| 225 x2 Bif + C + S + N + P | 6.5 | 7.0 | 7.0 | 6.5 | 8.0 |
| 226 x3 Bif + C + S + N + P | 6.5 | 7.0 | 7.0 | 7.0 | 8.0 |
| 227 x3 Bif + C + + AN + S + | 6.5 | 7.0 | 6.5 | 7.0 | 8.0 |
| N + P | | | | | |
| 228 x3 Bif + C + AN + AC + | 7.0 | 7.5 | 7.5 | 7.0 | 8.0 |
| S + N + P | | | | | |
| 229 x1 Bif + C + F + N + P | 7.0 | 6.0 | 7.0 | 7.0 | 8.0 |
| 230 x2 Bif + C + F + N + P | 7.0 | 6.0 | 7.0 | 6.5 | 8.0 |
| 231 x3 Bif + C + F + N + P | 6.5 | 6.5 | 7.0 | 6.5 | 7.0 |
| 232 x3 Bif + C + + AN + F + | 6.5 | 6.0 | 7.0 | 6.5 | 8.0 |
| N + P | | | | | |
| 233 x3 Bif + C + AN + AC + | 7.0 | 7.0 | 7.0 | 7.0 | 8.0 |
| F + N + P | | | | | |
| 234 x1 Bif + C + G + N + P | 7.0 | 6.5 | 7.5 | 6.5 | 7.5 |
| 235 x2 Bif + C + G + N + P | 7.0 | 7.0 | 7.0 | 7.0 | 7.5 |
| 236 x3 Bif + C + G + N + P | 7.0 | 7.0 | 7.0 | 7.0 | 7.5 |
| 237 x3 Bif + C + + AN + G + | 7.0 | 7.0 | 7.0 | 7.0 | 7.5 |
| N + P | | | | | |
| 238 x3 Bif + C + AN + AC + | 7.0 | 7.0 | 7.0 | 7.0 | 8.0 |
| G + N + P | | | | | |
| With added Category (a), (c) | | | | | |
| and (e) Safeners (239-248) | | | | | |
| 239 x1 Bif + C + Oil + N + P + G | 6.5 | 6.0 | 7.0 | 6.5 | 7.0 |
| 240 x2 Bif + C + Oil + N + P + G | 7.0 | 6.5 | 6.0 | 6.5 | 7.5 |
| 241 x3 Bif + C + Oil + N + P + G | 7.0 | 6.5 | 7.0 | 6.5 | 7.0 |
| 242 x3 Bif + C + + AN + Oil + | 6.5 | 7.0 | 7.0 | 6.5 | 7.0 |
| N + P + G | | | | | |
| 243 x3 Bif + C + AN + AC + | 7.0 | 7.0 | 7.0 | 7.0 | 7.5 |
| Oil + N + P + G | | | | | |
| 244 x1 Bif + C + Oil + T + R + G | 6.5 | 6.5 | 6.5 | 6.5 | 7.5 |
| 245 x2 Bif + C + Oil + T + R + G | 6.5 | 6.5 | 6.5 | 6.5 | 8.0 |
| 246 x3 Bif + C + Oil + T + R + G | 7.0 | 7.0 | 6.5 | 6.0 | 7.0 |
| 247 x3 Bif + C + + AN + Oil + | 7.0 | 7.0 | 6.5 | 6.5 | 7.5 |
| T + R + G | | | | | |
| 248 x3 Bif + C + AN + AC + | 7.0 | 7.5 | 7.0 | 7.0 | 8.0 |
| Oil + T + R + G | | | | | |
| With added Category (c) + (e) | | | | | |
| Safeners (249-263) | | | | | |
| 249 x1 Bif + C + Oil + F + T + R | 7.0 | 7.0 | 7.0 | 7.0 | 7.0 |
| 250 x2 Bif + C + Oil + F + T + R | 7.0 | 7.0 | 7.0 | 6.5 | 7.5 |
| 251 x3 Bif + C + Oil + F + T + R | 6.5 | 6.0 | 7.0 | 6.5 | 7.5 |
| 252 x3 Bif + C + + AN + Oil + | 6.5 | 6.5 | 7.0 | 6.5 | 7.5 |
| F + T + R | | | | | |
| 253 x3 Bif + C + AN + AC + | 6.5 | 7.0 | 7.0 | 7.0 | 8.0 |
| Oil + F + T + R | | | | | |
| 254 x1 Bif + C + Oil + AA + | 6.5 | 7.0 | 6.0 | 6.5 | 7.5 |
| B + B12 | | | | | |
| 255 x2 Bif + C + Oil + AA + | 6.5 | 6.5 | 6.5 | 6.5 | 7.0 |
| B + B12 | | | | | |
| 256 x3 Bif + C + Oil + AA + | 7.0 | 6.5 | 7.0 | 6.5 | 7.0 |
| B + B12 | | | | | |
| 257 x3 Bif + C + + AN + Oil | 6.5 | 6.5 | 6.5 | 6.5 | 7.0 |
| AA + B + B12 | | | | | |
| 258 x3 Bif + C + AN + AC + | 7.0 | 7.0 | 7.0 | 7.0 | 7.5 |
| AA + B + B12 | | | | | |
| 259 x1 Bif + C + Oil + AA + + | 6.0 | 5.5 | 6.0 | 7.0 | 7.0 |
| B12 | | | | | |
| 260 x2 Bif + C + Oil + AA + + | 6.0 | 5.5 | 6.0 | 7.0 | 7.0 |
| B12 | | | | | |
| 261 x3 Bif + C + Oil + AA + + | 6.0 | 5.5 | 6.0 | 5.5 | 7.5 |
| B12 | | | | | |
| 262 x3 Bif + C + + AN + Oil | 6.0 | 5.5 | 6.0 | 6.0 | 7.0 |
| AA + B12 | | | | | |
| 263 x3 Bif + C + AN + AC + | 6.0 | 5.5 | 6.0 | 5.5 | 7.0 |
| AA + B12 | | | | | |
| With added Category (a) + (c) + | | | | | |
| (e) + (f) Safeners (264-268) | | | | | |
| 264 x1 Bif + C + Oil + ME + | 7.0 | 6.5 | 6.0 | 6.5 | 7.0 |
| G + R + N | | | | | |
| 265 x2 Bif + C + Oil + ME + | 6.5 | 6.5 | 6.0 | 6.0 | 7.0 |
| G + R + N | | | | | |
| 266 x3 Bif + C + Oil + ME + | 6.5 | 7.0 | 6.5 | 6.0 | 7.5 |
| G + R + N | | | | | |
| 267 x3 Bif + C + + AN + Oil + | 6.5 | 7.0 | 6.5 | 6.0 | 7.0 |
| ME + G + R + N | | | | | |
| 268 x3 Bif + C + AN + AC + | 6.5 | 7.0 | 7.0 | 6.5 | 7.5 |
| ME + G + R + N | | | | | |

TABLE 6.2
OILSEED RAPE - CROP SAFENING BENEFITS FROM ADDITION OF
VARIOUS SAFENING COMPOUNDS FROM CATEGORIES (a) to (f)
ABOVE, TO THE HERBICIDE CARBETAMIDE (60% w/w) + PROPAQUIZAFOP
(100 g/l). EXAMPLES ARE SHOWN WITH AND WITHOUT ANTHRANILIC
ACID/ANTHRANILIC ACID + ACETAMINOPHEN.

| | Phytotoxicity | | Vigour | Vigour | Rooting |
|---|---|---|---|---|---|
| | (0-9) (0 = | Phytotoxicity | (0-9) (0 = | (0-9) (0 = | (0-9) (9 = |
| | Dead) + | (0-9) (0 = | Dead) + | Dead) + | Best |
| | 14 | Dead) + | 14 | 28 | Rooting) + |
| Treatment | Days | 28 Days | days | Days | 28 Days |
| 1. Untreated | 7.5 | 7.5 | 7.5 | 8.0 | 8.0 |
| 2. AN | 8.0 | 8.0 | 8.0 | 8.0 | 8.0 |
| 3. AC | 8.0 | 8.0 | 8.0 | 8.0 | 8.0 |
| 4. AN + AC | 8.0 | 8.0 | 8.0 | 8.0 | 8.0 |
| 5. 2.5 kg/ha | 6.0 | 5.0 | 6.0 | 5.0 | 6.0 |
| Carbetamide + | | | | | |
| 0.5 l/ha | | | | | |
| Propaquizafop = | | | | | |
| x1 Car + Prop | | | | | |
| 6. 3.5 kg/ha | 5.5 | 5.0 | 5.0 | 4.5 | 5.0 |
| Carbetamide + | | | | | |
| 0.7 l/ha | | | | | |
| Propaquizafop = | | | | | |
| x2 Car + Prop | | | | | |
| 7. 4.5 kg/ha | 5.5 | 4.0 | 5.0 | 4.0 | 4.5 |
| Carbetamide + | | | | | |
| 0.8 l/ha | | | | | |
| Propaquizafop = | | | | | |
| x3 Car + Prop | | | | | |
| 8. x3 Car + Prop + | 5.5 | 4.0 | 5.0 | 4.0 | 4.5 |
| AN | | | | | |
| 9. x3 Car + Prop + | 5.5 | 4.0 | 5.0 | 4.5 | 5.0 |
| AN + AC | | | | | |
| With added | | | | | |
| Category (a) | | | | | |
| Safeners (10-33) | | | | | |
| 10 x1 Car + Prop + | 6.5 | 6.5 | 7.5 | 7.0 | 7.5 |
| GL | | | | | |
| 11 x2 Car + Prop + | 7.0 | 7.0 | 6.5 | 7.0 | 7.0 |
| GL | | | | | |
| 12 x3 Car + Prop + | 6.5 | 6.5 | 6.5 | 6.0 | 7.0 |
| GL | | | | | |
| 12 x3 Car + Prop | 6.5 | 7.0 | 6.5 | 6.5 | 7.0 |
| AN + GL | | | | | |
| 13 x3 Car + Prop + | 7.0 | 7.0 | 6.5 | 7.0 | 7.0 |
| AN + AC + | | | | | |
| GL | | | | | |
| 14 x1 Car + Prop + | 6.5 | 6.5 | 6.5 | 6.5 | 7.5 |
| FR | | | | | |
| 15 x2 Car + Prop + | 6.0 | 6.0 | 6.5 | 6.0 | 7.0 |
| FR | | | | | |
| 16 x3 Car + Prop + | 7.0 | 6.5 | 6.5 | 6.5 | 6.5 |
| FR | | | | | |
| 17 x3 Car + Prop + | 6.5 | 6.5 | 6.5 | 6.5 | 7.0 |
| AN + FR | | | | | |
| 18 x3 Car + Prop + | 7.0 | 7.0 | 6.5 | 6.5 | 7.0 |
| AN + AC + FR | | | | | |
| 19 x1 Car + Prop + S | 6.5 | 6.5 | 6.5 | 6.5 | 6.5 |
| 20 x2 Car + Prop + S | 6.0 | 6.5 | 6.5 | 6.0 | 7.0 |
| 21 x3 Car + Prop + S | 6.5 | 7.0 | 6.5 | 6.5 | 7.0 |
| 22 x3 Car + Prop + | 6.5 | 6.5 | 6.5 | 6.5 | 7.0 |
| AN + S | | | | | |
| 23 x3 Car + Prop + | 6.5 | 7.0 | 6.5 | 6.5 | 7.0 |
| AN + AC + S | | | | | |
| 24 x1 Car + Prop G | 6.5 | 6.5 | 6.5 | 6.5 | 7.0 |
| 25 x2 Car + Prop + G | 6.5 | 6.5 | 6.5 | 6.5 | 7.0 |
| 26 x3 Car + Prop + G | 6.5 | 6.0 | 6.5 | 6.5 | 7.0 |
| 27 x3 Car + Prop + | 6.5 | 6.5 | 6.5 | 6.5 | 7.0 |
| AN + G | | | | | |
| 28 x3 Car + Prop + | 7.0 | 7.0 | 7.0 | 7.0 | 7.5 |
| AN + AC + G | | | | | |
| 29 x1 Car + Prop + | 6.0 | 6.0 | 6.0 | 6.0 | 6.5 |
| FR + G | | | | | |
| 30 x2 Car + Prop + | 6.5 | 6.5 | 6.5 | 6.5 | 7.0 |
| FR + G | | | | | |
| 31 x3 Car + Prop + | 6.5 | 6.0 | 6.5 | 6.5 | 7.0 |
| FR + G | | | | | |
| 32 x3 Car + Prop + | 6.5 | 6.5 | 6.0 | 6.5 | 7.0 |
| AN + FR + G | | | | | |
| 33 x3 Car + Prop + | 7.0 | 7.0 | 7.0 | 7.0 | 7.5 |
| AN + AC + FR + G | | | | | |
| With added | | | | | |
| Category (a) + | | | | | |
| (b) Safeners (34-58) | | | | | |
| 34 x1 Car + Prop + | 6.5 | 6.5 | 6.5 | 6.5 | 7.0 |
| GL + SU | | | | | |
| 35 x2 Car + Prop + | 7.0 | 7.0 | 6.0 | 6.0 | 6.5 |
| GL + SU | | | | | |
| 36 x3 Car + Prop + | 6.5 | 6.0 | 6.5 | 6.0 | 6.5 |
| GL + SU | | | | | |
| 37 x3 Car + Prop | 6.5 | 6.5 | 6.5 | 6.0 | 6.5 |
| AN + GL + SU | | | | | |
| 38 x3 Car + Prop + | 6.5 | 6.5 | 6.5 | 6.5 | 7.0 |
| AN + AC + GL + | | | | | |
| SU | | | | | |
| 39 x1 Car + Prop + | 6.5 | 6.5 | 7.0 | 7.0 | 6.0 |
| FR + SU | | | | | |
| 40 x2 Car + Prop + | 6.0 | 6.0 | 6.0 | 6.0 | 6.5 |
| FR + SU | | | | | |
| 41 x3 Car + Prop + | 6.0 | 6.0 | 6.5 | 6.5 | 7.0 |
| FR + SU | | | | | |
| 42 x3 Car + Prop + | 6.0 | 6.0 | 6.5 | 6.5 | 7.0 |
| AN + FR + SU | | | | | |
| 43 x3 Car + Prop + | 6.0 | 6.5 | 6.5 | 7.0 | 7.0 |
| AN + AC + FR + | | | | | |
| SU | | | | | |
| 44 x1 Car + Prop + | 7.0 | 7.0 | 6.5 | 6.5 | 7.0 |
| GL + S + C | | | | | |
| 45 x2 Car + Prop + | 6.5 | 6.5 | 6.5 | 6.5 | 6.5 |
| GL + S + C | | | | | |
| 46 x3 Car + Prop | 6.0 | 6.0 | 6.5 | 6.5 | 6.5 |
| GL + S + C | | | | | |
| 47 x3 Car + Prop + | 6.0 | 6.0 | 6.0 | 6.5 | 6.5 |
| AN + GL + S + C | | | | | |
| 48 x3 Car + Prop + | 6.0 | 6.0 | 6.5 | 6.5 | 6.5 |
| AN + AC + GL + | | | | | |
| S + C | | | | | |
| 49 x1 Car + Prop + | 6.5 | 6.5 | 6.5 | 6.0 | 7.5 |
| GL + C + G | | | | | |
| x2 Car + Prop + | 6.0 | 6.0 | 6.5 | 6.5 | 6.5 |
| GL + C + G | | | | | |
| 51 x3 Car + Prop + | 6.5 | 7.0 | 6.5 | 6.0 | 6.5 |
| GL + C + G | | | | | |
| 52 x3 Car + Prop | 6.5 | 7.0 | 6.5 | 6.5 | 6.5 |
| AN + GL + C + G | | | | | |
| 53 x3 Car + Prop + | 7.0 | 7.5 | 7.0 | 7.0 | 7.0 |
| AN + AC + | | | | | |
| GL + C + G | | | | | |
| 54 x1 Car + Prop + | 6.5 | 7.0 | 6.5 | 7.0 | 7.0 |
| FR + SU + G | | | | | |
| 55 x2 Car + Prop + | 6.5 | 6.5 | 7.0 | 6.5 | 7.0 |
| FR + SU + G | | | | | |
| 56 x3 Car + Prop + | 6.0 | 6.0 | 6.5 | 6.0 | 7.0 |
| FR + SU + G | | | | | |
| 57 x3 Car + Prop + | 6.0 | 6.0 | 6.5 | 6.5 | 7.0 |
| AN + FR + SU + G | | | | | |
| 58 x3 Car + Prop + | 6.5 | 7.0 | 6.5 | 7.0 | 7.5 |
| AN + AC + FR + | | | | | |
| SU + G | | | | | |
| With added | | | | | |
| Category (a) + (e) | | | | | |
| Safeners (59-78) | | | | | |
| 59 x1 Car + Prop + | 5.5 | 5.0 | 5.5 | 5.0 | 7.0 |
| Oil + GL | | | | | |
| 60 x2 Car + Prop + | 6.0 | 5.0 | 5.0 | 4.0 | 6.0 |
| Oil + GL | | | | | |
| 61 x3 Car + Prop + | 5.0 | 4.5 | 4.5 | 4.0 | 6.0 |
| Oil + GL | | | | | |
| 62 x3 Car + Prop + | 5.0 | 4.5 | 4.5 | 4.0 | 6.0 |
| AN + Oil + GL | | | | | |
| 63 x3 Car + Prop + | 5.0 | 5.0 | 5.0 | 4.5 | 6.0 |
| AN + AC + Oil + | | | | | |
| GL | | | | | |
| 64 x1 Car + Prop + | 7.0 | 7.0 | 7.0 | 7.0 | 7.5 |
| Oil + FR | | | | | |
| 65 x2 Car + Prop + | 6.0 | 6.0 | 7.0 | 6.5 | 7.0 |
| Oil + FR | | | | | |
| 66 x3 Car + Prop + | 6.5 | 6.0 | 7.0 | 6.5 | 7.0 |
| Oil + FR | | | | | |
| 67 x3 Car + Prop + | 6.5 | 6.0 | 7.0 | 6.5 | 7.0 |
| AN + Oil + FR | | | | | |
| 68 x3 Car + Prop + | 6.5 | 6.5 | 7.0 | 7.0 | 7.5 |
| AN + AC + Oil + | | | | | |
| FR | | | | | |
| 69 x1 Car + Prop | 6.5 | 6.0 | 5.5 | 5.0 | 6.0 |
| Oil + S | | | | | |
| 70 x2 Car + Prop + | 5.5 | 4.5 | 5.0 | 4.5 | 5.5 |
| Oil + S | | | | | |
| 71 x3 Car + Prop + | 6.5 | 4.0 | 4.5 | 4.0 | 5.5 |
| Oil + S | | | | | |
| 72 x3 Car + Prop + | 6.5 | 4.5 | 4.5 | 4.0 | 5.5 |
| AN + Oil + S | | | | | |
| 73 x3 Car + Prop + | 6.5 | 4.5 | 4.5 | 4.0 | 5.5 |
| AN + AC + Oil + S | | | | | |
| 74 x1 Car + Prop + | 6.5 | 6.5 | 7.0 | 7.0 | 6.5 |
| Oil + G | | | | | |
| 75 x2 Car + Prop + | 7.0 | 6.0 | 7.0 | 7.0 | 7.0 |
| Oil + G | | | | | |
| 76 x3 Car + Prop + | 6.5 | 6.0 | 6.5 | 6.5 | 6.0 |
| Oil + G | | | | | |
| 77 x3 Car + Prop + | 6.5 | 6.5 | 6.5 | 7.0 | 6.0 |
| AN + Oil + G | | | | | |
| 78 x3 Car + Prop + | 7.0 | 7.0 | 7.0 | 7.0 | 7.0 |
| AN + AC + Oil + G | | | | | |
| With added | | | | | |
| Category (a) + (f) | | | | | |
| Safeners (79-83) | | | | | |
| 79 x1 Car + Prop + | 6.0 | 6.0 | 6.0 | 6.0 | 6.5 |
| G + GL | | | | | |
| 80 x2 Car + Prop + | 6.5 | 6.5 | 6.5 | 6.5 | 6.5 |
| G + GL | | | | | |
| 81 x3 Car + Prop + | 6.0 | 6.0 | 6.5 | 6.0 | 6.5 |
| G + GL | | | | | |
| 82 x3 Car + Prop + | 6.0 | 6.0 | 6.5 | 6.5 | 7.0 |
| AN + G + GL | | | | | |
| 83 x3 Car + Prop + | 6.5 | 7.0 | 6.5 | 6.5 | 7.0 |
| AN + AC + G + | | | | | |
| GL | | | | | |
| With added | | | | | |
| Category (a) + | | | | | |
| (b) + (f) Safeners | | | | | |
| (84-93) | | | | | |
| 84 x1 Car + Prop + | 6.5 | 6.5 | 6.0 | 7.0 | 7.0 |
| GL + SU + AS | | | | | |
| 85 x2 Car + Prop + | 7.0 | 6.0 | 7.0 | 6.0 | 7.0 |
| GL + SU + AS | | | | | |
| 86 x3 Car + Prop + | 6.5 | 6.0 | 6.5 | 6.0 | 7.0 |
| GL + SU + AS | | | | | |
| 87 x3 Car + Prop + | 6.5 | 6.5 | 6.5 | 6.5 | 7.0 |
| AN + GL + SU + | | | | | |
| AS | | | | | |
| 88 x3 Car + Prop + | 7.0 | 6.5 | 6.5 | 6.5 | 7.0 |
| AN + AC + GL + | | | | | |
| SU + AS | | | | | |
| 89 x1 Car + Prop + | 7.0 | 7.0 | 6.0 | 6.5 | 7.0 |
| S + C + AS | | | | | |
| 90 x2 Car + Prop + | 7.0 | 7.0 | 6.5 | 6.0 | 6.5 |
| S + C + AS | | | | | |
| 91 x3 Car + Prop + | 6.5 | 6.5 | 6.5 | 6.0 | 7.0 |
| S + C + AS | | | | | |
| 92 x3 Car + Prop + | 6.5 | 6.5 | 6.5 | 6.0 | 7.0 |
| AN + S + C + | | | | | |
| AS | | | | | |
| 93 x3 Car + Prop + | 7.0 | 6.5 | 6.5 | 6.5 | 7.0 |
| AN + AC + S + | | | | | |
| C + AS | | | | | |
| With added | | | | | |
| Category (c) | | | | | |
| Safeners (94-153) | | | | | |
| 94 x1 Car + Prop + | 7.0 | 7.0 | 7.0 | 7.0 | 7.0 |
| AA + B12 | | | | | |
| 95 x2 Car + Prop + | 7.0 | 7.0 | 7.5 | 6.5 | 7.0 |
| AA + B12 | | | | | |
| 96 x3 Car + Prop + | 7.0 | 7.0 | 6.5 | 7.0 | 6.0 |
| AA + B12 | | | | | |
| 97 x3 Car + Prop + | 7.0 | 7.0 | 7.0 | 7.0 | 7.0 |
| AN + AA + | | | | | |
| B12 | | | | | |
| 98 x3 Car + Prop + | 7.5 | 7.5 | 7.0 | 7.5 | 7.5 |
| AN + AC + | | | | | |
| AA + B12 | | | | | |
| 99 x1 Car + Prop + | 6.5 | 6.5 | 7.0 | 6.0 | 7.0 |
| AA + B12 + B | | | | | |
| 100 x2 Car + | 7.0 | 7.0 | 7.0 | 7.0 | 7.0 |
| Prop + AA + B12 + B | | | | | |
| 101 x3 Car + | 7.0 | 6.5 | 7.0 | 6.0 | 7.0 |
| Prop + AA + B12 + B | | | | | |
| 102 x3 Car + | 7.0 | 7.0 | 7.0 | 6.5 | 7.0 |
| Prop + AN + AA + | | | | | |
| B12 + B | | | | | |
| 103 x3 Car + | 7.0 | 7.5 | 7.0 | 7.0 | 7.5 |
| Prop + AN + AC + | | | | | |
| AA + B12 + B | | | | | |
| 104 x1 Car + | 6.5 | 6.5 | 6.5 | 6.5 | 7.0 |
| Prop AA + B12 + | | | | | |
| B + R | | | | | |
| 105 x2 Car + | 6.0 | 6.5 | 6.5 | 7.0 | 7.0 |
| Prop + AA + B12 + | | | | | |
| B + R | | | | | |
| 106 x3 Car + | 6.5 | 6.5 | 6.0 | 6.5 | 6.0 |
| Prop + AA + B12 + | | | | | |
| B + R | | | | | |
| 107 x3 Car + | 6.5 | 6.5 | 6.0 | 6.5 | 6.0 |
| Prop + AN + AA + | | | | | |
| B12 + B + R | | | | | |
| 108 x3 Car + | 6.5 | 6.5 | 6.5 | 6.5 | 6.5 |
| Prop + AN + AC + | | | | | |
| AA + B12 + B + R | | | | | |
| 109 x1 Car + | 6.5 | 6.5 | 6.5 | 7.0 | 6.5 |
| Prop + AA + B12 + | | | | | |
| B + R + T | | | | | |
| 110 x2 Car + | 6.0 | 6.5 | 7.0 | 6.5 | 6.5 |
| Prop + AA + B12 + | | | | | |
| B + R + T | | | | | |
| 111 x3 Car + | 6.5 | 6.5 | 6.5 | 6.5 | 7.0 |
| Prop + AA + B12 + | | | | | |
| B + R + T | | | | | |
| 112 x3 Car + Prop + | 6.0 | 6.5 | 6.5 | 6.5 | 6.5 |
| AN + AA + | | | | | |
| B12 + B + R + T | | | | | |
| 113 x3 Car + | 6.5 | 7.0 | 7.0 | 7.0 | 7.5 |
| Prop + AN + AC + | | | | | |
| AA + B12 + B + | | | | | |
| R + T | | | | | |
| 114 x1 Car + | 6.5 | 6.0 | 7.0 | 6.0 | 6.5 |
| Prop + AA + B12 + | | | | | |
| B + R + T + F | | | | | |
| 115 x2 Car + | 7.0 | 6.0 | 6.5 | 6.5 | 7.0 |
| Prop + AA + B12 + | | | | | |
| B + R + T + F | | | | | |
| 116 x3 Car + | 6.5 | 6.5 | 6.5 | 6.0 | 7.0 |
| Prop + AA + B12 + | | | | | |
| B + R + T + F | | | | | |
| 117 x3 Car + | 6.0 | 6.5 | 6.5 | 6.5 | 6.5 |
| Prop + AN + AA + | | | | | |
| B12 + B + R + | | | | | |
| T + F | | | | | |
| 118 x3 Car + | 7.0 | 6.5 | 6.5 | 6.5 | 7.0 |
| Prop + AN + AC + | | | | | |
| AA + B12 + B + | | | | | |
| R + T + F | | | | | |
| 119 x1 Car + Prop + | 7.0 | 6.5 | 6.5 | 6.5 | 7.0 |
| AA + B12 + B + | | | | | |
| R + T + F + N | | | | | |
| 120 x2 Car + Prop + | 6.0 | 6.0 | 7.0 | 7.0 | 7.0 |
| AA + B12 + B + | | | | | |
| R + T + F + N | | | | | |
| 121 x3 Car + Prop + | 6.5 | 7.5 | 7.0 | 7.0 | 6.5 |
| AA + B12 + B + | | | | | |
| R + T + F + N | | | | | |
| 122 x3 Car + Prop + | 6.5 | 7.0 | 7.0 | 7.0 | 6.5 |
| AN + AA + | | | | | |
| B12 + B + R + T + | | | | | |
| F + N | | | | | |
| 123 x3 Car + | 7.0 | 7.5 | 7.0 | 7.0 | 7.5 |
| Prop + AN + AC + | | | | | |
| AA + B12 + B + | | | | | |
| R + T + F + N | | | | | |
| 124 x1 Car + Prop + | 6.0 | 6.5 | 7.0 | 7.0 | 6.5 |
| AA + B12 + B + | | | | | |
| R + T + F + P | | | | | |
| 125 x2 Car + Prop + | 6.5 | 7.0 | 6.0 | 6.0 | 6.0 |
| AA + B12 + B + | | | | | |
| R + T + F + P | | | | | |
| 126 x3 Car + Prop + | 7.0 | 6.0 | 6.5 | 5.5 | 6.5 |
| AA + B12 + B + | | | | | |
| R + T + F + P | | | | | |
| 127 x3 Car + Prop + | 6.5 | 6.5 | 6.0 | 6.0 | 6.5 |
| AN + AA + | | | | | |
| B12 + B + R + T + | | | | | |
| F + P | | | | | |
| 128 x3 Car + Prop + | 6.5 | 6.5 | 6.5 | 7.0 | 7.0 |
| AN + AC + AA + | | | | | |
| B12 + B + R + | | | | | |
| T + F + P | | | | | |
| 129 x1 Car + Prop + | 6.5 | 6.5 | 6.5 | 7.0 | 6.5 |
| AA + B12 + B + | | | | | |
| R + T | | | | | |
| 130 x2 Car + | 6.0 | 6.5 | 7.0 | 6.5 | 6.5 |
| Prop + AA + B12 + | | | | | |
| B + R + T | | | | | |
| 131 x3 Car + | 6.5 | 6.5 | 6.5 | 6.5 | 7.0 |
| Prop + AA + B12 + | | | | | |
| B + R + T | | | | | |
| 132 x3 Car + Prop + | 6.5 | 6.5 | 6.5 | 6.5 | 6.5 |
| AN + AA + | | | | | |
| B12 + B + R + T | | | | | |
| 133 x3 Car + | 6.5 | 7.0 | 6.5 | 7.0 | 7.5 |
| Prop + AN + AC + | | | | | |
| AA + B12 + B + | | | | | |
| R + T | | | | | |
| 134 x1 Car + | 6.0 | 6.5 | 6.5 | 6.5 | 7.0 |
| Prop + N + P + F | | | | | |
| 135 x2 Car + | 6.0 | 6.0 | 6.5 | 6.5 | 7.0 |
| Prop + N + P + F | | | | | |
| 136 x3 Car + | 7.0 | 6.0 | 6.0 | 7.0 | 6.5 |
| Prop + N + P + F | | | | | |
| 137 x3 Car + | 6.5 | 6.0 | 6.0 | 7.0 | 7.0 |
| Prop + AN + N + | | | | | |
| P + F | | | | | |
| 138 x3 Car + | 7.0 | 7.0 | 7.0 | 7.5 | 7.5 |
| Prop + AN + | | | | | |
| AC + N + P + F | | | | | |
| 139 x1 Car + Prop + | 6.5 | 6.5 | 7.0 | 7.0 | 6.5 |
| N + P + F + T | | | | | |
| 140 x2 Car + Prop + | 6.5 | 6.5 | 7.0 | 7.0 | 7.0 |
| N + P + F + T | | | | | |
| 141 x3 Car + Prop + | 6.0 | 6.0 | 6.0 | 6.0 | 6.0 |
| N + P + F + T | | | | | |
| 142 x3 Car + Prop + | 6.0 | 6.5 | 6.0 | 6.0 | 6.0 |
| AN + N + P + F + T | | | | | |
| 143 x3 Car + | 6.5 | 6.5 | 6.0 | 6.5 | 7.0 |
| Prop + AN + AC + | | | | | |
| N + P + F + T | | | | | |
| 144 x1 Car + | 6.5 | 6.5 | 7.0 | 6.5 | 7.0 |
| Prop + N + P + F + | | | | | |
| T + R | | | | | |
| 145 x2 Car + | 6.5 | 6.5 | 7.0 | 7.0 | 7.0 |
| Prop + N + P + F + | | | | | |
| T + R | | | | | |
| 146 x3 Car + | 6.0 | 6.0 | 7.0 | 5.5 | 7.0 |
| Prop + N + P + F + | | | | | |
| T + R | | | | | |
| 147 x3 Car + | 6.0 | 6.0 | 6.5 | 6.0 | 7.0 |
| Prop + AN + N + | | | | | |
| P + F + T + R | | | | | |
| 148 x3 Car + Prop + | 6.5 | 7.0 | 7.0 | 7.0 | 7.5 |
| AN + AC + N + | | | | | |
| P + F + T + R | | | | | |
| 149 x1 Car + Prop + | 7.0 | 6.5 | 6.5 | 6.5 | 7.0 |
| N + P + F + T + | | | | | |
| R + AA | | | | | |
| 150 x2 Car + | 6.0 | 6.0 | 7.0 | 7.0 | 7.0 |
| Prop + N + P + | | | | | |
| F + T + R + AA | | | | | |
| 151 x3 Car + | 6.5 | 7.5 | 7.0 | 7.0 | 6.5 |
| Prop + N + P + | | | | | |
| F + T + R + AA | | | | | |
| 152 x3 Car + Prop + | 6.0 | 7.0 | 7.0 | 7.0 | 7.0 |
| AN + N + P + | | | | | |
| F + T + R + AA | | | | | |
| 153 x3 Car + | 7.0 | 8.0 | 7.5 | 7.0 | 7.5 |
| Prop + AN + AC + | | | | | |
| N + P + F + T + | | | | | |
| R + AA | | | | | |
| With added | | | | | |
| Category (f) | | | | | |
| Safeners (154-198) | | | | | |
| 154 x1 Car + | 6.5 | 6.5 | 7.0 | 6.5 | 7.0 |
| Prop + LE + ME | | | | | |
| 155 x2 Car + | 6.5 | 6.5 | 7.5 | 6.5 | 7.5 |
| Prop + LE + ME | | | | | |
| 156 x3 Car + | 6.5 | 7.0 | 6.5 | 6.5 | 7.0 |
| Prop + LE + ME | | | | | |
| 157 x3 Car + | 6.5 | 6.5 | 6.5 | 6.5 | 6.5 |
| Prop + AN + LE + | | | | | |
| ME | | | | | |
| 158 x3 Car + | 7.0 | 7..0 | 7.0 | 7.0 | 7.5 |
| Prop + AN + AC + | | | | | |
| LE + ME | | | | | |
| 159 x1 Car + Prop + | 6.0 | 6.5 | 6.5 | 6.0 | 7.0 |
| GLY + LY | | | | | |
| 160 x2 Car + Prop + | 6.5 | 6.5 | 6.5 | 6.0 | 7.0 |
| GLY + LY | | | | | |
| 161 x3 Car + Prop + | 6.5 | 7.0 | 6.5 | 6.0 | 7.0 |
| GLY + LY | | | | | |
| 162 x3 Car + | 6.5 | 6.5 | 6.5 | 6.5 | 7.0 |
| Prop + AN + | | | | | |
| GLY + LY | | | | | |
| 163 x3 Car + | 7.0 | 7.0 | 7.0 | 7.0 | 7.5 |
| Prop + AN + AC + | | | | | |
| GLY + LY | | | | | |
| 164 x1 Car + Prop + | 6.5 | 6.5 | 6.0 | 6.5 | 7.0 |
| LE + GLU + | | | | | |
| AL + THR | | | | | |
| 165 x2 Car + Prop + | 6.5 | 6.5 | 6.5 | 6.5 | 6.5 |
| LE + GLU + | | | | | |
| AL + THR | | | | | |
| 166 x3 Car + Prop + | 7.0 | 6.5 | 6.0 | 6.5 | 7.0 |
| LE + GLU + | | | | | |
| AL + THR | | | | | |
| 167 x3 Car + Prop + | 6.5 | 7.0 | 6.0 | 6.5 | 7.0 |
| AN + GLU + | | | | | |
| AL + THR | | | | | |
| 168 x3 Car + Prop + | 7.0 | 7.0 | 6.5 | 6.5 | 7.0 |
| AN + AC + GLU + | | | | | |
| AL + THR | | | | | |
| 169 x1 Car + Prop + | 6.5 | 6.5 | 7.0 | 6.5 | 7.0 |
| AS + ME + CY | | | | | |
| 170 x2 Car + Prop + | 6.0 | 6.0 | 6.0 | 6.0 | 6.5 |
| AS + ME + CY | | | | | |
| 171 x3 Car + Prop + | 6.0 | 6.0 | 7.0 | 6.0 | 8.0 |
| AS + ME + CY | | | | | |
| 172 x3 Car + | 6.0 | 6.0 | 6.5 | 6.5 | 7.0 |
| Prop + AN + | | | | | |
| AS + ME + CY | | | | | |
| 173 x3 Car + | 6.5 | 7.0 | 7.0 | 7.0 | 7.5 |
| Prop + AN + AC + | | | | | |
| AS + ME + CY | | | | | |
| 174 x1 Car + Prop + | 7.0 | 7.0 | 6.0 | 6.0 | 7.0 |
| ME + CY + | | | | | |
| GLU | | | | | |
| 175 x2 Car + Prop + | 6.0 | 6.0 | 6.0 | 6.5 | 7.0 |
| ME + CY + | | | | | |
| GLU | | | | | |
| 176 x3 Car + Prop + | 6.5 | 6.5 | 6.5 | 7.0 | 6.5 |
| ME + CY + | | | | | |
| GLU | | | | | |
| 177 x3 Car + | 6.5 | 6.0 | 6.5 | 7.0 | 7.0 |
| Prop + AN + ME + | | | | | |
| CY + GLU | | | | | |
| 178 x3 Car + | 7.0 | 7.0 | 6.5 | 7.0 | 7.0 |
| Prop + AN + AC + | | | | | |
| ME + CY + | | | | | |
| GLU | | | | | |
| 179 x1 Car + | 6.0 | 6.5 | 6.5 | 6.5 | 6.5 |
| Prop + LE + | | | | | |
| GLU + AL + | | | | | |
| THR + AS | | | | | |
| 180 x2 Car + | 6.0 | 6.0 | 6.5 | 6.0 | 6.5 |
| Prop + LE + | | | | | |
| GLU + AL + | | | | | |
| THR + AS | | | | | |
| 181 x3 Car + | 6.5 | 5.5 | 6.0 | 5.5 | 6.5 |
| Prop + LE + | | | | | |
| GLU + AL + | | | | | |
| THR + AS | | | | | |
| 182 x3 Car + | 6.0 | 6.0 | 6.0 | 5.5 | 6.5 |
| Prop + AN + LE + | | | | | |
| GLU + AL + | | | | | |
| THR + AS | | | | | |
| 183 x3 Car + | 6.5 | 6.5 | 6.0 | 6.0 | 7.0 |
| Prop + AN + AC + | | | | | |
| LE + GLU + | | | | | |
| AL + THR + AS | | | | | |
| 184 x1 Car + | 7.0 | 7.0 | 6.0 | 6.5 | 6.0 |
| Prop + LE + GLU + | | | | | |
| AL + THR + | | | | | |
| AS + N + P | | | | | |
| 185 x2 Car + Prop + | 6.5 | 6.5 | 6.5 | 6.5 | 6.0 |
| LE + GLU + | | | | | |
| AL + THR + | | | | | |
| AS + N + P | | | | | |
| 186 x3 Car + Prop + | 6.0 | 6.0 | 7.0 | 6.5 | 6.5 |
| LE + GLU + | | | | | |
| AL + THR + AS + | | | | | |
| N + P | | | | | |
| 187 x3 Car + Prop + | 6.0 | 6.0 | 6.5 | 6.5 | 6.5 |
| AN + LE + GLU + | | | | | |
| AL + THR + | | | | | |
| AS + N + P | | | | | |
| 188 x3 Car + | 6.5 | 7.0 | 7.0 | 7.5 | 7.5 |
| Prop + AN + AC + | | | | | |
| LE + GLU + | | | | | |
| AL + THR + AS + | | | | | |
| N + P | | | | | |
| 189 x1 Car + | 7.0 | 6.5 | 6.5 | 6.5 | 8.0 |
| Prop + LE + | | | | | |
| GLU + AL + | | | | | |
| THR + LY | | | | | |
| 190 x2 Car + | 7.0 | 6.5 | 6.5 | 6.5 | 8.0 |
| Prop + LE + | | | | | |
| GLU + AL + | | | | | |
| THR + LY | | | | | |
| 191 x3 Car + | 6.0 | 6.0 | 6.5 | 6.5 | 8.0 |
| Prop + LE + | | | | | |
| GLU + AL + | | | | | |
| THR + LY | | | | | |
| 192 x3 Car + | 6.0 | 6.5 | 6.5 | 6.5 | 8.0 |
| Prop + AN + LE + | | | | | |
| GLU + AL + | | | | | |
| THR + LY | | | | | |
| 193 x3 Car + | 6.5 | 7.0 | 7.0 | 7.0 | 8.0 |
| Prop + AN + AC + | | | | | |
| LE + GLU + | | | | | |
| AL + THR + LY | | | | | |
| 194 x1 Car + | 6.5 | 6.0 | 6.5 | 6.5 | 6.5 |
| Prop + LE + CY + | | | | | |
| ME + GLU + | | | | | |
| GLY + AL + | | | | | |
| THR + LY + AS | | | | | |
| 195 x2 Car + | 7.0 | 6.0 | 6.5 | 6.5 | 6.5 |
| Prop + LE + CY + | | | | | |
| ME + GLU + | | | | | |
| GLY + AL + | | | | | |
| THR + LY + AS | | | | | |
| 196 x3 Car + | 6.0 | 6.0 | 6.0 | 6.0 | 7.0 |
| Prop + LE + CY + | | | | | |
| ME + GLU + | | | | | |
| GLY + AL + | | | | | |
| THR + LY + AS | | | | | |
| 197 x3 Car + | 6.0 | 6.0 | 6.0 | 6.0 | 7.0 |
| Prop + AN + LE + | | | | | |
| CY + ME + | | | | | |
| GLU + GLY + | | | | | |
| AL + THR + LY + | | | | | |
| AS | | | | | |
| 198 x3 Car + | 6.0 | 6.5 | 6.5 | 6.5 | 7.0 |
| Prop + AN + AC + | | | | | |
| LE + CY + ME + | | | | | |
| GLU + GLY + | | | | | |
| AL + THR + LY + | | | | | |
| AS | | | | | |
| With added | | | | | |
| Category (c) + (f) | | | | | |
| Safeners (199-223) | | | | | |
| 199 x1 Car + | 6.5 | 6.0 | 6.0 | 6.0 | 6.5 |
| Prop + ME + | | | | | |
| CY + GLU + F | | | | | |
| 200 x2 Car + | 6.0 | 6.0 | 6.5 | 6.5 | 6.5 |
| Prop + ME + | | | | | |
| CY + GLU + F | | | | | |
| 201 x3 Car + | 5.5 | 5.5 | 6.0 | 6.0 | 7.0 |
| Prop + ME + | | | | | |
| CY + GLU + F | | | | | |
| 202 x3 Car + | 6.0 | 5.5 | 6.0 | 6.5 | 7.0 |
| Prop + AN + ME + | | | | | |
| CY + GLU + F | | | | | |
| 203 x3 Car + | 6.0 | 6.5 | 6.5 | 6.5 | 7.5 |
| Prop + AN + AC + | | | | | |
| ME + CY + | | | | | |
| GLU + F | | | | | |
| 204 x1 Car + | 7.0 | 6.0 | 6.5 | 6.5 | 7.0 |
| Prop + ME + CY + | | | | | |
| GLU + F + N | | | | | |
| 205 x2 Car + | 6.5 | 6.0 | 7.0 | 7.0 | 7.0 |
| Prop + ME + CY + | | | | | |
| GLU + F + N | | | | | |
| 206 x3 Car + | 6.5 | 6.5 | 6.0 | 6.0 | 6.5 |
| Prop + ME + CY + | | | | | |
| GLU + F + N | | | | | |
| 207 x3 Car + Prop + | 6.5 | 6.5 | 6.5 | 6.5 | 6.5 |
| AN + ME + CY + | | | | | |
| GLU + F + N | | | | | |
| 208 x3 Car + | 7.0 | 6.5 | 6.5 | 6.5 | 6.5 |
| Prop + AN + AC + | | | | | |
| ME + CY + | | | | | |
| GLU + F + N | | | | | |
| 209 x1 Car + | 7.0 | 7.5 | 7.0 | 7.0 | 7.0 |
| Prop + ME + CY + | | | | | |
| GLU + F + N + P | | | | | |
| 210 x2 Car + | 7.0 | 7.0 | 7.0 | 7.0 | 7.5 |
| Prop + ME + CY + | | | | | |
| GLU + F + N + P | | | | | |
| 211 x3 Car + Prop + | 7.0 | 7.0 | 7.5 | 7.5 | 7.0 |
| ME + CY + | | | | | |
| GLU + F + N + P | | | | | |
| 212 x3 Car + | 7.0 | 7.0 | 7.0 | 7.0 | 7.0 |
| Prop + AN + ME + | | | | | |
| CY + GLU + F + | | | | | |
| N + P | | | | | |
| 213 x3 Car + | 7.0 | 7.5 | 7.0 | 7.5 | 8.0 |
| Prop + AN + AC + | | | | | |
| ME + CY + | | | | | |
| GLU + F + N + P | | | | | |
| 214 x1 Car + | 6.0 | 6.5 | 6.5 | 6.5 | 7.0 |
| Prop + ME + CY + | | | | | |
| GLU + F + P | | | | | |
| 215 x2 Car + | 6.5 | 6.0 | 6.5 | 6.5 | 6.0 |
| Prop + ME + CY + | | | | | |
| GLU + F + P | | | | | |
| 216 x3 Car + | 6.5 | 5.5 | 6.5 | 6.0 | 7.0 |
| Prop + ME + CY + | | | | | |
| GLU + F + P | | | | | |
| 217 x3 Car + | 6.5 | 6.0 | 6.0 | 6.5 | 7.0 |
| Prop + AN + ME + | | | | | |
| CY + GLU + F + P | | | | | |
| 218 x3 Car + | 6.5 | 6.0 | 6.5 | 6.5 | 7.0 |
| Prop + AN + AC + | | | | | |
| ME + CY + | | | | | |
| GLU + F + P | | | | | |
| 219 x1 Car + | 6.0 | 4.5 | 6.0 | 5.5 | 6.0 |
| Prop + LE + AA + | | | | | |
| B12 | | | | | |
| 220 x2 Car + | 6.0 | 5.0 | 6.0 | 5.0 | 5.0 |
| Prop + LE + AA + | | | | | |
| B12 | | | | | |
| 221 x3 Car + | 5.5 | 4.5 | 6.0 | 4.5 | 5.0 |
| Prop + LE + AA + | | | | | |
| B12 | | | | | |
| 222 x3 Car + | 5.5 | 4.5 | 5.5 | 4.5 | 5.0 |
| Prop + AN + LE + | | | | | |
| AA + B12 | | | | | |
| 223 x3 Car + | 5.5 | 4.5 | 6.0 | 5.0 | 5.0 |
| Prop + AN + AC + | | | | | |
| LE + AA + B12 | | | | | |
| With added | | | | | |
| Category (a) + (c) | | | | | |
| Safeners (224-238) | | | | | |
| 224 x1 Car + | 7.0 | 6.5 | 6.5 | 6.5 | 6.5 |
| Prop + S + N + P | | | | | |
| 225 x2 Car + | 7.0 | 6.5 | 6.5 | 6.5 | 6.5 |
| Prop + S + N + P | | | | | |
| 226 x3 Car + | 7.0 | 6.5 | 6.5 | 6.5 | 6.5 |
| Prop + S + N + P | | | | | |
| 227 x3 Car + | 6.5 | 6.5 | 6.5 | 6.5 | 6.5 |
| Prop + AN + S + | | | | | |
| N + P | | | | | |
| 228 x3 Car + | 7.0 | 7.0 | 7.0 | 6.5 | 7.0 |
| Prop + AN + AC + | | | | | |
| S + N + P | | | | | |
| 229 x1 Car + | 7.0 | 6.5 | 6.5 | 6.5 | 7.0 |
| Prop + F + N + P | | | | | |
| 230 x2 Car + | 7.0 | 7.0 | 6.5 | 7.0 | 7.0 |
| Prop + F + N + P | | | | | |
| 231 x3 Car + | 6.5 | 6.0 | 6.0 | 6.0 | 7.0 |
| Prop + F + N + P | | | | | |
| 232 x3 Car + | 6.5 | 6.5 | 6.0 | 6.0 | 6.5 |
| Prop + AN + F + | | | | | |
| N + P | | | | | |
| 233 x3 Car + | 7.0 | 7.0 | 6.5 | 6.5 | 7.5 |
| Prop + AN + | | | | | |
| AC + F + N + P | | | | | |
| 234 x1 Car + | 7.0 | 7.0 | 6.0 | 6.0 | 7.0 |
| Prop + G + N + P | | | | | |
| 235 x2 Car + Prop + | 6.5 | 6.0 | 6.5 | 6.0 | 7.0 |
| G + N + P | | | | | |
| 236 x3 Car + | 7.0 | 6.0 | 6.0 | 6.0 | 6.5 |
| Prop + G + N + P | | | | | |
| 237 x3 Car + | 7.0 | 6.5 | 6.5 | 6.5 | 6.5 |
| Prop + AN + G + | | | | | |
| N + P | | | | | |
| 238 x3 Car + | 7.5 | 7.0 | 7.0 | 7.0 | 7.5 |
| Prop + AN + AC + | | | | | |
| G + N + P | | | | | |
| With added | | | | | |
| Category (a), (c) | | | | | |
| and (e) Safeners | | | | | |
| (239-248) | | | | | |
| 239 x1 Car + | 6.5 | 6.5 | 6.5 | 6.0 | 7.0 |
| Prop + Oil + N + | | | | | |
| P + G | | | | | |
| 240 x2 Car + | 6.5 | 7.0 | 6.5 | 6.5 | 7.0 |
| Prop + Oil + N + | | | | | |
| P + G | | | | | |
| 241 x3 Car + | 6.5 | 6.5 | 6.5 | 6.5 | 7.0 |
| Prop + Oil + N + | | | | | |
| P + G | | | | | |
| 242 x3 Car + | 6.5 | 6.5 | 6.5 | 6.5 | 7.0 |
| Prop + AN + Oil + | | | | | |
| N + P + G | | | | | |
| 243 x3 Car + | 6.5 | 7.0 | 6.5 | 7.0 | 7.5 |
| Prop + AN + AC + | | | | | |
| Oil + N + P + G | | | | | |
| 244 x1 Car + | 7.0 | 7.0 | 6.0 | 6.0 | 6.5 |
| Prop + Oil + T + | | | | | |
| R + G | | | | | |
| 245 x2 Car + | 7.0 | 6.0 | 6.5 | 6.0 | 7.0 |
| Prop + Oil + T + | | | | | |
| R + G | | | | | |
| 246 x3 Car + | 7.0 | 6.5 | 7.0 | 6.5 | 7.0 |
| Prop + Oil + T + | | | | | |
| R + G | | | | | |
| 247 x3 Car + | 7.0 | 7.0 | 7.0 | 6.5 | 6.5 |
| Prop + AN + | | | | | |
| Oil + T + R + G | | | | | |
| 248 x3 Car + | 7.5 | 7.0 | 7.0 | 7.0 | 7.5 |
| Prop + AN + AC + | | | | | |
| Oil + T + R + G | | | | | |
| With added | | | | | |
| Category (c) + (e) | | | | | |
| Safeners (249-263) | | | | | |
| 249 x1 Car + | 6.5 | 6.5 | 6.5 | 6.5 | 7.0 |
| Prop + Oil + F + | | | | | |
| T + R | | | | | |
| 250 x2 Car + | 7.0 | 6.5 | 6.0 | 6.5 | 7.0 |
| Prop + Oil + F + | | | | | |
| T + R | | | | | |
| 251 x3 Car + | 6.5 | 6.5 | 6.5 | 6.0 | 7.0 |
| Prop + Oil + F + | | | | | |
| T + R | | | | | |
| 252 x3 Car + | 7.0 | 6.5 | 6.5 | 6.5 | 7.0 |
| Prop + AN + Oil + | | | | | |
| F + T + R | | | | | |
| 253 x3 Car + | 7.0 | 6.5 | 7.0 | 7.0 | 7.0 |
| Prop + AN + AC + | | | | | |
| Oil + F + T + R | | | | | |
| 254 x1 Car + | 7.0 | 7.0 | 7.0 | 6.5 | 6.5 |
| Prop + Oil + | | | | | |
| AA + B + B12 | | | | | |
| 255 x2 Car + | 6.5 | 6.5 | 6.5 | 6.0 | 6.5 |
| Prop + Oil + AA + | | | | | |
| B + B12 | | | | | |
| 256 x3 Car + | 6.5 | 6.5 | 6.0 | 6.0 | 7.0 |
| Prop + Oil + AA + | | | | | |
| B + B12 | | | | | |
| 257 x3 Car + | 6.5 | 6.5 | 6.5 | 6.5 | 7.0 |
| Prop + AN + Oil + | | | | | |
| AA + B + B12 | | | | | |
| 258 x3 Car + | 7.0 | 7.0 | 7.0 | 7.0 | 7.5 |
| Prop + AN + AC + | | | | | |
| AA + B + B12 | | | | | |
| 259 x1 Car + | 7.0 | 6.5 | 7.0 | 7.0 | 7.0 |
| Prop + Oil + AA + | | | | | |
| B12 | | | | | |
| 260 x2 Car + | 7.0 | 6.5 | 7.0 | 6.5 | 7.0 |
| Prop + Oil + AA + | | | | | |
| B12 | | | | | |
| 261 x3 Car + | 7.0 | 7.0 | 6.0 | 6.0 | 6.5 |
| Prop + Oil + AA + | | | | | |
| B12 | | | | | |
| 262 x3 Car + | 7.0 | 7.0 | 6.5 | 6.5 | 6.5 |
| Prop + AN + Oil + | | | | | |
| AA + B12 | | | | | |
| 263 x3 Car + | 7.0 | 7.0 | 7.0 | 7.0 | 7.5 |
| Prop + AN + AC + | | | | | |
| AA + B12 | | | | | |
| With added | | | | | |
| Category (a) + (c) + | | | | | |
| (e) + (f) | | | | | |
| Safeners (264-268) | | | | | |
| 264 x1 Car + | 6.5 | 7.0 | 6.5 | 6.5 | 7.0 |
| Prop + Oil + ME + | | | | | |
| G + R + N | | | | | |
| 265 x2 Car + | 6.5 | 6.5 | 6.0 | 6.0 | 6.5 |
| Prop + Oil + | | | | | |
| ME + G + R + N | | | | | |
| 266 x3 Car + | 6.5 | 6.5 | 6.5 | 6.0 | 6.5 |
| Prop + Oil + ME + | | | | | |
| G + R + N | | | | | |
| 267 x3 Car + | 6.5 | 6.5 | 6.0 | 6.5 | 7.0 |
| Prop + AN + Oil + | | | | | |
| ME + G + R + N | | | | | |
| 268 x3 Car + | 6.5 | 7.0 | 6.5 | 6.5 | 7.0 |
| Prop + AN + AC + | | | | | |
| ME + G + R + N | | | | | |

A reduction in phytotoxicity, along with increases in vigour and rooting, are shown from the use of the safening systems above (either combinations of compounds from classes (a) to (f) alone or in combination AN and/or AC) in combination with a herbicide, in contrast to application of a herbicide alone.

### Example 7

### Root Nodulation and Safening in a Range of Nitrogen-Fixing Crops

Safening systems were applied to crops of soybean, navy bean and pea either alone or in combination with cobalt and/or a general foliar fertilizer, either without or without AN and/or AC. The safener/safening system and the fertiliser were applied to the crops either simultaneously or sequentially.

Co=100% Cobalt Sulphate (20 g per litre and per hectare).
FF1=20 g per litre Cobalt Sulphate (as per Co above) plus “Miracle-Gro” at xl recommended rate (applied at 15 g per 2.5 sq metres). Miracle-Gro contains: 24% N, 4% P, 13% K, plus 0.02% B, 0.03% Cu, 0.19% Fe, 0.05% Mn, 0.001% Mo and 0.03% Zn.
FF2=20 g per litre Cobalt Sulphate plus Miracle-Gro at ×2 recommended rate.
SAF: at least one from class (f) each at <3 g/l, plus at least one from class (c).

### Example 7.1

### Soybean

Scored/Counted+28 Days After Spraying. Sown in Compost of low pH (5.0-5.5) on 1 May 2008. Spray Date (VC)=4 June, V1 Date=20 June. Scored/Measured on 17 July. Each treatment is the mean result of 12 plants, within four replicates. Seed density approx 110 kg/ha. Soybean treated with standard inoculant at sowing.

| | | | | | | Phyto- | |
|---|---|---|---|---|---|---|---|
| | | Nodules | | Nodules | Nod | Toxicity | Vigour |
| | | Per | Nodulation | Per | Score | Score | Score |
| | | Plant | Score (0-9) | Plant | (0-9) | (0-9) | (0-9) |
| No. | Treatment | (V1) | (V1) | (VC) | (VC) | (V1) | (V1) |
| 1 | Untreated | 24.0 | 4.9 | 29.0 | 5.4 | 7.6 | 6.0 |
| 2 | AN | 28.2 | 5.3 | 33.2 | 5.8 | 8.0 | 6.2 |
| 3 | AC | 26.1 | 5.0 | 28.1 | 5.3 | 8.0 | 6.0 |
| 4 | AN + AC | 31.2 | 5.5 | 33.3 | 5.8 | 8.3 | 6.5 |
| 5 | AN + SAF | 33.0 | 5.8 | 34.0 | 5.9 | 8.6 | 6.2 |
| 6 | AC + SAF | 31.4 | 5.5 | 29.3 | 5.4 | 8.6 | 6.1 |
| 7 | AN + AC + | 37.2 | 6.0 | 41.2 | 6.5 | 8.6 | 7.1 |
| | SAF | | | | | | |
| 8 | AN + AC + | 33.0 | 5.8 | 34.3 | 5.9 | 8.6 | 6.8 |
| | SAF + POL | | | | | | |
| 9 | Co | 27.3 | 5.2 | 28.8 | 5.4 | 7.8 | 6.0 |
| 10 | Co + AN | 30.0 | 5.5 | 31.5 | 5.7 | 8.0 | 6.0 |
| 11 | Co + AC | 26.9 | 5.2 | 28.9 | 5.4 | 8.0 | 6.0 |
| 12 | Co + AN + | 32.1 | 5.7 | 35.9 | 6.0 | 8.4 | 6.5 |
| | AC | | | | | | |
| 13 | Co + AN + | 33.3 | 5.8 | 37.7 | 6.3 | 8.7 | 6.2 |
| | SAF | | | | | | |
| 14 | Co + AC + | 28.1 | 5.3 | 33.3 | 5.8 | 8.7 | 6.1 |
| | SAF | | | | | | |
| 15 | Co + AN + | 37.1 | 6.1 | 41.6 | 6.5 | 8.7 | 6.8 |
| | AC + SAF | | | | | | |
| 16 | Co + AN + | 36.4 | 6.0 | 38.4 | 6.3 | 8.6 | 6.8 |
| | AC + SAF + | | | | | | |
| | POL | | | | | | |
| 17 | FF1 | 26.2 | 5.0 | 28.8 | 5.4 | 8.0 | 6.0 |
| 18 | FF1 + AN | 27.8 | 5.3 | 33.2 | 5.8 | 8.3 | 6.3 |
| 19 | FF1 + AN + | 32.4 | 5.7 | 36.1 | 6.0 | 8.7 | 6.3 |
| | SAF | | | | | | |
| 20 | FF1 + AN + | 32.7 | 5.7 | 36.3 | 6.0 | 8.4 | 6.8 |
| | AC | | | | | | |
| 21 | FF1 + AN + | 35.9 | 6.0 | 41.0 | 6.5 | 8.7 | 7.0 |
| | AC + SAF | | | | | | |
| 22 | FF1 + AN + | 36.2 | 6.0 | 38.0 | 6.3 | 8.6 | 6.9 |
| | AC + SAF + | | | | | | |
| | POL | | | | | | |
| 23 | FF2 | 26.7 | 5.1 | 28.2 | 5.3 | 8.0 | 6.0 |
| 24 | FF2 + AN | 29.2 | 5.4 | 31.0 | 5.6 | 8.3 | 6.3 |
| 25 | FF2 + AN + | 31.7 | 5.6 | 34.0 | 5.9 | 8.7 | 6.4 |
| | SAF | | | | | | |
| 26 | FF2 + AN + | 33.1 | 5.8 | 33.8 | 5.9 | 8.5 | 6.5 |
| | AC | | | | | | |
| 27 | FF2 + AN + | 36.4 | 6.1 | 40.8 | 6.5 | 8.7 | 6.8 |
| | AC + SAF | | | | | | |
| 28 | FF2 + AN + | 35.1 | 6.0 | 40.1 | 6.4 | 8.7 | 6.8 |
| | AC + SAF + | | | | | | |
| | POL | | | | | | |
| LSD | | 3.21 | 0.50 | 3.38 | 0.53 | 0.48 | 0.52 |
| (Treatment | | | | | | | |
| Mean) 5% | | | | | | | |

### Example 7.2

### Glycine max (Soybean)

Dates as per Example 7.1 above, but sown in compost of normal pH (6.5). Each treatment represents the mean values for 12 plants, within four replicates. Sowing density 110 kg/ha. Standard inoculant applied at sowing.

| | | | | | | Phyto- | |
|---|---|---|---|---|---|---|---|
| | | Nodules | | Nodules | Nod | Toxicity | Vigour |
| | | Per | Nodulation | Per | Score | Score | Score |
| | | Plant | Score (0-9) | Plant | (0-9) | (0-9) | (0-9) |
| | Treatment | (V1) | (V1) | (VC) | (VC) | (V1) | (V1) |
| 1 | Untreated | 26.9 | 5.2 | 29.1 | 5.4 | 7.4 | 6.5 |
| 2 | AN | 34.2 | 5.9 | 33.3 | 5.8 | 8.0 | 6.7 |
| 3 | AC | 29.9 | 5.5 | 32.0 | 5.7 | 8.0 | 6.5 |
| 4 | AN + AC | 36.0 | 6.0 | 37.8 | 6.2 | 8.3 | 7.1 |
| 5 | AN + SAF | 34.0 | 5.9 | 37.6 | 6.2 | 8.6 | 6.5 |
| 6 | AC + SAF | 33.9 | 5.9 | 31.9 | 5.7 | 8.6 | 6.5 |
| 7 | AN + AC + | 37.0 | 6.2 | 38.1 | 6.3 | 8.7 | 7.8 |
| | SAF | | | | | | |
| 8 | AN + AC + | 35.7 | 6.0 | 35.7 | 6.0 | 8.5 | 7.6 |
| | SAF + POL | | | | | | |
| 9 | Co | 29.8 | 5.5 | 28.0 | 5.3 | 8.0 | 6.5 |
| 10 | Co + AN | 30.0 | 5.5 | 32.5 | 5.7 | 8.0 | 6.4 |
| 11 | Co + AC | 30.2 | 5.5 | 28.2 | 5.3 | 8.0 | 6.5 |
| 12 | Co + AN + | 33.3 | 5.8 | 35.6 | 6.0 | 8.0 | 7.0 |
| | AC | | | | | | |
| 13 | Co + AN + | 35.8 | 6.0 | 33.0 | 5.8 | 8.7 | 6.7 |
| | SAF | | | | | | |
| 14 | Co + AC + | 32.2 | 5.7 | 28.1 | 5.3 | 8.7 | 6.5 |
| | SAF | | | | | | |
| 15 | Co + AN + | 37.0 | 6.2 | 37.8 | 6.2 | 8.7 | 7.6 |
| | AC + SAF | | | | | | |
| 16 | Co + AN + | 35.7 | 6.0 | 35.3 | 6.0 | 8.7 | 7.4 |
| | AC + SAF + | | | | | | |
| | POL | | | | | | |
| 17 | FF1 | 29.8 | 5.5 | 32.8 | 5.7 | 8.0 | 6.5 |
| 18 | FF1 + AN | 29.7 | 5.5 | 34.0 | 5.9 | 8.0 | 6.7 |
| 19 | FF1 + AN + | 33.1 | 5.8 | 36.1 | 6.1 | 8.7 | 6.7 |
| | SAF | | | | | | |
| 20 | FF1 + AN + | 33.2 | 5.8 | 39.1 | 6.4 | 8.0 | 7.1 |
| | AC | | | | | | |
| 21 | FF1 + AN + | 35.5 | 6.0 | 42.1 | 6.7 | 8.7 | 7.8 |
| | AC + SAF | | | | | | |
| 22 | FF1 + AN + | 35.7 | 6.0 | 40.1 | 6.5 | 8.6 | 7.6 |
| | AC + SAF + | | | | | | |
| | POL | | | | | | |
| 23 | FF2 | 29.5 | 5.5 | 32.3 | 5.7 | 8.0 | 6.5 |
| 24 | FF2 + AN | 30.2 | 5.6 | 33.9 | 5.9 | 8.0 | 6.8 |
| 25 | FF2 + AN + | 33.6 | 5.8 | 37.3 | 6.2 | 8.7 | 6.9 |
| | SAF | | | | | | |
| 26 | FF2 + AN + | 33.7 | 5.8 | 39.3 | 6.4 | 8.2 | 7.1 |
| | AC | | | | | | |
| 27 | FF2 + AN + | 36.0 | 6.0 | 42.6 | 6.7 | 8.7 | 8.0 |
| | AC + SAF | | | | | | |
| 28 | FF2 + AN + | 35.8 | 6.0 | 40.1 | 6.5 | 8.7 | 7.6 |
| | AC + SAF + | | | | | | |
| | POL | | | | | | |
| LSD | | 3.42 | 0.53 | 3.58 | 0.54 | 0.52 | 0.48 |
| (Treatment | | | | | | | |
| Mean) 5% | | | | | | | |

### Example 7.3

### Phaseolus vulgaris (Navy Bean)

NAVY BEAN cv Mogex. Scored/Counted+28 Days after Spraying. Sown in Compost of low pH (5.0-5.5) on 29 Apr. 2008. Spray Date (VC)=27 May, V1 Date=16 June. Scored/Measured on 11 July. Each treatment represents the mean value of 12 plants, within four replicates. No inoculum applied.

| | | | | | | Phyto- | |
|---|---|---|---|---|---|---|---|
| | | Nodules | | Nodules | Nod | Toxicity | Vigour |
| | | Per | Nodulation | Per | Score | Score | Score |
| | | Plant | Score (0-9) | Plant | (0-9) | (0-9) | (0-9) |
| No. | Treatment | (V1) | (V1) | (VC) | (VC) | (V1) | (V1) |
| 1 | Untreated | 18.2 | 3.0 | 21.1 | 3.4 | 5.5 | 5.8 |
| 2 | AN | 20.9 | 3.3 | 23.4 | 3.8 | 6.0 | 6.0 |
| 3 | AC | 19.3 | 3.1 | 22.1 | 3.5 | 5.6 | 6.0 |
| 4 | AN + AC | 22.2 | 3.5 | 25.2 | 4.0 | 6.1 | 6.5 |
| 5 | AN + SAF | 22.1 | 3.5 | 24.1 | 3.9 | 6.5 | 6.0 |
| 6 | AC + SAF | 20.8 | 3.3 | 23.9 | 3.9 | 6.5 | 6.0 |
| 7 | AN + AC + | 31.1 | 4.9 | 27.1 | 4.3 | 7.2 | 6.9 |
| | SAF | | | | | | |
| 8 | AN + AC + | 29.3 | 4.6 | 26.7 | 4.2 | 6.6 | 6.6 |
| | SAF + POL | | | | | | |
| 9 | Co | 21.0 | 3.3 | 23.8 | 3.8 | 5.7 | 5.9 |
| 10 | Co + AN | 22.3 | 3.5 | 25.2 | 4.0 | 6.2 | 6.0 |
| 11 | Co + AC | 20.8 | 3.3 | 23.6 | 3.7 | 5.7 | 5.9 |
| 12 | Co + AN + | 25.1 | 4.0 | 26.0 | 4.1 | 5.9 | 6.5 |
| | AC | | | | | | |
| 13 | Co + AN + | 25.3 | 4.0 | 26.9 | 4.2 | 6.5 | 6.8 |
| | SAF | | | | | | |
| 14 | Co + AC + | 23.6 | 3.7 | 25.3 | 4.0 | 6.6 | 6.8 |
| | SAF | | | | | | |
| 15 | Co + AN + | 26.9 | 4.3 | 28.3 | 4.5 | 6.7 | 7.1 |
| | AC + SAF | | | | | | |
| 16 | Co + AN + | 26.5 | 4.2 | 26.9 | 4.3 | 6.5 | 6.8 |
| | AC + SAF + | | | | | | |
| | POL | | | | | | |
| 17 | FF1 | 21.9 | 3.5 | 23.5 | 3.7 | 5.8 | 6.2 |
| 18 | FF1 + AN | 23.8 | 3.7 | 25.2 | 4.0 | 5.7 | 6.3 |
| 19 | FF1 + AN + | 23.7 | 3.8 | 25.0 | 4.0 | 6.4 | 6.8 |
| | SAF | | | | | | |
| 20 | FF1 + AN + | 23.8 | 3.8 | 26.1 | 4.1 | 6.0 | 6.4 |
| | AC | | | | | | |
| 21 | FF1 + AN + | 27.0 | 4.3 | 28.3 | 4.5 | 6.8 | 6.8 |
| | AC + SAF | | | | | | |
| 22 | FF1 + AN + | 26.2 | 4.1 | 30.3 | 4.8 | 6.8 | 6.7 |
| | AC + SAF + | | | | | | |
| | POL | | | | | | |
| 23 | FF2 | 23.2 | 3.6 | 23.6 | 3.7 | 5.8 | 6.1 |
| 24 | FF2 + AN | 24.0 | 3.8 | 24.7 | 3.9 | 5.7 | 6.2 |
| 25 | FF2 + AN + | 23.9 | 3.8 | 26.1 | 4.1 | 6.7 | 6.6 |
| | SAF | | | | | | |
| 26 | FF2 + AN + | 24.2 | 3.9 | 25.3 | 4.0 | 6.0 | 6.4 |
| | AC | | | | | | |
| 27 | FF2 + AN + | 26.9 | 4.1 | 28.4 | 4.5 | 6.8 | 6.8 |
| | AC + SAF | | | | | | |
| 28 | FF2 + AN + | 25.3 | 4.0 | 26.8 | 4.3 | 6.8 | 6.8 |
| | AC + SAF + | | | | | | |
| | POL | | | | | | |
| LSD | | 2.15 | 0.32 | 2.23 | 0.34 | 0.47 | 0.55 |
| (Treatment | | | | | | | |
| Mean) 5% | | | | | | | |

### Example 7.4

### Phaseolus vulgaris (Navy Bean)

NAVY BEAN cv Mogex. Scored/Counted+28 Days after Spraying. Dates as per Example 7.3 Above, but sown in compost of normal pH (6.5). Each treatment represents the mean value from 12 plants, within four replicates. No inoculum applied.

| | | | | | | Phyto- | |
|---|---|---|---|---|---|---|---|
| | | Nodules | | Nodules | Nod | Toxicity | Vigour |
| | | Per | Nodulation | Per | Score | Score | Score |
| | | Plant | Score (0-9) | Plant | (0-9) | (0-9) | (0-9) |
| No. | Treatment | (V1) | (V1) | (VC) | (VC) | (V1) | (V1) |
| 1 | Untreated | 29.7 | 4.8 | 31.1 | 4.9 | 7.0 | 6.8 |
| 2 | AN | 32.2 | 5.0 | 33.2 | 5.1 | 7.0 | 7.2 |
| 3 | AC | 29.5 | 4.8 | 32.1 | 5.0 | 7.0 | 7.0 |
| 4 | AN + AC | 34.1 | 5.2 | 34.8 | 5.3 | 7.5 | 7.0 |
| 5 | AN + SAF | 32.0 | 5.0 | 36.2 | 5.5 | 7.2 | 7.0 |
| 6 | AC + SAF | 33.2 | 5.1 | 35.0 | 5.4 | 7.2 | 7.0 |
| 7 | AN + AC + | 38.1 | 5.8 | 38.0 | 5.8 | 7.8 | 7.8 |
| | SAF | | | | | | |
| 8 | AN + AC + | 36.0 | 5.5 | 38.1 | 5.8 | 7.6 | 7.2 |
| | SAF + POL | | | | | | |
| 9 | Co | 33.5 | 5.2 | 31.8 | 5.0 | 7.3 | 7.2 |
| 10 | Co + AN | 36.2 | 5.5 | 34.2 | 5.3 | 7.5 | 7.0 |
| 11 | Co + AC | 33.7 | 5.2 | 31.6 | 5.0 | 7.5 | 7.0 |
| 12 | Co + AN + | 35.9 | 5.5 | 34.4 | 5.3 | 7.5 | 7.5 |
| | AC | | | | | | |
| 13 | Co + AN + | 36.3 | 5.5 | 38.0 | 5.8 | 7.5 | 7.0 |
| | SAF | | | | | | |
| 14 | Co + AC + | 34.2 | 5.3 | 36.0 | 5.5 | 7.5 | 7.2 |
| | SAF | | | | | | |
| 15 | Co + AN + | 37.3 | 5.6 | 37.9 | 5.8 | 8.0 | 7.9 |
| | AC + SAF | | | | | | |
| 16 | Co + AN + | 35.0 | 5.4 | 37.5 | 5.7 | 7.5 | 7.5 |
| | AC + SAF + | | | | | | |
| | POL | | | | | | |
| 17 | FF1 | 32.0 | 5.0 | 33.8 | 5.2 | 7.8 | 7.5 |
| 18 | FF1 + AN | 34.9 | 5.3 | 34.7 | 5.3 | 7.8 | 7.4 |
| 19 | FF1 + AN + | 35.1 | 5.4 | 35.1 | 5.4 | 7.8 | 7.5 |
| | SAF | | | | | | |
| 20 | FF1 + AN + | 34.6 | 5.3 | 35.2 | 5.4 | 7.8 | 7.5 |
| | AC | | | | | | |
| 21 | FF1 + AN + | 38.1 | 5.8 | 38.2 | 5.8 | 7.8 | 7.5 |
| | AC + SAF | | | | | | |
| 22 | FF1 + AN + | 37.9 | 5.8 | 38.0 | 5.8 | 7.8 | 7.8 |
| | AC + SAF + | | | | | | |
| | POL | | | | | | |
| 23 | FF2 | 32.8 | 5.1 | 31.8 | 5.0 | 7.8 | 7.2 |
| 24 | FF2 + AN | 34.6 | 5.3 | 33.8 | 5.2 | 7.3 | 7.5 |
| 25 | FF2 + AN + | 35.0 | 5.4 | 36.1 | 5.5 | 7.3 | 7.5 |
| | SAF | | | | | | |
| 26 | FF2 + AN + | 37.3 | 5.6 | 36.0 | 5.5 | 7.8 | 7.5 |
| | AC | | | | | | |
| 27 | FF2 + AN + | 37.9 | 5.8 | 38.3 | 5.8 | 7.2 | 7.5 |
| | AC + SAF | | | | | | |
| 28 | FF2 + AN + | 38.1 | 5.8 | 37.7 | 5.7 | 7.5 | 7.8 |
| | AC + SAF + | | | | | | |
| | POL | | | | | | |
| LSD | | 3.08 | 0.37 | 3.14 | 0.39 | 0.46 | 0.53 |
| (Treatment | | | | | | | |
| Mean) 5% | | | | | | | |

### Example 7.5

### Pisum sativum (Pea)

PEA—TRIAL 5—cv Ragtime. Scored/Counted+28 Days after Spraying. Sown in Compost of Low pH (5.0-5.5) on 28 Apr. 2008. Spray Date (VC)=26 May, V1 Date=14 June. Scored/Measured on 9 July. Each treatment represents the results from 12 plants, within four replicates. No inoculum applied.

| | | | | | | Phyto- | |
|---|---|---|---|---|---|---|---|
| | | Nodules | | Nodules | Nod | Toxicity | Vigour |
| | | Per | Nodulation | Per | Score | Score | Score |
| | | Plant | Score (0-9) | Plant | (0-9) | (0-9) | (0-9) |
| No. | Treatment | (V1) | (V1) | (VC) | (VC) | (V1) | (V1) |
| 1 | Untreated | 15.1 | 4.8 | 17.4 | 5.2 | 5.2 | 5.0 |
| 2 | AN | 16.8 | 5.0 | 17.3 | 5.2 | 5.2 | 5.5 |
| 3 | AC | 16.7 | 5.0 | 17.3 | 5.2 | 5.2 | 5.1 |
| 4 | AN + AC | 19.9 | 5.5 | 19.8 | 5.5 | 5.4 | 6.0 |
| 5 | AN + SAF | 17.0 | 5.1 | 19.9 | 5.5 | 6.7 | 5.8 |
| 6 | AC + SAF | 16.6 | 5.0 | 18.8 | 5.4 | 6.5 | 5.8 |
| 7 | AN + AC + | 22.2 | 5.8 | 22.2 | 5.8 | 7.5 | 6.5 |
| | SAF | | | | | | |
| 8 | AN + AC + | 22.4 | 5.8 | 21.9 | 5.7 | 7.2 | 6.2 |
| | SAF + POL | | | | | | |
| 9 | Co | 16.4 | 5.0 | 18.1 | 5.3 | 5.1 | 5.8 |
| 10 | Co + AN | 17.2 | 5.2 | 19.7 | 5.5 | 5.5 | 5.5 |
| 11 | Co + AC | 17.4 | 5.2 | 17.9 | 5.3 | 5.3 | 5.5 |
| 12 | Co + AN + | 19.7 | 5.5 | 19.7 | 5.5 | 5.5 | 5.8 |
| | AC | | | | | | |
| 13 | Co + AN + | 19.8 | 5.6 | 22.2 | 5.8 | 6.5 | 6.5 |
| | SAF | | | | | | |
| 14 | Co + AC + | 17.2 | 5.2 | 21.3 | 5.7 | 6.4 | 6.0 |
| | SAF | | | | | | |
| 15 | Co + AN + | 19.6 | 5.5 | 22.1 | 5.8 | 6.5 | 6.5 |
| | AC + SAF | | | | | | |
| 16 | Co + AN + | 19.4 | 5.5 | 22.3 | 5.8 | 6.5 | 6.2 |
| | AC + SAF + | | | | | | |
| | POL | | | | | | |
| 17 | FF1 | 16.7 | 5.0 | 17.3 | 5.2 | 6.0 | 6.5 |
| 18 | FF1 + AN | 16.5 | 5.0 | 18.1 | 5.3 | 6.0 | 6.5 |
| 19 | FF1 + AN + | 16.4 | 5.0 | 19.1 | 5.4 | 6.5 | 6.7 |
| | SAF | | | | | | |
| 20 | FF1 + AN + | 16.6 | 5.0 | 19.5 | 5.5 | 6.1 | 6.8 |
| | AC | | | | | | |
| 21 | FF1 + AN + | 16.7 | 5.0 | 22.1 | 5.8 | 6.5 | 7.0 |
| | AC + SAF | | | | | | |
| 22 | FF1 + AN + | 16.7 | 5.0 | 22.2 | 5.8 | 6.5 | 7.2 |
| | AC + SAF + | | | | | | |
| | POL | | | | | | |
| 23 | FF2 | 16.5 | 5.0 | 16.4 | 5.0 | 6.0 | 6.2 |
| 24 | FF2 + AN | 17.3 | 5.2 | 17.0 | 5.2 | 6.0 | 6.1 |
| 25 | FF2 + AN + | 18.1 | 5.3 | 17.2 | 5.2 | 6.2 | 6.7 |
| | SAF | | | | | | |
| 26 | FF2 + AN + | 20.0 | 5.5 | 17.2 | 5.2 | 6.1 | 6.3 |
| | AC | | | | | | |
| 27 | FF2 + AN + | 21.7 | 5.7 | 22.3 | 5.8 | 6.2 | 7.0 |
| | AC + SAF | | | | | | |
| 28 | FF2 + AN + | 20.6 | 5.6 | 21.1 | 5.7 | 6.2 | 7.0 |
| | AC + SAF + | | | | | | |
| | POL | | | | | | |
| LSD | | 1.71 | 0.33 | 1.85 | 0.36 | 0.48 | 0.50 |
| (Treatment | | | | | | | |
| Mean) 5% | | | | | | | |

### Example 7.6

### Pisum sativum (Pea)

PEA—TRIAL 7.6—cv Ragtime. Dates as per Example 7.5 above, but sown in compost of normal pH (6.5). Each treatment represents the results from 12 plants, within four replicates. No inoculum was applied.

| | | | | | | Phyto- | |
|---|---|---|---|---|---|---|---|
| | | Nodules | | Nodules | Nod | Toxicity | Vigour |
| | | Per | Nodulation | Per | Score | Score | Score |
| | | Plant | Score (0-9) | Plant | (0-9) | (0-9) | (0-9) |
| No. | Treatment | (V1) | (V1) | (VC) | (VC) | (V1) | (V1) |
| 1 | Untreated | 15.1 | 4.8 | 15.3 | 4.8 | 7.0 | 6.8 |
| 2 | AN | 17.2 | 5.2 | 17.1 | 5.2 | 7.0 | 6.9 |
| 3 | AC | 15.4 | 4.9 | 16.4 | 5.0 | 7.0 | 6.7 |
| 4 | AN + AC | 17.3 | 5.2 | 16.4 | 5.0 | 7.1 | 6.6 |
| 5 | AN + SAF | 17.2 | 5.2 | 16.5 | 5.0 | 7.6 | 7.0 |
| 6 | AC + SAF | 16.8 | 5.1 | 16.3 | 5.0 | 7.5 | 6.9 |
| 7 | AN + AC + | 23.6 | 6.0 | 23.8 | 6.0 | 8.0 | 7.5 |
| | SAF | | | | | | |
| 8 | AN + AC + | 22.0 | 5.8 | 22.7 | 5.9 | 7.8 | 7.2 |
| | SAF + POL | | | | | | |
| 9 | Co | 16.9 | 5.1 | 17.4 | 5.2 | 6.9 | 6.8 |
| 10 | Co + AN | 17.6 | 5.2 | 17.5 | 5.2 | 7.0 | 6.8 |
| 11 | Co + AC | 16.7 | 5.1 | 17.3 | 5.2 | 7.0 | 6.8 |
| 12 | Co + AN + | 19.6 | 5.5 | 19.6 | 5.5 | 7.0 | 6.8 |
| | AC | | | | | | |
| 13 | Co + AN + | 19.7 | 5.5 | 19.5 | 5.5 | 7.4 | 6.8 |
| | SAF | | | | | | |
| 14 | Co + AC + | 19.7 | 5.5 | 17.4 | 5.2 | 7.6 | 6.8 |
| | SAF | | | | | | |
| 15 | Co + AN + | 19.6 | 5.5 | 22.1 | 5.8 | 7.9 | 7.6 |
| | AC + SAF | | | | | | |
| 16 | Co + AN + | 19.2 | 5.4 | 17.9 | 5.3 | 7.8 | 7.1 |
| | AC + SAF + | | | | | | |
| | POL | | | | | | |
| 17 | FF1 | 23.7 | 6.0 | 25.0 | 6.2 | 6.9 | 6.8 |
| 18 | FF1 + AN | 23.9 | 6.0 | 23.6 | 6.0 | 6.9 | 6.9 |
| 19 | FF1 + AN + | 23.6 | 6.0 | 23.5 | 6.0 | 7.3 | 6.7 |
| | SAF | | | | | | |
| 20 | FF1 + AN + | 22.1 | 5.8 | 23.5 | 6.0 | 7.4 | 6.7 |
| | AC | | | | | | |
| 21 | FF1 + AN + | 22.0 | 5.8 | 23.6 | 6.0 | 7.8 | 7.6 |
| | AC + SAF | | | | | | |
| 22 | FF1 + AN + | 23.0 | 5.9 | 23.5 | 5.9 | 7.9 | 7.3 |
| | AC + SAF + | | | | | | |
| | POL | | | | | | |
| 23 | FF2 | 23.7 | 6.0 | 23.6 | 6.0 | 7.1 | 6.8 |
| 24 | FF2 + AN | 22.2 | 5.8 | 22.3 | 5.8 | 6.9 | 6.8 |
| 25 | FF2 + AN + | 22.4 | 5.8 | 23.2 | 5.9 | 7.3 | 6.8 |
| | SAF | | | | | | |
| 26 | FF2 + AN + | 22.4 | 5.8 | 21.1 | 5.7 | 7.0 | 6.8 |
| | AC | | | | | | |
| 27 | FF2 + AN + | 22.2 | 5.8 | 21.0 | 5.7 | 7.9 | 7.0 |
| | AC + SAF | | | | | | |
| 28 | FF2 + AN + | 22.4 | 5.8 | 22.3 | 5.8 | 7.6 | 6.8 |
| | AC + SAF + | | | | | | |
| | POL | | | | | | |
| LSD | | 1.73 | 0.32 | 1.75 | 0.35 | 0.49 | 0.52 |
| (Treatment | | | | | | | |
| Mean) 5% | | | | | | | |

### Example 7.7

### Pisum sativum (Pea)

PEA—Comparison of Nodulation Results with Rooting Results: i.e. whereas under low pH conditions, nodulation was significantly improved by addition of various treatments, rooting was not improved under these conditions (data from Example 7.5). Sowing details etc as per Example 7.5.

| | | | | | Phyto- |
|---|---|---|---|---|---|
| | | Nodules | | Rooting | Toxicity |
| | | Per | Nodulation | Score | Score |
| | | Plant | Score (0-9) | (0-9) | (0-9) |
| No. | Treatment | (V1) | (V1) | (V1) | (V1) |
| 1 | Untreated | 15.1 | 4.8 | 4.2 | 5.2 |
| 2 | AN | 16.8 | 5.0 | 4.2 | 5.2 |
| 3 | AC | 16.7 | 5.0 | 4.2 | 5.2 |
| 4 | AN + AC | 19.9 | 5.5 | 4.2 | 5.4 |
| 5 | AN + SAF | 17.0 | 5.1 | 4.1 | 6.7 |
| 6 | AC + SAF | 16.6 | 5.0 | 4.2 | 6.5 |
| 7 | AN + AC + | 22.2 | 5.8 | 4.2 | 7.5 |
| | SAF | | | | |
| 8 | AN + AC + | 22.4 | 5.8 | 4.2 | 7.2 |
| | SAF + POL | | | | |
| 9 | Co | 16.4 | 5.0 | 4.2 | 5.1 |
| 10 | Co + AN | 17.2 | 5.2 | 4.2 | 5.5 |
| 11 | Co + AC | 17.4 | 5.2 | 4.1 | 5.3 |
| 12 | Co + AN + | 19.7 | 5.5 | 4.2 | 5.5 |
| | AC | | | | |
| 13 | Co + AN + | 19.8 | 5.6 | 4.2 | 6.5 |
| | SAF | | | | |
| 14 | Co + AC + | 17.2 | 5.2 | 4.2 | 6.4 |
| | SAF | | | | |
| 15 | Co + AN + | 19.6 | 5.5 | 4.2 | 6.5 |
| | AC + SAF | | | | |
| 16 | Co + AN + | 19.4 | 5.5 | 4.2 | 6.5 |
| | AC + SAF + | | | | |
| | POL | | | | |
| LSD | | 1.71 | 0.33 | 0.48 | 0.49 |
| (Treatment | | | | | |
| Mean) 5% | | | | | |

The addition of safeners or a safening system greatly reduced any phytotoxicity.

The improvements in the degree of nodulation were obtained by applications at either VC (cotyledon stage) or at V1 (first true leaf stage). Such improvements would be highly advantageous from application as seed treatments, either applied alone or in combination with other seed treatments available e.g. fungicides, insecticides or those intended for any other purpose.

### Example 8

### Safening of Herbicides from Addition of Auxin/Auxin Precursor and Acetaminophen

Cultural Details: winter wheat cv Alchemy, sown 15 Apr. 2009, at seven seeds per 9 cm pot, sown in normal pH multi-purpose compost. Date of spraying: 14 May. Dates of measurement/scoring: 28 May, 11 June.

The following auxins or precursors were compared, each at 10⁻² Molar solutions. Addition of acetaminophen (AC) was at 3 g per hectare equivalent in each case. Phytotoxicity reduction is on a 0-9 scale, where 0=dead plant.

| | Phytotoxicity | Phytotoxicity |
|---|---|---|
| | (0-9; | (0-9; |
| | 0 = dead) + | 0 = dead) + |
| Treatment | 14 Days | 28 Days |
| Untreated | 8.0 | 8.0 |
| Acetaminophen (AC) | 8.0 | 8.0 |
| Anthranilic acid (AN) | 8.0 | 8.0 |
| Anthranilic acid + AC | 8.0 | 8.0 |
| 75 ml/ha flumioxazin - Guillotine | 4.0 | 3.5 |
| (300 g/l) (x1 rate) - Flu x1 | | |
| 100 ml/ha Flu x2 | 4.0 | 3.0 |
| 125 ml/ha Flu x3 | 3.5 | 3.0 |
| x1 Flu + AC | 4.0 | 3.5 |
| x2 Flu + AC | 3.5 | 3.0 |
| x3 Flu + AC | 3.5 | 3.0 |
| x1 Flu + AN | 4.0 | 3.0 |
| x2 Flu + AN | 3.5 | 3.0 |
| x3 Flu + AN | 3.5 | 3.0 |
| x1 Flu + AN + AC | 5.0 | 4.5 |
| x2 Flu + AN + AC | 5.0 | 4.0 |
| x3 Flu + AN + AC | 5.0 | 4.0 |
| x3 Flu + Anthranilic acid methyl ester | 3.5 | 3.0 |
| (AME) | | |
| x3 Flu + AME + AC | 5.0 | 4.5 |
| x3 Flu + Acetamide | 3.0 | 3.0 |
| x3 Flu + Acetamide + AC | 4.5 | 4.5 |
| x3 Flu + Anthranilic | 3.5 | 3.5 |
| Acid monosodium salt | | |
| x3 Flu + Anthranilic | 4.0 | 4.5 |
| Acid monosodium salt + AC | | |
| x3 Flu + Indole-3-acetamide | 3.5 | 3.0 |
| x3 Flu + Indole-3-acetamide + AC | 5.0 | 4.5 |
| x3 Flu + 3-Hydroxyanthranilic acid | 3.5 | 3.5 |
| x3 Flu + 3-Hydroxyanthranilic acid + | 4.5 | 4.5 |
| AC | | |
| x3 Flu + Tryptamine | 3.0 | 3.5 |
| x3 Tryptamine + AC | 4.0 | 4.5 |

Addition of an auxin/auxin precursor plus acetaminophen provides a benefit to safening improvement (phytotoxicity reduction).

All publications mentioned in the above specification are herein incorporated by reference. Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the field are intended to be within the scope of the following claims.

1.-25. (canceled)

26. A composition comprising an auxin, an auxin precursor, an auxin metabolite or a derivative of said auxin, auxin precursor or auxin metabolite and acetaminophen or a derivative thereof for use as a plant safener.

27. The composition according to claim 26 wherein the auxin is an indolic auxin or a phenolic auxin.

28. The composition according to claim 26 wherein the auxin derivative is an acid, a conjugate, a salt, an ester, or an amide of the auxin, or an alkylated or halogenated auxin.

29. The composition according to claim 28 wherein the auxin is conjugated to a sugar, an alcohol, an amino acid or a protein.

30. The composition according to claim 26 wherein the precursor is chorismate, anthranilic acid, phosphoribosyl anthraniliate, 1-(O-carboxyphenulamino)-1-deoxyribulose-5-phosphate, indole-3-glycerol-phosphate, indole, indole-3-acetic acid, trytophan, tryptamine, N-hydroxy tryptamine, indole-3-acetaldoxime, 1-aci-nitro-2-indolylethane, indolic glucosinate, indole-3-acetonitrile (IAN), indole-3-acetaldehyde, indole-3-lactic acid, indole-3-pyruvic acid, or indole-3-ethanol.

31. The composition according to claim 30 wherein the precursor is anthranilic acid or a derivative thereof; wherein the anthranilic acid derivative is preferably a conjugate, a salt, an ester, or an amide of anthranilic acid, optionally substituted with an alkyl or halogen group.

32. The composition according to claim 31 wherein the anthranilic acid derivative is conjugated to a sugar, an alcohol, an amino acid, a peptide or a protein.

33. The composition according to claim 26 wherein the auxin is a natural auxin selected from indole-3-acetic acid (IAA), 4-chloro-indole-3-acetic acid (4-Cl-IAA), phenylacetic acid (PAA), indole-3-butyric acid (IBA), indole-3-acetyl-1-O-β-D-glucose (IAAglc); or a synthetic auxin selected from 1-naphthaleneacetic acid (NAA), 2,4-dichlorophenoxyacetic acid (2,4-D), 2-methoxy-3,6-dichlorobenzoic acid (dicamba), 4-amino-3,5,6-trichloropicolinic acid (tordon), 2,4,5-trichlorophenoxyacetic acid (2,4,5-T), 2,3,6-trichlorobenzoic acid or N,N-dimethylethylthiocarbamate.

34. The composition according to claim 33 wherein the conjugate of the natural auxin is IAA-Inositol, IAA-Inositol-arabinose, IAP1, an IAA-peptide, an IAA glycoprotein, an IAA-glucan, IAA-aspartate, IAA-glucose, IAA-1-O-glucose, IAA-myo-Inositol, IAA-4-O-glucose, IAA-6-O-glucose, IAA-Inositol-galactose, an IAA amide conjugate, or an IAA-amino acid conjugate.

35. The composition according to claim 26 wherein the metabolite is indole-3-lactic acid or indole-3-ethanol.

36. The composition according to claim 26 wherein the composition further comprises cobalt.

37. The composition according to claim 26 wherein the composition further comprises a compound selected from:
a) glucose, hydrolysed starch, sucrose, fructose, glycerol, glyceraldehydes, erythrose, ribulose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate;
b) an organic acid of the Krebs tricarboxylic acid cycle or a metabolic precursor thereof;
c) a vitamin or coenzyme, or a precursor thereof;
d) a purine or pyrimidine nucleoside, nucleotide or metabolic precursor thereof;
e) a naturally occurring fat or oil; or
f) an amino acid.

38. The composition of claim 37 wherein the compound is selected from c) a vitamin or coenzyme, or a precursor thereof; d) a purine or pyrimidine nucleoside, nucleotide or metabolic precursor thereof; or f) an amino acid.

39. The composition of claim 26 wherein the composition further comprises at least one of a fungicide, an insecticide, a herbicide, a chemical thinning agent, a fertiliser, a plant growth regulator and an abscission delay agent.

40. A method of protecting a desired plant from the effect of an agrochemical comprising applying an effective amount of the composition of claim 26.

41. The method of claim 40 wherein the composition is applied by at least one of seed treatment, localised soil treatment, plant treatment, including seedling treatment.

42. The method of claim 40 wherein the application of the composition is in advance of the application of the agrochemical.

43. A method for improving plant safety comprising the application of the composition of claim 26 to a plant or its environs.

44. The method of claim 40 wherein application of the composition further provides a boost in plant vigour.

45. The method of claim 40 wherein the composition is applied at conditions of at least one of low or high pH, temperature, salinity or drought.
